SEQUENCE LISTING (2 sequences)

SEQ ID NO: 1 - DNA, 24 bp, Artificial Sequence
  Description of Artificial Sequence Synthetic oligonucleotide
aagggattcctgggaaaactggac

SEQ ID NO: 2 - DNA, 24 bp, Artificial Sequence
  Description of Artificial Sequence Synthetic oligonucleotide
catccgctgcctcccgtaggagtg

(19) United States
(12) Patent Application Publication
(10) Pub. No.: US 2012/0135874 A1
(43) Pub. Date: May 31, 2012

(54) SINGLE MOLECULE SPECTROSCOPY FOR ANALYSIS OF CELL-FREE NUCLEIC ACID BIOMARKERS

(75) Inventors: Jeff Tza-Huei Wang, Timonium, MD (US); Kelvin J. Liu, Baltimore, MD (US); Christopher M. Puleo, Baltimore, MD (US)

(73) Assignee: The Johns Hopkins University, Baltimore, MD (US)

(21) Appl. No.: 13/260,212

(22) PCT Filed: May 6, 2010
(86) PCT No.: PCT/US2010/033888

§ 371 Date: Sep. 23, 2011

Related U.S. Application Data
(60) Provisional application No. 61/176,745, filed on May 8, 2009.

(51) Int. Cl. G01N 21/64; B01L 3/00; C40B 30/04; B82Y 15/00

(52) U.S. Cl. 506/9; 436/501; 435/6.1; 435/5; 435/6.11; 435/6.14; 422/502; 977/700; 977/902; 977/774

(57) ABSTRACT

The present invention relates, e.g., to a method for detecting a nucleic acid molecule of interest in a sample comprising cell-free nucleic acids, comprising fluorescently labeling the nucleic acid molecule of interest, by specifically binding a fluorescently labeled nanosensor or probe to the nucleic acid of interest, or by enzymatically incorporating a fluorescent probe or dye into the nucleic acid of interest, illuminating the fluorescently labeled nucleic acid molecule, causing it to emit fluorescent light, and measuring the level of fluorescence by single molecule spectroscopy, wherein the detection of a fluorescent signal is indicative of the presence of the nucleic acid of interest in the sample.

This application claims the benefit of the filing date of U.S. provisional application 61/176,745, filed May 8, 2009, which is incorporated by reference herein in its entirety.

This research was supported by grants from NIH (1R21CA120742) and NSF (0725528 and 0552063). The U.S. government thus has certain rights in the invention.

### FIELD OF THE INVENTION

This invention relates, e.g., to a diagnostic method for detecting biomarkers in single molecule cell-free nucleic acid, using single molecule spectroscopy.

### BACKGROUND INFORMATION

Cell-free nucleic acids (CNAs) are a highly promising source of non-invasive biomarkers for the detection of a wide array of human diseases. CNAs are extra-cellular nucleic acids freely present in human body fluids such as blood, urine, and sputum. This makes them easily obtained and highly attractive as a source of non-invasive biomarkers. They are released by both diseased and healthy cells alike and have been used to diagnose and manage a range of diseases such as cancer, fetal medicine, trauma, and diabetes.

Due to the low levels CNAs present, enzymatic amplification via polymerase chain reaction (PCR) has, to date, been the primary method used to analyze these marker molecules. Unfortunately, PCR-based techniques are fraught with technical and practical limitations that have precluded the rapid and efficient translation of CNA biomarkers from the discovery stage into clinical practice. For example, PCR-based diagnostic assays are expensive, labor intensive, time consuming, and difficult to reproduce on a daily basis. In addition, PCR based assays cannot be easily multiplexed, limiting the number of markers that can be concurrently analyzed. Finally, it is challenging to perform accurate quantification of low level changes in CNA biomarkers using PCR. These limitations have hindered the clinical validation and adoption of these promising biomarker molecules.

It would be desirable to develop new methods for detecting CNA biomarkers.

### DESCRIPTION OF THE DRAWINGS

FIG. 1 shows CCD images of the laser focal region in standard confocal spectroscopy (left) and μCICS (right). The standard CS spot is highly non-uniform and covers only a small portion of the microchannel. The μCICS line uniformly spans the entire microchannel increasing throughput and quantification accuracy.

FIG. 2 shows smDIA trace data (left) and a burst size histogram (middle) that were taken from Stage I (green) and Stage IV (blue) lung cancer patient serum samples. The late stage patient has a higher prevalence of large fluorescent bursts correlating to longer DNA fragments. This can be seen in the single molecule trace data by comparing the number of bursts greater than the dotted threshold line. This can also be seen by examining the area between the Stage I and Stage IV curves on the burst size histogram. Higher prevalence of large bursts in the Stage IV patient indicates higher DNA integrity (i.e. longer DNA strands) and is indicative of advanced disease. (Right) Hind III digest DNA analyzed using μCICS. The DNA was labeled using TOTO-3 and flowed through a microchannel. Each histogram peak corresponds to a fragment population in the digest. The location of each peak is correlated to the length of the DNA while the size of each peak is correlated to the relative abundance. The inset shows the linear correlation between burst size and DNA length.

FIG. 3 shows detected burst counts for DNA concentrations from 1 fM to 10 pM. DNA levels were analyzed using single molecule counting.

FIG. 4a shows a conceptual illustration of a QD-FRET nanosensor. FRET emission occurs only when a perfect match target is present to link the QD donor to the Cy5 acceptor. The QD functions as both a nanoscaffold and a nanoconcentrator. FIG. 4b shows that near perfect discrimination was achieved between homozygous wild-type targets and heterozygous targets when analyzing KRAS point mutations in borderline serous tumors using the QD-FRET nanosensor. FIG. 4c shows the detection of methylated p16 alleles in the presence of unmethylated p16 alleles background using MS-qFRET. A 1:10000 ratio of methylated:unmethylated alleles could be discriminated. FIG. 4d shows that miRNA detection using LNA probes and QD-FRET was used to detect 120 pM concentrations of target. Only in the presence of miRNA target could the Cy5 acceptor signal be seen.

FIG. 5A is a schematic illustration a cylindrical illumination confocal spectroscopy (CICS) system according to an embodiment of the current invention. FIG. 5B shows reflected images of the illumination volume of the system of FIG. 5A, but with no aperture. FIG. 5C corresponds to FIG. 5B, but a 620×115 μm rectangular aperture was included. FIG. 5D is the case of conventional SMD with no pinhole. The conventional SMD illumination volume resembles a football that extends in and out of the plane of the page while the CICS observation volume resembles an elongated sheet or plane that also extends in and out of the page. The CICS observation volume is expanded in 1-D using a cylindrical lens (CL) and then filtered using a rectangular aperture (CA). In the absence of a confocal aperture in FIG. 5B, the CICS illumination profile is roughly Gaussian in shape along the x, y, and z axis, chosen to align with the width, length, and height of a microchannel, respectively. The addition of the confocal aperture in FIG. 5C, depicted as a rectangular outline, allows collection of fluorescence from only the uniform center section of the illumination volume. Abbreviations: SL—spherical lens, IP—illumination pinhole, CL—cylindrical lens, OBJ—objective, DM—dichroic mirror, CA—confocal aperture, BP—bandpass filter, RM—removable mirror, NF—notch filter, CCD—CCD camera, APD—avalanche photodiode

FIG. 6A-6F show the illumination, I (top), collection efficiency, CEF (middle), and observation volume, OV (bottom), profiles of traditional SMD (left) and CICS (right) calculated using a semi-geometric optics model. The profiles are illustrated as xz-plots. Traditional SMD has a small OV profile that varies sharply in the x- and z-directions while the CICS OV profile has a smooth plateau region that varies minimally. The units of illumination profile and OV profile are arbitrary units (AU).

FIGS. 7A and 7B show simulated single molecule trace data of FIG. 7A standard SMD and FIG. 7B CICS performed using Monte Carlo simulations and the theoretical OV profiles. CICS displays a significant increase in burst rate and burst height uniformity over traditional SMD. An increase in background noise is also evident. The bin time was 0.1 ms.

FIGS. 8A and 8B show OV profiles of FIG. 8A traditional SMD and FIG. 8B CICS acquired using a sub-micron fluorescent bead. The CICS observation volume resembles traditional SMD in the z-direction but is elongated in the x-direction such that it can span a typical microchannel.

FIGS. 9A-9F show Gaussian curve fits of the OV profiles shown in FIG. 8 for standard 488-SMD (left) and 488-CICS (right). The CICS profiles are similar to the standard SMD profiles in the y- and z-directions but appear substantially elongated in the x-direction. Good fits are obtained for all except CICS in the x-direction which is not expected to be Gaussian. A slightly better approximation of the curve shape can be obtained if a Lorentzian fit is used in the z-direction rather than a Gaussian fit. (Gaussian Fit: y=y0+(A/(w*sqrt(PI/2)))*exp(−2*((x−xc)/w)̂2).

FIG. 10 shows image analysis of the 488-CICS illumination volume depicted in FIG. 9D before the confocal aperture. The sum of each column of pixels within the illumination volume is plotted as a function of the x-position. Before filtering with the aperture, the illumination follows a Gaussian profile with a 1/e² radius of 12.1 μm. (Gaussian Fit: y=y0+(A/(w*sqrt(PI/2)))*exp(−2*((x−xc)/w)̂2).

FIG. 11 shows image analysis of 488-CICS illumination volume depicted FIG. 9C after the confocal aperture. The sum of each column of pixels within the observation volume is plotted as a function of the x-position. After filtering with the aperture, light is collected from only the uniform center 7 μm.

FIG. 12 shows single molecule trace data of PicoGreen stained pBR322DNA taken using 488-CICS. The fluorescence bursts appear at a high rate and are highly uniform, but the background appears elevated due to the high amounts of background scatter from the silicon substrate. The bin time was 0.1 ms and 0.08 mW/cm2 of illumination power was used.

FIG. 13 shows image analysis of 633-QCS. The sum of each column of pixels within the illumination volume is plotted as a function of the x-position. Before filtering with the aperture, the illumination follows a Gaussian profile with a 1/e² radius of 16.5 μm. This radius is approximately 30-fold greater than the 1/e² radius of the diffraction limited 633-SMD illumination volume. (Gaussian Fit: y=y0+(A/(w*sqrt(PI/2)))*exp(−2*((x−xc)/w)̂2).

FIG. 14 shows image analysis 633-QCS. The sum of each column of pixels within the observation volume is plotted as a function of the x-position. After filtering with the aperture, light is collected from only the uniform center 7 μm.

FIG. 15 shows threshold effects on burst rate in 633-CICS analysis of TOTO-3 in a 5×2 μm PDMS microchannel. CICS data is much less sensitive to thresholding artifacts. There is a flat region between thresh=65-125 where the burst rate remains fairly constant. The illumination power was 1.85 mW/cm², and the bin time was 0.1 ms.

FIG. 16 is a burst height histogram of the CICS data presented in FIG. 13. The burst height histogram shows a sharp, well-defined Gaussian peak centered at 219 counts. Also depicted is a Gaussian curve-fit.

FIG. 17 is single molecule trace data of Cy5 labeled oligonucleotides taken using 633-SMD (top) and 633-CICS (bottom). Cy5 bursts can be clearly discriminated even above the high background. The background appears higher than the TOTO-3/pBR322 traces in FIG. 5 because of the longer bin time and higher excitation power. The bin time was 1 ms while 0.185 mW/cm² and 3.7 mW/cm² of illumination power was used for SMD and QCS, respectively.

FIG. 18 shows threshold effects on burst rate in 633-SMD analysis of Cy5 in a 5×2 μm PDMS microchannel. As the threshold is increased, the burst rate first increases slowly and then increases sharply as the number of false negative bursts rises sharply. A linear fit is applied to the points at t=16, 20, 24 and 28 and used to extrapolate the number of detected bursts if the threshold was set to 0. The illumination power was 0.185 mW/cm², and a 1 ms bin time was used.

FIG. 19 shows threshold effects on burst rate in 633-CICS analysis of Cy5 in a 5×2 μm PDMS microchannel. A linear fit is applied to the points at t=268, 282, 300, 320, and 340 and used to extrapolate the number of detected bursts if the threshold was set to 0. The illumination power was 3.7 mW/cm², and the bin time was 1 ms.

FIG. 20 shows threshold effects on burst rate in 633-SMD analysis of Cy5 in a 100 μm ID silica microcapillary. A linear fit is applied to the points at t=10, 12, 16 and 20 and used to extrapolate the number of detected bursts if the threshold was set to 0.1312 molecules were detected while 3×10⁶ molecules are expected based on the 1 μl/min flow rate, 1 pM concentration, and 300 s data acquisition time. This leads to a mass detection efficiency of 0.04%. The illumination power was 0.185 mW/cm², and the bin time was 1 ms.

FIG. 21 shows experimental single molecule trace data of TOTO-3 stained pBR322DNA taken using SMD (top) and CICS (bottom). The CICS experimental data shows a high burst rate and burst height uniformity that parallels the results of the Monte Carlo simulations. The bin time was 0.1 ms.

FIG. 22 shows BSDA histograms of PicoGreen stained pBR322DNA taken using standard SMD (left) and CICS (right). In standard SMD, the DNA peak is not resolved from the noise fluctuations due to the Gaussian OV profile whereas CICS shows a clearly discernable peak due to the high uniformity of the OV profile.

FIG. 23A is a schematic illustration of a microfluidic device according to an embodiment of the current invention. FIG. 23B is a schematic illustration to help facilitate the description of the operation of the microfluidic device of FIG. 23B.

FIGS. 24A-24C are schematic illustrations of a microfluidic device according to another embodiment of the current invention. In FIGS. 24A and 24B the combined microevaporator/rotary SMD microdevice has a control layer (lighter grey) that shows the evaporation membrane, rotary pump, and isolation valves. Target accumulation is accomplished by solvent removal from the fluidic layer (black, inlet labeled i.) through the pervaporation membrane (inlet labeled ii.). Following target accumulation the concentrated sample plug is transferred to the SMD-Rotary Chamber for probe hybridization and detection; probes and hybridization buffer are introduced through separate inlets (labeled iii.). In FIG. 24C the side sectional view of the operating microevaporator, prior to sample transfer into the detection chamber is shown. Solvent removal through the pervaporation membrane is compensated by convection from the sample reservoir, while actuation of the accumulation valve enables target collection at the dead end.

FIGS. 25A and 25B provide schematic illustrations of a detection channel for a microfluidic device according to another embodiment of the current invention.

FIGS. 26A-26 B show photo- and fluorescence micrographs of the accumulation zone just prior to the closed accumulation valve at time 0 after loading the evaporator coil with 500 nM fluorescently labeled DNA sequences in a microfluidic device according to an embodiment of the current invention. FIG. 26C is a fluorescence micrograph showing target accumulation after 6 hours of evaporation in the 1000 mm membrane pervaporator with 20 PSI nitrogen pressure and at room temperature. FIG. 26D is a photomicrograph of the SMD-rotary chamber just prior to sample injection with valves bisecting the chamber into analyte (left three-quarters) and probe/buffer (right one-quarter) compartments. FIG. 26E is the accumulated model target from FIG. 17C injected into the rotary chamber along with DI water in the probe/buffer section. FIG. 26F shows mixing of the contents shown in FIG. 26E for 1 second using the rotary pump at 10 Hz, mixing was complete within 5 seconds (data not shown).

FIGS. 27A-27C show bulk evaporation rates versus evaporation pressure (FIG. 27A), microdevice temperature (FIG. 27B), and evaporation membrane length (FIG. 27C) according to an embodiment of the current invention. Pressure data was taken using a 1000 mm membrane at room temperature. Temperature data was taken using a 1000 mm membrane at 25 PSI, while evaporation length data was taken at room temperature and 25 PSI. FIG. 27D shows time trace of the measured fluorescent burst duration of Tetraspec beads at the start of the evaporation channel at two different evaporation pressures (25 and 5 PSI). Large fluctuations at low pressure are due to evaporation membrane vibration upon initiation of nitrogen flow. Points for A, B, and C are mean evaporation rates from a single device after three separate two hour measurements±standard error.

FIG. 28 shows calibration curve of fluorescence burst counts versus target concentration loaded into the SMD-rotary chamber without evaporation-based accumulation (10 pM molecular beacon concentration). The solid line represents the average number of fluorescent bursts from the no target control (dotted line equals one standard deviation from an average of four measurements).

FIG. 29 shows number of fluorescent bursts detected versus hybridization time (5 pM targets, 10 pM probe) within the device according to an embodiment of the current invention. Hybridization time follows a 15 second mixing period using the rotary pump and a 5 second incubation at 80° C.

FIGS. 30A-30B show raw fluorescence burst traces from the recirculating SMD chamber (100 Hz pump frequency) after 20 hours of target enrichment and probe hybridization with no target control (A) and 50 aM target (B) samples according to an embodiment of the current invention. FIG. 30C shows number of fluorescent bursts detected versus loading concentration after 20 hours of evaporation within the 1000 mm membrane device (10 pM probe, room temperature, 25 PSI), along with no target controls.

### DESCRIPTION

The inventors describe herein procedures which employ single molecule spectroscopy methods, combined with fluorescent probe technologies, to form an amplification-free alternative to PCR for CNA analysis. In embodiments of the invention, the single molecule spectroscopy is confocal fluorescence spectroscopy (e.g. cylindrical illumination confocal spectroscopy (CICS)); multiplexed spectroscopy analysis and microfluidics are employed; and/or FRET analysis is used. In other embodiments of the invention, single molecule spectroscopy can also be performed on samples that have been amplified via PCR.

Advantages of a method of the invention include that it enables rapid, inexpensive, sensitive, robust, and accurate quantification of CNA biomarkers. Because of the high sensitivity of single molecule spectroscopy, direct detection of CNAs can be performed without enzymatic amplification, which reduces artifacts that can result from variable amplification efficiencies, reaction-to-reaction variability, and sample preparation steps. Furthermore, when single molecule spectroscopy is combined with nanosensor probes and/or microfluidics, CNA analysis can be performed directly from patient samples such as serum without the need for prior sample preparation steps such as isolation, separation, or purification. This streamlines the assay and eliminates many potential sources of error. Sample preparation steps are often tedious, labor intensive, and sensitive to human error. They can also artificially bias assay results due to preferential separation and recovery. Thus, the elimination of these steps not only reduces assay cost and time but also increases assay robustness and accuracy.

Advantageously, in one embodiment of the invention, the analysis requires only an inexpensive, disposable microfluidic device, buffers, and appropriate probes. Furthermore, the use of separation-free nanosensor probes and single molecule spectroscopy allows the analysis to be easily automated such that the entire assay can be performed with no human input and with only simple microfluidics. This makes analysis facile, robust, and able to be performed by without special training. In addition, CNA analysis can be easily multiplexed such that multiple CNA markers can be concurrently analyzed using a single sample. This can be accomplished, e.g., through multiplexed spectroscopy analysis and microfluidics.

Single molecule spectroscopy can be used to analyze many different types of CNA biomarkers in a diverse array of diseases. With the correct probes, analysis of markers such, e.g., as DNA, mRNA, and miRNA levels, DNA integrity, point mutations, microsatellite instabilities, and DNA hypermethylation can be readily performed. These markers can be applied to diseases or conditions such as, e.g., fetal medicine, critical illness, trauma, cancer, and diabetes. Furthermore, analysis can be performed on nearly any type of body fluid containing CNAs such as blood, plasma, serum, urine, sputum, ascites fluid, and stool.

In addition, the development of biomarkers has traditionally been hampered by high validation costs and lengthy, highly variable validation assays. A method of the invention allows for the rapid translation and application of CNA biomarkers from research into widespread clinical practice.

One aspect of the invention is a method for detecting (e.g., determining the presence of, or the amount of) a nucleic acid molecule of interest in a sample comprising cell-free nucleic acids, comprising

fluorescently labeling the nucleic acid molecule of interest, by specifically binding a fluorescently labeled nanosensor or probe (e.g. fluorophore labeled oligonucleotide or intercalating dye) to the nucleic acid of interest, or by enzymatically incorporating (e.g. polymerization or ligation reaction) a fluorescent probe or dye (e.g. fluorophore labeled dNTP) into the nucleic acid of interest,

illuminating the fluorescently labeled nucleic acid molecule, causing it to emit fluorescent light, and

measuring the level of fluorescence by single molecule spectroscopy,

wherein the detection of a fluorescent signal is indicative of the presence of the nucleic acid of interest in the sample.

In one embodiment of this method, the single molecule spectroscopy is conducted by

causing the sample comprising the fluorescently labeled nucleic acid molecule to flow through a channel of a fluidic device,

illuminating a portion of the fluid flowing through the channel with diffraction limited beam of light that activates the fluorescent label,

directing fluorescing light from the fluorescent nucleic acid molecule to be detected through an aperture comprising a confocal pinhole or slit to be detected and,

detecting the labeled nucleic acid molecule based on light directed through the aperture.

In another embodiment of this method, the single molecule spectroscopy is conducted by

causing the sample comprising the fluorescently labeled nucleic acid molecule to flow through a channel of a fluidic device,

illuminating a portion of the fluid flowing through the channel substantially uniformly with a sheet-like beam of light that activates the fluorescent label,

directing fluorescing light from the fluorescent nucleic acid molecule to be detected through a substantially rectangular aperture of an aperture stop to be detected,

wherein the substantially rectangular aperture is constructed and arranged to substantially match a width of the channel in one dimension and to substantially match a diffraction limited width of the sheet-like illumination beam in another dimension, and

detecting the labeled nucleic acid molecule based on light directed through the substantially rectangular aperture.

In this method, the detecting of the molecules can comprise correlating substantially quantized light pulses with a number of molecules detected.

In one embodiment of this method, the single molecule spectroscopy is cylindrical illumination confocal spectroscopy (CICS).

This method may further comprise

concentrating the sample comprising cell-free nucleic acids by removing at least a portion of fluid in the sample, using a microfluidic device to provide a concentrated sample;

mixing the concentrated sample with a reagent to fluorescently label the nucleic acid molecule of interest, using the microfluidic device (e.g., mixing a fluorescently labeled nanosensor or probe with the nucleic acid of interest; or mixing an enzyme and a fluorescent probe or dye with the nucleic acid of interest, in order to incorporate the fluorescent probe or dye into the nucleic acid of interest); and

detecting the nucleic acid of interest after the mixing, by illuminating the nucleic acid to be detected, causing the fluorescent molecules to emit fluorescent light to be detected,

wherein the sample is greater than about 1 μl and less than about 1 ml, and the concentrated sample is reduced in volume by a factor of at least 100. The concentrated sample may be less than 100 nl.

In one embodiment of this method, the illuminating may comprise illuminating the sample with a beam of light (e.g., a substantially planar beam of light) to perform fluorescence spectroscopy (e.g., cylindrical illumination confocal spectroscopy).

In embodiments of this method, the fluorescently labeled nanosensor is a molecular beacon or is a fluorescence coincidence nanosensor.

In one embodiment of this method, the fluorescently labeled nanosensor is a QD-FRET nanosensor.

One embodiment of this method comprises

(a) performing an assay that, in the presence of the nucleic acid of interest, generates a fluorescence coincidence nanosensor, wherein the fluorescence coincidence nanosensor comprises
i. one or more copies of the nucleic acid of interest, each bound to
ii. an oligonucleotide probe that is specific for the nucleic acid of interest, and which comprises a first member of a fluorophore pair,

and to
iii. a second oligonucleotide probe that is also specific for the nucleic acid of interest, which comprises the second member of the fluorophore pair;

(b) exciting fluorescence emission from both fluorophores; and

(c) measuring the level of fluorescence by single molecule spectroscopy (e.g. CICS)

wherein the coincident detection of a fluorescent signal from both fluorophores is indicative of the presence of the nucleic acid of interest in the sample.

Either one or both of the fluorophores may be quantum dots.

In one embodiment of the invention, the fluorescently labeled nanosensor is a fluorescent amplification nanosensor. For example, one embodiment of this method comprises

(a) performing an assay that, in the presence of the nucleic acid of interest, generates a fluorescence amplification nanosensor, wherein the fluorescence amplification nanosensor comprises
i. two or more fluorophores that are enzymatically incorporated into a nucleic acid duplicate that is produced using the nucleic acid target of interest as the template
ii. two or more fluorescently labeled oligonucleotide probes that hybridize to the nucleic acid of interest,

(b) exciting fluorescence emission from the labeled fluorophores; and

(c) measuring the level of fluorescence by single molecule spectroscopy (e.g. CICS)

wherein the amplified single molecule fluorescent signal from (i) the enzyme-mediated multiply labeled duplicate or (ii) the hybrid comprising multiple probes bound to the nucleic acid target is indicative of the presence of the nucleic acid of interest in the sample.

The fluorescently labeled nanosensor may be a FRET nanosensor.

For example, one embodiment of this method comprises

(a) performing an assay that, in the presence of the nucleic acid of interest, generates a FRET-nanosensor, wherein the FRET-nanosensor comprises
i. one or more copies of the nucleic acid of interest, each bound to
ii. an oligonucleotide probe that is specific for the nucleic acid of interest, and which comprises a first member of a fluorophore pair,

and to
iii. a second oligonucleotide probe that is also specific for the nucleic acid of interest, which comprises the second member of the fluorophore pair;

(b) inducing fluorescence resonance energy transfer (FRET) between the first and second members of the fluorophore pair; and

(c) measuring the level of fluorescence by single molecule spectroscopy (e.g. CICS),

wherein the detection of a fluorescent signal is indicative of the presence of the nucleic acid of interest in the sample.

In embodiments of this method, the first member of the fluorophore pair is a quantum dot and together comprises a QD-FRET nanosensor. The QD-FRET-nanosensor may be bound to the quantum dot, e.g. by the interaction of a biotin molecule attached to the QD-FRET-nanosensor and an avidin molecule fixed to the quantum dot, or by the interaction of an avidin molecule attached to the QD-FRET-nanosensor and a biotin molecule fixed to the quantum dot.

In one embodiment of the preceding method, in which the fluorescently labeled nanosensor is a FRET nanosensor, the method is a method for detecting methylation of a nucleic acid, comprising, in step (a),

treating a nucleic acid suspected of containing one or more methylated cytosine residues with an agent (e.g., bisulfite) that converts unmethylated cytosines to uracils,

hybridizing the treated nucleic acid with a specific positive or a negative methylation-specific oligonucleotide probe, which is labeled with a first member of a fluorophore pair, and

binding the hybridized, treated nucleic acid to a quantum dot which comprises the second member of the fluorophore pair, thereby forming a QD-FRET-nanosensor,

wherein the presence of a fluorescent signal following hybridization with the positive methylation-specific probe indicates that the nucleic acid contains the one or more methylated cytosine residues, and the presence of a fluorescent signal following hybridization with the negative methylation-specific probe indicates that the nucleic acid does not contain the one or more methylated cytosine.

Alternatively, the method comprises, in step (a),

amplifying a nucleic acid comprising unmethylated cytosines converted to uracil with a primer pair, wherein one primer comprises a binding moiety having affinity to a binding partner, and the other primer comprises a first member of a fluorophore pair, to obtain an amplicon; and capturing the amplicon comprising the binding moiety with a binding partner fixed to a quantum dot, which comprises the second member of the fluorophore pair, thereby forming a QD-FRET-nanosensor, wherein the presence of the fluorescent signal indicates that the nucleic acid is methylated.

Alternatively, in step (a),

a nucleic acid suspected of containing one or more methylated cytosine residues within a region of known sequence is treated with an agent (e.g., bisulfite) that converts unmethylated cytosines to uracils;

the treated nucleic acid is amplified with a pair of non-overlapping oligonucleotide primers, wherein at least one of the primers is specific for the presence or for the absence of the one or more methyl groups in the known sequence (a positive methylation-specific probe, or a negative methylation-specific probe, respectively); the first primer comprises a first member of a fluorophore pair, and the second primer comprises a binding moiety having affinity for a binding partner (e.g., biotin); to obtain an amplicon; and

the amplicon is captured with a binding partner (e.g., streptavidin) fixed to a quantum dot, which comprises the second member of the fluorophore pair, thereby forming a QD-FRET-nanosensor.

In this embodiment, the presence of a fluorescent signal following amplification with the positive methylation-specific probe indicates that the nucleic acid contains the one or more methylated cytosine residues, and the presence of a fluorescent signal following amplification with the negative methylation-specific probe indicates that the nucleic acid does not contain the one or more methylated cytosine.

In another embodiment of a method in which the fluorescently labeled nanosensor is a FRET nanosensor, the method is a method for detecting a mutation in the nucleic acid, comprising, in step (a),

hybridizing a nucleic acid of interest that is suspected of comprising the mutation with two probes that flank (are adjacent to) the position of the mutation, wherein one of the probes comprises a sequence that is complementary to the mutation, wherein one of the probes is labeled at the end distal to the site of the mutation with a first member of a fluorophore pair, and wherein the other probe comprises, at the end distal to the site of the mutation, a binding moiety having affinity to a binding partner,

treating the hybridized nucleic acid with a ligase, such that the two probes become ligated if the mutation is present in the nucleic acid of interest, and

capturing ligated nucleic acids, which comprise both the first member of the fluorophore pair and the binding moiety, with a binding partner fixed to a quantum dot, which comprises the second member of the fluorophore pair, thereby forming a QD-FRET-nanosensor,

wherein the presence of the fluorescent signal indicates that the DNA of interest comprises the mutation.

In embodiments of this ligation assay, the presence of a specific CNA may be measured by QD-FRET or with coincidence probes, each of which has a different fluorophore.

In embodiments of the invention, the sample is a body fluid; the nucleic acid of interest is a cell-free nucleic acid (CNA) in a body fluid; the cell-free nucleic acid in the sample is not separated from other components in the sample before the assay is performed; the cell-free nucleic acid is isolated (separated) from other components in the sample before the assay is performed; the cell-free nucleic acid in the sample is not amplified before the assay is performed; the sample is a cell-free body fluid; the sample is from a human; the sample is generated from a pleural effusion, ascites sample, plasma, serum, whole blood, urine, ductal lavage, stool, or sputum; the nucleic acid of interest is a microRNA (miRNA), a viral DNA or RNA, a mitochondrial DNA, a tumor DNA or RNA, a fetal DNA or RNA, or an mRNA; the nucleic acid of interest is a microsatellite instability (MSI) marker, loss of heterozygosity (LOH) marker, or copy number variation (CNV) marker, or it comprises a mutation (e.g., a point mutation) or a single nucleic polymorphism (SNP) of interest; the nucleic acid of interest comprises unmethylated cytosines that have been converted to uracils (e.g., by bisulfite treatment); the probe (e.g., oligonucleotide probe) is linked nucleic acid (LNA), peptide nucleic acid (PNA), or DNA complementary to the nucleic acid of interest; is an intercalating dye, or the dye is incorporated through polymerization of fluorophore labeled nucleotides, the dye is incorporated through ligation of fluorophore labeled oligonucleotides, or the probe is a molecular beacon; the method is high throughput; the method is a method for the quantification of the amount of the nucleic acid of interest, wherein the frequency of detection of fluorescent bursts indicates the amount of the nucleic acid of interest in the sample; the method is a method for detecting methylation of a nucleic acid, for detecting a mutation in the nucleic acid, or for diagnosis of cancer (e.g., ovarian, breast, lung, prostate, colorectal, esophageal, pancreatic, prostate, head and neck, gastrointestinal, bladder, kidney, liver, lung, or brain cancer, gynecological, urological or brain cancer, or a leukemia, lymphoma, myeloma or melanoma), trauma, stroke, diabetes, or fetal medicine; the method further comprises introducing a fluorescent tracer particle during single molecule spectroscopy (e.g., CICS) to control for flow velocity, focus position and/or fluorescent intensity.

A method as above may be used for determining the tumor load in a subject compared to one or more reference standards. In this embodiment, the DNA of interest is correlated with the presence of a cancer in a subject; and the method further comprises comparing the amount of the DNA of interest in the sample to a positive and/or a negative reference standard, wherein the negative and positive reference standards are representative of defined amounts of tumor load.

For example, the method may be used to determine if a subject is likely to have a cancer. In this embodiment, the negative reference standard is representative of the tumor load in a subject that does not have the cancer; and the positive reference standard is representative of the tumor load in a subject that has the cancer; and an amount of the nucleic acid of interest in the sample that is statistically significantly greater than the negative reference standard, and/or is approximately the same the positive reference standard, indicates that the subject is likely to have the cancer.

Such a method can be used for detecting a cancer at stage 1 or stage 2. It can also be used to stage a cancer in the subject. In this embodiment, the negative reference standard is representative of the tumor load in a subject that does not have the cancer, or has an early stage cancer, and the positive reference standard is representative of the tumor load in a subject that has a late stage cancer; and an amount of the nucleic acid of interest that is approximately the same as the negative standard indicates that the subject is likely to have an early stage cancer, and an amount of the nucleic acid of interest that is statistically significantly greater than the negative reference standard, or is approximately the same as the positive standard, indicates that the subject is likely to have a more advanced stage of the cancer.

Such a method can also be used to determine if a tumor is benign or malignant. In this embodiment, the negative reference standard is representative of the tumor load in a subject that has a benign tumor, and the positive reference standard is representative of tumor load in a subject that has a malignant cancer; and an amount of the nucleic acid of interest that is approximately the same as the negative standard indicates that the subject is likely to have a benign tumor, and an amount of the nucleic acid of interest that is statistically significantly greater than the negative reference standard, or is approximately the same as the positive standard, indicates that the subject is likely to have a malignant tumor.

Such a method can also be used for monitoring the progress or prognosis of a cancer in a subject, comprising determining the amount of the nucleic acid of interest at various times during the course of the cancer. In this embodiment, a decrease in the amount of the nucleic acid of interest over the course of the analysis indicates that cancer is going into remission and that the prognosis is likely to be good, and an increase in the amount of the nucleic acid of interest over the course of the analysis indicates that cancer is progressing and that the prognosis is not likely to be good.

Such a method can also be used for evaluating the efficacy of a cancer treatment, comprising measuring the amount of the nucleic acid of interest at different times during the treatment. In this embodiment, a change in the amount of the nucleic acid of interest over the course of the analysis indicates whether the cancer treatment is efficacious.

Another aspect of the invention is a kit for carrying out one of the methods of the invention. A kit of the invention can comprise, e.g., a microfluidic device (such as an inexpensive disposable microfluidic device), which is optionally preloaded with a suitable buffer, such as TE buffer; and suitable probes or nanosensors, which bind specifically to a biomarker of interest, or which can be used to detect a biomarker of interest (e.g., by binding to a sequence that is generated by a translocation event).

A “cell-free” nucleic acid (CNA), as used herein, is a nucleic acid (e.g., DNA or RNA) that has been released or otherwise escaped from a cell into blood or another body fluid in which the cell resides or comes into contact with. Some cell-free nucleic acids are circulating nucleic acids. Cell-free nucleic acids that can be measured by a method of the invention include a variety of types of DNA or RNA, including, e.g., microRNA (miRNA), viral RNA or DNA, genomic DNA, mitochondrial DNA, tumor DNA, fetal DNA or mRNA. Much of the discussion herein is directed to the analysis of DNA. However, it will be evident to a skilled worker that this discussion also applies to the above-mentioned, and other, types of cell-free nucleic acids.

Some samples (e.g., serum or plasma samples) comprising cell-free DNA can be analyzed in a method of the invention without further separations or purification because, under the conditions of the assay, there are few if any cells in the sample, so there will be little if any contaminating DNA that can interfere with the assay. Alternatively, when intact cells are present in a sample, potentially contaminating DNA can be avoided by using a cell membrane impermeable fluorescent dye or cell membrane impermeant probes and nanosensors. The presence of intact cells in the sample will not interfere with the specific detection of cell-free DNA, because DNA located inside of those cells will not be labeled. For other samples, it may be necessary to remove DNA present in contaminating cells or cellular debris by removing such cells or cellular debris before subjecting the DNA to a method of the invention.

Suitable subjects from which the body fluids can be collected include any animal which has, or is suspected of having, a disease or condition to be analyzed, such as vertebrate animals, e.g. mammals, including pets, farm animals, research animals (mice, rats, rabbits, guinea pigs, etc) and primates, including humans.

A variety of conditions or diseases can be evaluated by a method of the invention. These include, e.g., cancer, trauma, stroke, diabetes or fetal medicine. Much of the discussion herein is directed to the detection of a cancer, but a skilled worker will recognize that the analysis of the aforementioned, and other, conditions or diseases is also included. A method of the invention can be used to assay for the presence, or the amount, of any of a variety of nucleic acid modifications or biomarkers, including, e.g., epigenetic modifications such as methylation, mutations such as point mutations, DNA integrity, microsatellite instabilities, loss of heterozygosity (LOH), etc.

A variety of body fluids that are suitable for analysis will be evident to a skilled worker. The cell-free DNA can be found in circulating body fluids, such as blood, but it can also be found in non-circulating fluids, such as urine, sputum, bile juice, etc. Suitable body fluids include, e.g., blood (e.g., whole blood, plasma or serum), lymph fluid, serous fluid, a ductal aspirate sample or ductal lavage, bronchoalveolar lavage, a lung wash sample, a breast aspirate, a nipple discharge sample, peritoneal fluid, duodenal juice, pancreatic duct juice, bile, an esophageal brushing sample, glandular fluid, amniotic fluid, cervical swab or vaginal fluid, ejaculate, semen, prostate fluid, cerebrospinal fluid, a spinal fluid sample, a brain fluid sample, lacrimal fluid, tears, conjunctival fluid, synovial fluid, saliva, stool, sperm, urine, sweat, fluid from a cystic structure (such as an ovarian cyst), nasal swab or nasal aspirate, or a lung wash sample.

It will be evident to a skilled worker what source of body fluid is suitable for the detection of a particular type of disease or condition. For example, for ovarian cancer, suitable samples can be generated from, e.g., a pleural effusion, ascites fluid (effusion in the abdominal cavity), plasma, urine or sputum. For the detection of pancreatic cancer, one can assay, e.g., pancreatic duct juice (sometimes referred to as “pancreatic juice” or “juice”), for example obtained during endoscopy, brushings of the pancreatic duct, bile duct or aspirates of cyst fluid. For the detection of lung cancer, sputum or bronchoalveolar lavage can be used. For head and neck cancer in the oral or pharyngeal cavity, sputum or wash from the mouth can be used. For colon cancer, prostate cancer, breast cancer and nasopharyngeal cancer, suitable body fluids include stool, prostate fluid, breast aspirate and nasal swab/wash, respectively.

In some cases, a body fluid sample is treated to remove cells, cellular debris and the like. For example, a urine sample, a pleural effusion or an ascites sample can be subjected to centrifugation, following conventional procedures, and the supernatant containing the DNA isolated; or a sample can be filtered to remove the cells or cell debris. In other cases, e.g., when serum is used, no further treatment is required to remove cells, cellular debris and the like.

Although PCR is generally not required or preferred, in some cases PCR can be used to select and amplify nucleic acids of interest. PCR can also be used to incorporate fluorescent dyes or dye labeled probes as discussed subsequently.

“Cell-free” body fluids used in a method of the invention are body fluids into which DNA has been released (e.g., from cancer cells, such as tumor cells), and from which all or substantially all particulate material in the preparation, such as cells or cell debris, has been removed. These samples are sometimes referred to herein as cell-free “effusion samples.” It will be evident to a skilled worker that a cell-free body fluid generally contains only a few if any cells, but that a number of cells can be present in a “cell-free” body fluid, provided that those cells do not interfere with a method of the invention. A skilled worker will recognize how many cells can be present without interfering with the assay. For example, 1,000 or fewer cells (e.g., 1, 10, 50, 100, 500 or 1,000 cells) can generally be present in a volume of one liter of body fluid without interfering with the assay.

Methods for preparing a DNA sample from a body fluid (e.g., a cell-free body fluid) are conventional and well-known in the art. It may be desirable to include an agent in the sample which inhibits DNase activity. For example, for the isolation of DNA from a plasma sample, anti-coagulants contained in whole blood can inhibit DNase activity. Suitable anti-coagulants include, e.g., chelating agents, such as ethylenediaminetetraacetic acid (EDTA), which prevents both DNase-caused DNA degradation and clotting of whole blood samples.

If desired (although generally not necessary), DNA for analysis can be isolated (purified), before subjecting it to a method of the invention, using conventional methods or kits that are commercially available. Methods for isolating DNA and other molecular biology methods used in the invention can be carried out using conventional procedures. See, e.g., discussions in Sambrook, et al. (1989), Molecular Cloning, a Laboratory Manual, Cold Harbor Laboratory Press, Cold Spring Harbor, N.Y.; Ausubel et al. (1995). Current Protocols in Molecular Biology, N.Y., John Wiley & Sons; Davis et al. (1986), Basic Methods in Molecular Biology, Elseveir Sciences Publishing, Inc., New York; Hames et al. (1985), Nucleic Acid Hybridization, IL Press; Dracopoli et al. (current edition) Current Protocols in Human Genetics, John Wiley & Sons, Inc.; and Coligan et al. (current edition) Current Protocols in Protein Science, John Wiley & Sons, Inc.

DNA molecules can be labeled with a fluorescent dye by a variety of methods, which will be evident to a skilled worker. Methods of labeling a DNA of interest with a fluorescent dye include, e.g., using an intercalating dye, covalently binding the dye to the DNA through a coupling reaction, introducing the dye into the DNA by an enzymatic method (such as PCR), or incorporating the dye into the DNA by the binding of a labeled fluorescent probe.

In one embodiment of the invention, in which the size of a CNA molecule is determined, a fluorescent dye is incorporated into the CNA in a stoichiometric manner, such that the amount of label is proportional to the length of the CNA molecule. A DNA intercalating dye can be used for this purpose. The labeled CNA molecule is then analyzed using single molecule spectroscopy such as CICS where the size of each fluorescent burst can be correlated to the length of the CNA molecule. Details of carrying out a typical example of this type of assay can be found in Liu et al (2010) J Am Chem Soc, (epub ahead of print) DOI: 10.1021/ja100342q.

In another embodiment of the invention, a fluorescent probe, such as an oligonucleotide, antibody, aptamer, PNA, LNA etc., is bound specifically to a nucleic acid of interest (e.g., containing or representing a biomarker of interest), and the presence or amount of that DNA is detected by measuring the amount of fluorescence emanating from the bound probe. By binding “specifically” is meant that the probe binds preferentially to a particular target and not to other entities unintended for binding to the subject components. Methods for designing suitable probes and conditions for binding them specifically to a designated target (e.g., specific hybridization of an oligonucleotide probe) are conventional and well-known in the art. By hybridizing “specifically” is meant herein that two components (e.g. a cell-free nucleic acid target and a nucleic acid probe) bind selectively to each other and not generally to other components unintended for binding to the subject components. The parameters required to achieve specific interactions can be determined routinely, using conventional methods in the art. For example, the hybridization can be carried out under conditions of high stringency. As used herein, “conditions of high stringency” or “high stringent hybridization conditions” means any conditions in which hybridization will occur when there is at least about 95%, preferably about 97 to 100%, nucleotide complementarity (identity) between the nucleic acids (e.g., a polynucleotide of interest and a nucleic acid probe). Generally, high stringency conditions are selected to be about 5° C. to 20° C. lower than the thermal melting point (Tₘ) for the specific sequence at a defined ionic strength and pH. Appropriate high stringent hybridization conditions include, e.g., hybridization in a buffer such as, for example, 6×SSPE-T (0.9 M NaCl, 60 mM NaH₂ PO₄, 6 mM EDTA and 0.05% Triton X-100) for between about 10 minutes and about at least 3 hours (in a preferred embodiment, at least about 15 minutes) at a temperature ranging from about 4° C. to about 37° C. In one embodiment, hybridization under high stringent conditions is carried out in 5×SSC, 50% deionized Formamide, 0.1% SDS at 42° C. overnight.

In another embodiment of the invention, a nucleic acid of interest is bound specifically to a labeled nanosensor. As used herein, a “nanosensor” refers to a biological or chemical agent that can transduce information about biological molecules into detectable fluorescent signals. Several examples of suitable nanosensors are described elsewhere herein.

Any assay for detecting a nucleic acid of interest can be adapted to be used in a method of the invention, in which the nucleic acids detected are CNAs, and the molecules are detected by single molecule spectroscopy. Methods for designing suitable probes, binding them specifically to a target of interest, etc. are conventional and well-known in the art. Guidance as to how to carry out a typical embodiments of the invention is found, e.g., in Liu et al. (2010) J Am Chem Soc 132, 5793-8, a publication from the inventors' laboratory.

In one embodiment of the invention, sequence specific detection of CNA molecules is performed using a molecular beacon or hairpin probe (see Zhang et al. (2005) Nat Mater 4, 826-831). This scheme can be used to detect CNA mutations such as SNPs. A short 27 base single strand probe is designed to contain 5 base long complementary stem regions at the 5′ and 3′ ends. The 17 base long center section is designed to hybridize to the sequence of interest. The 5′ end of the probe is labeled with a Cy5 dye, and the 3′ end is labeled with a Black Hole Quencher. In the absence of the sequence of interest, the stem regions bind to each other, bringing the quencher and Cy5 dye into close proximity and quenching fluorescence emission. In the presence of the CNA of interest, the molecular beacon binds and opens up, separating the Cy5 dye from the quencher and restoring fluorescence. Sample containing CNA molecules is mixed with molecular beacons and allowed to hybridize. The mixed sample is then diluted and analyzed using single molecule spectroscopy where the presence of Cy5 fluorescence bursts indicates presence of the CNA target sequence.

In one embodiment of the invention, a mutation, such as a point mutation, is detected with a ligation-based assay. For example, some of the present inventors reported (Yeh et al. (2006) Nucleic Acids Research 34, e35) a method for detecting point mutations, in which two oligonucleotides are prepared which correspond to adjacent sequences of a gene region having a particular point mutation of interest, and that flank the site of the mutation. The 5′-terminal oligo (a discrimination probe) is labeled at its 5′ end with biotin, and the 3′-terminal oligo (a reporter probe) is labeled at its 3′ end with a first fluorophore. The oligos are then hybridized to a test sample comprising the gene region of interest, and are reacted with a ligase. If the test sample has the mutation, the two oligos will match perfectly with the test DNA and will be ligated to form a longer ligation product, which has biotin at its 5′ end and the first fluorescent label at its 3′ end. By contrast, if the test sample does not contain the mutation, the two probes will not line up perfectly and thus will not be ligated. After heat denaturing the duplexes, the single-stranded molecules which have biotinylated ends are coupled via the biotinylated ends to a streptavidin-conjugated quantum dot (QD) that is labeled with a second fluorophore, to form a QD-fluorescent ligation product (QD-FLP). Typically, many ligated products will be conjugated to each QD, forming a QD-FLP nanoassembly. Only when a perfect match is present will the 3′ end of the QD-bound oligos comprise the first fluorophore at their 3′ ends.

In the method of the Yeh et al. (2006) paper, the QD-FLPs are analyzed using a single wavelength-excitation, dual wavelength emission confocal spectroscopic system. When a QD-FLP nanoassembly flows through the confocal detection volume, simultaneous burst signals, or coincident signals, are detected in the two detection channels. In the case of a mismatch, the QDs are bound only with nonfluorescent probes so no coincident signals are seen. Coincident signals thus serve as indicators of perfect match targets.

In another embodiment of the invention, a probe or nanosensor is used that specifically recognizes (binds to) a particular feature of a target nucleic acid of interest. Such features are sometimes referred to herein as “biomarkers.” For example, biomarkers associated with certain cancers include, among many others, allelic imbalance (which can be detected, for example, by assaying for particular SNPs); mutations associated with a cancer (as described, e.g., by Parrella et al. (2003) Mod Pathol 16, 636-640), including point mutations, microsatellite alterations, and translocations; epigenetic modifications such as promoter methylation; the presence of a viral sequence; loss of heterozygosity (LOH); copy number variation (CNV; or the amplification of a cancer-associated amplified genomic locus [e.g., for ovarian cancer, the markers described by Nakayama et al. (2007) Int J Cancer 120, 2613-2617), or secretory tumor-associated markers (Borgono et al. (2004) Mol Cancer Res 2, 257-80; I. Shih (2007) Hum Immunol 68, 272-276; Shih et al. (2007) Gynecol Oncol 105, 501-7)].

In another embodiment of the invention, enzymatic incorporation is used to create fluorescence amplification nanosensors. PCR primers specific for the CNA region of interest are designed. PCR is then performed using fluorophore labeled nucleotides such as Cy5-dCTP. In the presence of sequence specific CNA targets, PCR creates fluorescence amplification nanosensor products each with large number of internally incorporated fluorophore labels. Single molecule spectroscopy can be performed on the products from this enzymatic incorporation step. An embodiment of this method is reported by one of the current inventors in Bailey et al (2010) ChemBioChem, 11(1), 71-74.

In another embodiment of the invention, MS-qFRET (Bailey et al (2009) Genome Research, 19(8):1455-1461) is used to generate QD-FRET nanoassemblies for detection of CNA methylation. These nanoassemblies can be analyzed using single molecule spectroscopy as reported.

In one embodiment of the invention, multiple samples are assayed simultaneously, used a microfluidic chamber/chip as described in Example III. In this embodiment, samples from a single subject are analyzed simultaneously for a plurality of nucleic acid modifications; or multiple samples are analyzed for the presence of a single nucleic acid modification.

A variety of fluorescent dyes can be used in a method of the invention, as will be evident to a skilled worker. Intercalating dyes are often used due to ease and their useful properties; other types of dyes can also be used. Desirable (but not essential) properties of a suitable fluorescent dye include that it exhibits signal enhancement upon incorporation into the DNA (so that the unincorporated label will not give rise to background fluorescence), preferential binding to DNA, cell membrane impermeance, emits at a level that is far from biological autofluorescence (thus reducing background), and exhibits fast on rate kinetics (for a short reaction time) and slow off rate kinetics (so it can be diluted). In embodiments in which stoichiometric binding is important, a suitable dye will provide stoichiometric binding even when concentrations are accurately controlled (i.e., is tolerant to a wide range of staining ratios). Representative dyes that can be used include SYBR® Green and the intercalating dyes TOTO-3, PicoGreen, EvaGreen, and YOYO-1. Other suitable dyes are described in the following world wide web sites: invitrogen.com/site/us/en/home/References/Molecular-Probes-The-Handbook/tables/Properties-of-classic-nucleic-acid-stains.html; invitrogen.com/site/us/en/home/References/Molecular-Probes-The-Handbook/tables/Specialty-nucleic-acid-reagents-for-molecular-biology.html; invitrogen.com/site/us/en/home/References/Molecular-Probes-The-Handbook/tables/Cell-membrane-impermeant-cyanine-nucleic-acid-stains.html; and invitrogen.com/site/us/en/home/References/Molecular-Probes-The-Handbook/tables/Cell-permeant-cyanine-nucleic-acid stains.html.

Additional moieties such as fluorophores, microparticles, and nanoparticles can be used to label probes and nanosensors. These include fluorescein, rhodamine, Oregon green, Alexa fluors, Cy dyes, quantum dots, Texas red, tetramethylrhodamine, fluorescence quenchers, metallic nanoparticles, fluorescent beads, etc. Other suitable labels are known to those skilled in the art and must only give a signal that can be detected by single molecule spectroscopy. These fluorescent dyes can be attached through streptavidin-biotin interactions or covalently linked (e.g. thiol-maleimide reactions, amine-ester reactions, etc). Suitable fluorophores are selected based upon their optical properties such as spectral curves, quantum yield, extinction coefficient, resistance to photobleaching, Stokes shift, etc

A variety of well-known methods of single molecule spectroscopy can be used to analyze CNA in a method of the invention. Single molecule spectroscopy is most commonly performed using confocal fluorescence spectroscopy. Confocal fluorescence spectroscopy can be used in conjunction with DNA nanosensors to detect molecules from 5 fM-0.5 nM in concentration, a range that overlaps well with the physiological serum concentrations of CNAs, which range from 5-200 ng/ml, corresponding to nanomolar levels of CNAs (Zhang et al. (2005) Nat Mater 4, 826-831). A variation of confocal fluorescence spectroscopy that may be used is cylindrical illumination confocal spectroscopy. Alternatively, molecular cytometry may be performed. Single molecule Raman spectroscopy can also be used if Raman dyes are used as labels rather than fluorophores. The single molecule spectroscopy may be carried out in capillary devices, wells, microwells, microchannels or nanochannels.

In one embodiment of the invention, the single molecule spectroscopy is cylindrical illumination confocal spectroscopy (CICS) or microfluidic cylindrical illumination confocal spectroscopy (μCICS). CICS uses a 1-D focal volume expansion and matched microfluidic constriction to achieve high detection uniformity, 100% mass detection efficiency, and higher throughput than conventional diffraction-limited CS-systems. One feature of this embodiment of the method is that it insures a substantially uniform detection profile. Furthermore, the high sensitivity of CICS enables the direct elucidation of the amount (or size) of a DNA molecule of interest without the need for enzymatic amplification (e.g., PCR).

For guidance as to how to carry out CICS or μCICS, see Liu et al. (2008) Biophys J 95, 2964-2975, the Examples herein, or the co-pending U.S. application Ser. No. 12/612,300, filed on Nov. 4, 2009 and application number PCT/US2010/025933 filed on Mar. 2, 2010, the entire contents of which are incorporated herein by reference. When single molecule spectroscopy is carried out using standard confocal fluorescence spectroscopy, a method of the invention is carried out essentially as described herein using CICS, except the sample is loaded into a confocal spectrometer which uses a diffraction limited laser excitation profile and a transport channel that is substantially larger than the laser detection region (see, e.g., Wang et al. (2004) J Am Chem Soc 127 (15), 5354-5359). When single molecule spectroscopy is carried out using flow cytometry, a method of the invention is carried out essentially as described herein using CICS, except the sample is loaded into a molecular cytometer which uses a hydrodynamic sheath flow to confine the molecules to the uniform region of the laser excitation (see, e.g., Habbersett et al. (2004) Cytometry A 60(2), 125-34). When single molecule spectroscopy is carried out using nanochannels, a method of the invention is carried out essentially as described herein using CICS, except the sample is loaded into a micro fluidic device having channels significantly smaller (250 nm×250 nm w×h) than the size of the diffraction limited laser focus (1 um×2 um w×h). See, e.g., Foquet et al. (2002) Anal Chem 74, 1415-1422. The laser is focused into the center of the nanochannel and DNA is flowed through accordingly.

As used herein, with regard to single molecule spectroscopy, the term “burst size” means the integrated or total number of photons emitted by a single molecule within a fluorescent burst; the term “burst height” means the maximum number of photons emitted by a single molecule within a single acquisition period of a fluorescent burst; and the term “burst rate” means the rate at which individual fluorescent bursts are detected. In a method of the invention, the frequency of detection of fluorescent bursts indicates the amount of a nucleic acid of interest in the sample.

In a method of the invention, a suitable cut-off value or range of values of DNA amounts is generally selected in order to distinguish between two populations of subjects. A person of ordinary skill in the art will be able to determine a suitable cut-off value of the amount of a DNA of interest for, for example, distinguishing between subjects that have or do not have a particular type or stage of cancer, using empirical methods, without undue experimentation. This cut-off value will depend on a variety of factors including, e.g., biological factors. For example, for the detection of cancer, the detection can depend on factors such as the type of cancer, location of tumor, clinical stage, type of sample that the CNAs are obtained from, treatments being performed, pre-existing underlying non-neoplastic disease, concurrent physiological factors such as trauma and other diseases; and engineering factors, such as the measurement of CV, pre-analytical factors (freshness of sample, freeze-thaw cycles, sample collection and processing steps), and system signal to noise ratio.

A method of the invention can be used for a variety of assays, including diagnosing a cancer (a malignant tumor, neoplasm, malignancy) in a subject, determining the stage of the cancer, determining the prognosis of a subject having a cancer (e.g., the likelihood of recurrence), or monitoring therapeutic efficacy of a drug or treatment regimen. A method of the invention is sensitive enough to allow for the early detection of cancers. A method of the invention can be non-specific and sensitive to all tumors, regardless of type, or it can be specific for a particular cancer or class of cancers. Examples of suitable cancers for analysis will be evident to a skilled worker, and include, e.g., ovarian, breast, lung, prostate, colorectal, esophageal, pancreatic, prostate, gastrointestinal, bladder, kidney, liver, lung, head and neck (including oral cavity), gynecological, urological, or brain cancer, or leukemias, lymphomas, myelomas or melanomas. Metastatic spread can also be detected.

The phrase “a method for diagnosing a cancer in a subject” is not meant to exclude tests in which no cancer is found. In a general sense, this invention involves assays to determine whether a subject has cancer, irrespective of whether or not such a cancer is detected.

One embodiment of the invention is a general method for determining the tumor load in a subject, in which, rather than using predetermined, absolute values of a biomarker of interest to determine if, for example, a subject has a cancer, the amount of the DNA of interest is compared to positive and/or negative reference values. “Tumor load,” sometimes called tumor burden, refers to the number of cancer cells, the size of a tumor, or the amount of cancer in the body. This method comprises analyzing a body fluid sample from the subject by a method of the invention, determining the amount of a DNA of interest (e.g., a DNA containing a biomarker of interest); and comparing the amount of the DNA molecules in the sample to a positive and/or a negative reference standard, wherein the negative and positive reference standards are representative of defined amounts of tumor load.

For example, one embodiment of the invention is a method for determining if a subject is likely to have a cancer. In this method, a “positive reference standard” reflects (represents, is proportional to) the amount of DNA comprising a biomarker of interest in the same type of body fluid of a subject, or the average (e.g., mean) value for a population or pool of subjects, that have the cancer being tested for. In one embodiment of the invention, an amount of the DNA that is approximately the same as (e.g., statistically the same as) a positive reference standard is indicative of the cancer. A “negative reference standard,” as used herein, reflects (represents, is proportional to) the amount of DNA from the same type of cell-free body fluid of a subject, or the average (e.g., mean) value for a population or pool of subjects, that do not exhibit clinical evidence of the cancer of interest. Such “normal” controls do not have the cancer being tested for, or any type of cancer, or have a benign tumor of the type of cancer being assayed for. An amount that is greater than (e.g., statistically significantly greater than) the negative reference standard is indicative of the cancer.

By “likely” is meant herein that the subject has at least about a 75% chance (e.g., at least about a 75%, 80%, 85%, 90%, 95% chance) of having the cancer.

In one embodiment of the invention, the positive and negative reference standards are measured from subjects or pools of subjects, or are retrospective values from such subjects. Alternatively, and more conveniently, a positive or negative reference standard can comprise an amount of DNA comprising a biomarker of interest that is proportional to the amount present in a subject that does, or that does not, have the cancer, respectively. Such DNA standards can be prepared synthetically. In one embodiment, the reference standard is the same as expected in a subject having the cancer being assayed for (positive reference standard), or not having the cancer being assayed for (negative reference standard). In another embodiment, the amount of the DNA in the reference standard is proportional to the amount expected in a subject having, or not having, the cancer being assayed, and the investigator applies a suitable multiple to convert the standard to the actual expected value.

By “statistically significant” is meant a value that is reproducible or statistically significant, as determined using statistical methods that are appropriate and well-known in the art, generally with a probability value of less than five percent chance of the change being due to random variation. For example, a significant increase in the amount of DNA having a biomarker of interest can be at least about a 25% or 50% increase, or at least 2-fold (e.g., at least about 5-fold, 10-fold, 15-fold, 20-fold, 25-fold, 30-fold, 100-fold, or more) higher than a negative reference standard. The degree of increase can be a factor of a number of variables, including the type and stage of the cancer, the age and weight of the subject, and the like.

A diagnostic method of the invention can be used in conjunction with other methods for diagnosing a cancer. For example, one can evaluate allelic imbalance, e.g., by using digital SNP assays (as described, e.g., by Chang et al. (2002) Clin Cancer Res 8, 2580-2585); carry out conventional cytology analysis (as described, e.g., by Motherby et al. (1999) Cytopathol 20, 350-357); or perform other molecular assays, including PCR-based assays, which will be evident to a skilled worker (see, e.g., Fiegl et al. (2004) J Clin Oncol 22, 474-83). Secondary assays such as those discussed above can be carried out before a single molecule spectroscopy assay of the invention, as part of a preliminary screen; at the same time as an assay of the invention is carried out; or after the assay is carried out.

Another aspect of the invention is a method for staging a cancer in a subject by a method of the invention. In this method, reference standards can be used that are representative of the amounts of a particular biomarker of two or more subjects having different stages of the cancer. For example, a low amount can be used that represents the tumor load in a subject that does not have the cancer, or has an early stage cancer, and the positive reference standard is representative of the tumor load in a subject that has a late stage cancer. An amount of a biomarker that is approximately the same as the negative standard indicates that the subject is likely to have an early stage cancer, and an amount that is statistically significantly greater than the negative reference standard, or is approximately the same as the positive standard, indicates that the subject is likely to have a more advanced stage of the cancer. The method can be used to screen a non-symptomatic subject, or a subject having early stage cancer, in order to detect whether a subject has a curable form of the cancer, such a stage 1 or stage 2 cancer. The detection in the sample of an elevated amount of a biomarker would indicate a high probability of cancer and, in the case of an asymptomatic subject, necessitate a search for the cancer.

Another aspect of the invention is a diagnostic method for determining if a tumor in a subject is benign or malignant, comprising measuring DNA in a body fluid (e.g., a cell-free body fluid) from the subject by a method of the invention. A benign tumor will give rise to a lower amount of a biomarker of interest for the tested DNA in the body fluid of the subject than will a malignant tumor.

Another aspect of the invention is a method for monitoring the progress or prognosis of a cancer in a subject, comprising measuring DNA in a body fluid (e.g., a cell-free body fluid) from the subject by a method of the invention at various times during the course of the cancer.

Another aspect of the invention is a method for evaluating the efficacy of a cancer treatment of a subject (e.g., chemotherapy, radiation, biotherapy or surgical operation), comprising measuring DNA in a body fluid (e.g., a cell-free body fluid) from the subject by a method of the invention, at different times during the course of the treatment (e.g., before, during, and/or after the treatment). It will be evident to an investigator that the amount of a biomarker may actually increase temporarily during an efficacious treatment, because during the treatment the cancer cells are dying and, once the treatment is completed, the value is expected to drop below the pre-treatment value. Whether the amount of a biomarker increases or decreases during various stages of an efficacious treatment may also depend on other factors, such as, e.g., type of therapy (resection, chemotherapy, radiotherapy, etc.).

For any of the assays used in a method of the invention, suitable controls will be evident to a skilled worker. For example, the assays can be normalized to a normalization control, such as the volume of the effusion sample.

Methods of the invention can be readily adapted to a high throughput format, using automated (e.g. robotic) systems, which allow many measurements to be carried out simultaneously. Furthermore, the methods can be miniaturized.

The order and numbering of the steps in the methods described herein are not meant to imply that the steps of any method herein must be performed in the order in which the steps are listed or in the order in which the steps are numbered. The steps of any method disclosed herein can be performed in any order which results in a functional method. Furthermore, the method may be performed with fewer than all of the steps, e.g., with just one step.

Any combination of the materials useful in the disclosed methods can be packaged together as a kit for performing any of the disclosed methods. A kit can be suitable, e.g., for diagnosing a condition or disease (such as a cancer) in a subject, using a method of the invention. For example, a kit of the invention can contain a microfluidic device (such as an inexpensive disposable microfluidic device), which is optionally preloaded with a suitable buffer (such as TE buffer); suitable probes or nanosensors, which bind specifically to a biomarker of interest, or which can be used to detect a biomarker of interest (e.g., by binding to a sequence that is generated by a translocation event), and which can be fluorescently labeled; and/or tracer particles such as 0.04 μm yellow-green fluorescent microspheres. If desired, defined amounts of positive and negative standards (e.g., prepared synthetically) can be included. Elements of a kit can be packaged in one or more suitable containers. If desired, the reagents can be packaged in single use form, suitable for carrying one set of analyses.

Kits may supply reagents in pre-measured amounts so as to simplify the performance of the subject methods. Optionally, kits of the invention comprise instructions for performing the method. Other optional elements of a kit of the invention include suitable buffers, labeling reagents, packaging materials, etc. The kits of the invention may further comprise additional reagents that are necessary for performing the subject methods. The reagents of the kit may be in containers in which they are stable, e.g., in lyophilized form or as stabilized liquids.

In the foregoing and in the following example, all temperatures are set forth in uncorrected degrees Celsius; and, unless otherwise indicated, all parts and percentages are by weight.

### EXAMPLES

### Example I

### Applications of a Method of the Invention

### A. 1-Step CNA Analysis.

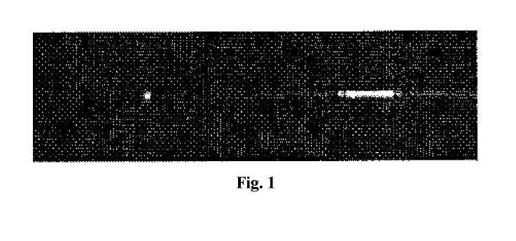

Microfluidic Cylindrical Illumination Confocal Spectroscopy (μCICS) is ideally suited for the clinical analysis of CNAs. In μCICS, the standard diffraction limited CS observation volume is elongated in 1D to span the entire microchannel as illustrated in FIG. 1. The 1D expansion increases the mass detection efficiency to 100% and greatly enhances the analysis uniformity. Thus, it increases throughput, enables more accurate determination of molecular properties, and enables assays that are impossible to efficiently perform using other methods.

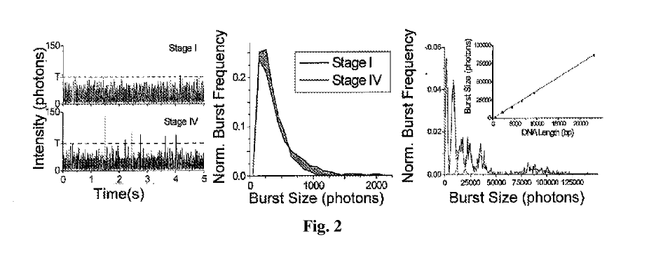

Using the μCICS platform, we have performed CNA analysis directly from serum with a 1-step assay called single molecule DNA integrity analysis (smDIA). With this assay, we are able to directly measure both DNA integrity (i.e. DNA fragment size) and DNA quantity without PCR amplification, DNA isolation, or separation steps. Previous studies have shown that the DNA integrity (i.e. the prevalence of long DNA fragments in the blood) can be correlated to the presence of cancer in a wide variety of cancers such as gynecological, colon, breast, and head and neck. The assay is performed directly from patient serum using a single reagent, in less than 1 hour, and at a cost of less than $0.50. As shown in FIG. 2, the Stage IV cancer patient (blue) has a higher prevalence of large fluorescent bursts than the Stage I patient (green). These larger bursts correspond to long DNA fragments which can be indicative of advanced disease. Because the concentrations of these CNAs is so low, standard DNA integrity analysis (DIA) relies exclusively on nested qPCR for amplification and determination of fragment size. Nested qPCR, however, is expensive, error prone, and tedious. This data illustrates the manner in which μCICS can thoroughly streamline CNA analysis by performing an identical analysis in a much more rapid and efficient manner.

The smDIA assay is based on burst size distribution analysis (BSDA). BSDA uses fluorescent probes, such as DNA intercalating dyes, to stoichiometrically label DNA. The number of bound fluorescent probes on each molecule is then correlated to the length of that particular DNA fragment. As each DNA fragment traverses the CICS observation volume, it emits a fluorescent burst that is linearly correlated to the fragment size. To perform this assay, TOTO-3 (Invitrogen) is mixed into the serum sample and allowed to react for 30 minutes after which the entire labeled sample is diluted 75× before being analyzed on the μC1CS platform. The high sensitivity of the μCICS platform requires that the CNA containing serum actually be diluted before CICS and allows <10 μl of patient serum to be used per assay. FIG. 2 illustrates the linear correlation between fluorescent burst size and DNA length. Currently, the μCICS prototype can accurately size individual DNA molecules from 564 bp-23.1 kbp in length. Further modifications are currently being performed to push this range down to 125 bp. This analysis cannot be done using standard CS.

### B. Single Molecule DNA Counting.

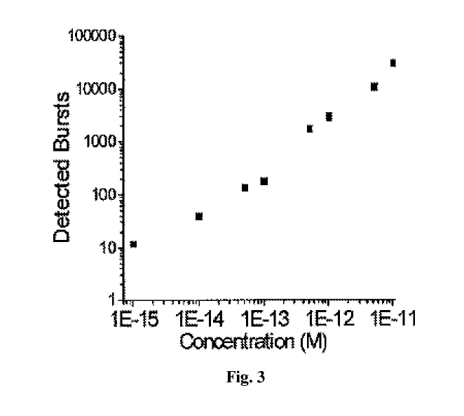

Low concentrations of DNA can be accurately quantified by direct counting of the fluorescent bursts. We conducted experiments measuring a set of highly diluted pBR322 DNA samples (4.3 kbp) labeled with fluorescent probes. The fluorescent burst rate decreased linearly with the DNA concentration (FIG. 3); yet, DNA concentrations as low as 1 femtomolar (2.8 pg/ml) were still clearly determined. In contrast, commonly used DNA quantification methods such as UV absorption and fluorescence DNA quantification kits are only able to measure DNA of concentrations higher than 100's pg/ml.

C. DNA Mutation, DNA Methylation, and miRNA Analysis.

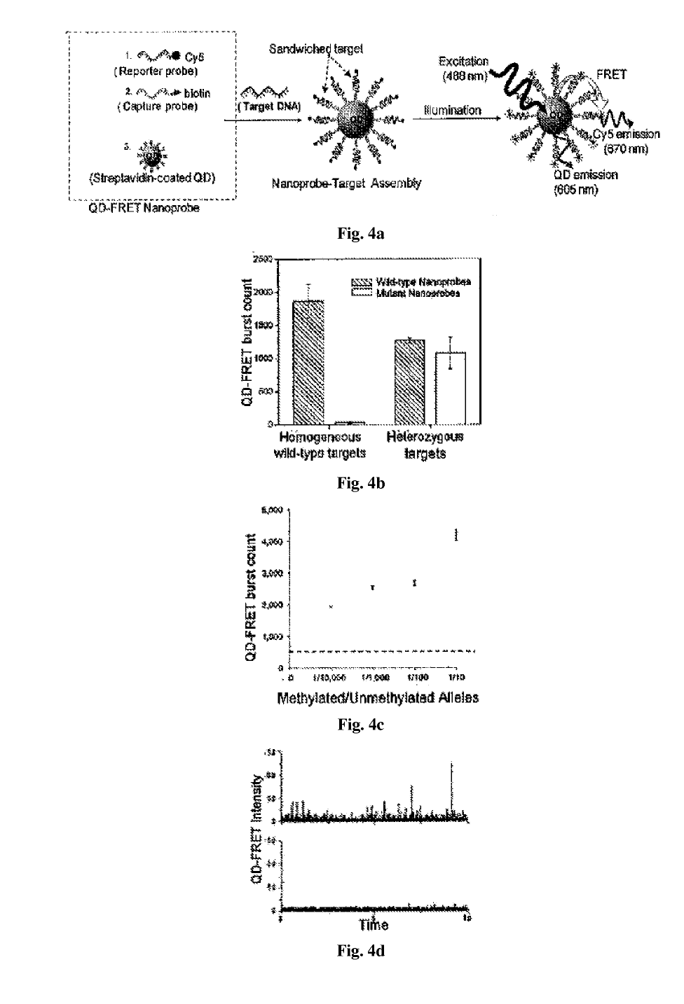

We have developed additional probe technologies for single molecule analysis of gene mutation status, miRNA, and DNA methylation based on quantum dot fluorescence resonance energy transfer (QD-FRET) (Bailey et al. (2008) “Quantitative ultrasensitive detection of DNA methylation through MS-qFRET.” ASCO-NCI-EORTC Conference, Vol. Hollywood, Fla.; Bailey et al. (2008) “High-throughput quantitative DNA methylation screening using quantum dot based nanotechnology assay.” Third International AACR Conference: Molecular Diagnostics in Cancer Therapeutic Development, Vol. Philadelphia, Pa.; Yeh et al. (2006) Nucleic Acids Research 34:e35; Zhang et al. (2005) Nature Materials 4, 826-31). (Using QD-FRET we have demonstrated the detection of sequence specific DNA at concentrations of <5 femtomolar (Zhang et al. (2005, supra)). These technologies can be combined with the μCICS platform to form a powerful tool for analyzing multiple types of CNA markers simultaneously, a feat that cannot be easily or efficiently done with any other platform. FIG. 4 shows data for single molecule assays of DNA mutation, DNA methylation, and miRNA analysis. We have detected single nucleotide polymorphisms in the KRAS gene with high sensitivity and high discrimination of mutant versus wild-type alleles (Yeh et al. (2006, supra)). This technology was used to discriminate between homozygous and heterozygous mutations in ovarian serous tumors. In addition, we have performed DNA methylation analysis using methylation specific quantum dot FRET (MS-qFRET) where we were able to detect as little as 15 pg of methylated DNA (˜5 genomic equivalents) in 150 ng of excess unmethylated DNA (Bailey et al. (2009) Genome Research 19, 1455-61). MS-qFRET was clinically applied to detect the methylation status of three tumor suppressor genes in the sputum of lung cancer patients. Finally, we have successfully detected miRNA using QD-FRET nanosensors. QD-FRET nanosensors comprising locked nucleic acid (LNA) probes were designed to hybridize to short miRNA targets with high specificity.

### D. Validate μCICS by Performing CNA Analysis of Cancer Patient Serum

The validation of the hardened μCICS platform will comprise two steps: 1) clinical validation of μCICS in CNA based cancer diagnostics using a pilot cohort, and 2) technical validation of the proposed modifications. The clinical validation will serve to demonstrate the feasibility of μCICS in the clinical analysis of two promising CNA markers, DNA integrity and DNA methylation. In contrast, the technical validation will be performed using only μCICS to determine whether the proposed modifications have been effective in increasing overall robustness. This will be accomplished by comparing the results of novice and experienced user groups in DNA mutation analysis of synthetic targets. Of note, the main purpose of this validation is to apply the hardened platform in testing of patient samples to ensure that our technology is readily applicable in a clinical setting. The results of this study and validation step will provide us with valuable feedback for future modifications, if necessary, and to facilitate the implementation of this technology in the future clinical trials.

E. Clinical Validation using DNA integrity and DNA Methylation.

Patient serum samples will be analyzed using both μCICS and PCR-based methods to compare the relative merits of these different techniques. A small pilot cohort will consist of 20 late stage ovarian cancer and 20 age-matched healthy control serum samples. DNA integrity will be analyzed using μCICS and quantitative real-time PCR while DNA methylation will be analyzed using μCICS and methylation specific PCR (MSP). These procedures will be carried out using conventional methods. The specimens will be obtained from the Gynecologic Pathology Tumor/Blood Bank at the Johns Hopkins Hospital. All the specimens will be anonymous and the experimental procedures will be performed in accordance to the guidelines of the Institutional Review Board.

DNA Integrity. It has been demonstrated that increased size and quantity of circulating DNA fragments may be found in the blood of cancer patients as compared to individuals without clinically known cancer. This may be attributable to the tendency for neoplastic cells to evade the normal apoptotic pathways in which DNA is uniformly truncated into small fragments ˜200 bp in length. Therefore, the study of DNA integrity (i.e. DNA fragment length) could shed new light on a promising, unique, and universal biomarker for cancer screening, detection, and treatment monitoring.

Methods. DNA integrity will be analyzed using both μCICS and quantitative real-time PCR (qPCR) to demonstrate the full potential of μCICS for rapid and accurate CNA analysis. This will be the primary clinical validation step because it implements the full capabilities of μCICS including microfluidic sample processing, automated analysis, and automated data processing. Fully automated smDIA analysis will be performed on patient serum samples using the μCICS platform as described above. Briefly, serum sample and a disposable microfluidic device will be loaded into the machine by the user after which the μCICS platform will perform all assay steps including metering, mixing of the sample and TOTO-3 probe, incubation, and dilution. Once the microfluidic sample processing is finished, the sample will be transported to the analysis region for CICS detection. Finally, the automated software will perform data processing to determine DNA size distribution and DNA quantity. This method streamlines testing and reduces variability by eliminating nearly all user input.

Traditional analysis of DNA integrity with qPCR will be performed using our previously established procedures. Briefly, we will use the beta-actin genomic locus as the marker and 10 loci will be measured for each sample. Five primers (one forward and four nested reverse primers) for each locus will be used to probe the relative fragment concentrations at 100, 200, 400, and 1,000 bp. The Bio-Rad iCycler software monitors the changes in fluorescence of SybrGreen I dye (Molecular Probe, Eugene, Oreg.) during each cycle. The threshold (Ct) value for each reaction will be calculated by the iCycler software package to determine the quantity of DNA fragments of a particular length. The average quantity and variance of each fragment length will be analyzed based on the measurement results from the 10 loci. This will give a characteristic DNA integrity spectrum for each patient that can be compared to the μCICS smDIA results. A direct comparison of the proportion of 100, 200, 400, and 1000 by fragments obtained using smDIA and qPCR will be performed. An additional comparison of cost, time, and effort will also be made.

DNA Methylation. DNA methylation is associated with the silencing of key genes during tumorigenesis and can be utilized as a specific cancer-associated biomarker. Therefore, reliable detection offers great promise in cancer risk assessment, cancer diagnostics, prognostic assessment of tumor behavior, and prediction of therapeutic response. Furthermore, these abnormal epigenetic changes appear to be an early event that precedes detection of genetic mutations. Thus, detection of promoter hypermethylation can be a valuable tool in both the early and late stages of cancer management.

Methods. We will further demonstrate μCICS by detecting methylated DNA in the previous ovarian cancer serum samples. The genes to be analyzed will be BRCA1 and RASSFIA. Serum based analysis of promoter hypermethylation in these two genes was previously accomplished using methylation specific PCR (MSP) (Herman et al. (1996) Proc Natl Acad Sci USA 93, 9821-6). Using our previous studies of QD-FRET probes for DNA methylation detection as a guide (Yeh et al. (2006, supra); Zhang et al. (2005, supra)), we will design new methylation-specific QD-FRET nanosensor probes for direct hybridization to methylated DNA. Our previously validated energy transfer pair, 605QD (donor) and Cy5 (acceptor) (Zhang et al. (2005, supra), will be used in the QD-FRET system. In order to facilitate methylation-specific hybridization, the serum DNA will be pre-treated with sodium bisulfate, following the established procedures, to convert cytosine residues to uracils. As a result, a Cy5 FRET signal will only be seen when the complimentary methylated sequences are present in serum. The μCICS system will be used to accurately quantify the degree of methylation in the 20 ovarian cancer samples and 20 healthy controls. These samples will also be analyzed using the standard MSP method to evaluate and compare the differences between the two technologies.

### F. Technical Validation Using DNA Point Mutations.

To show that our modifications have been effective in reducing systemic error and operator variability, DNA mutation analysis will be performed on synthetic targets by two user groups, novice and experienced. The results obtained by these two user groups will be compared and combined with user feedback to show that the system is robust and reproducible.

DNA Point Mutations. Cancers are caused by the accumulation of multiple mutations in the genes that regulate cell growth, death and other cellular behaviors. Since the majority of mutations are associated with sequence variations such as single nucleotide substitutions, deletions, and insertions, point mutations can serve as generic markers for cancer diagnostics. We have previously developed a highly specific nanosensing system for point mutation detection by combining QD-FRET probes and oligonucleotide ligation (Yeh et al. (2006, supra)). Using μCICS, this method can be applied for analyzing gene mutation status in CNAs.

Methods. To test the robustness and reproducibility of the μCICS platform, we will use point mutation detection in the KRAS gene as a model system. We will design QD-FRET nanosensors that are specific to a common KRAS mutation (Yeh et al. (2006, supra)). Each QD-FRET nanosensor consists of a common probe and a discrimination probe. The common probe is biotinylated at the 3′ end and binds to both wild type and mutant alleles. The discrimination probe is labeled with Cy5 at the 5′-end and contains the mutant base at the 3′-end. Only in the presence of complimentary mutant allele can the common probe and discrimination probe co-hybridize and be ligated together. After ligation and denaturing of ligation products, μCICS will be used to detect FRET-induced Cy5 fluorescent emission that is indicative of the mutant allele.

Since this experiment is designed to evaluate the level of robustness and ease-of-use, we will use synthetic DNA that mimics the above KRAS hotspot sequence for the test. Synthetic targets are chosen to eliminate the sample variability. Two sets of users will be trained by Circulomics, novice users and power users. Novice users will be given a basic 1 hour training and will consist of 2 clinical researchers and 2 lab technicians with no previous CICS or single molecule detection experience. Circulomics will also thoroughly train 4 power users. These users will be graduate students within our lab that already have significant experience with both traditional CS and CICS. Both user groups will be given a series of samples with unknown concentrations of mutant DNA and asked to determine the concentrations using a single protocol developed by Circulomics Inc. The microfluidic device developed in C.2.3.a. will be adapted and used in this test. Direct comparison of the results obtained by the novice user group and power user group will be used to assess problematic areas, if any, in the μCICS platform. Challenging steps within the automated system will be evaluated and redesigned, until test results between the two groups of users fall within the normal variation of the QD-FRET assay.

### Example II

### System for CICS

The terms light, optical, optics, etc are not intended to be limited to only visible light in the broader concepts. For example, they could include infrared and/or ultraviolet regions of the electromagnetic spectrum according to some embodiments of the current invention.

An embodiment of the current invention provides a confocal spectroscopy system that can enable highly quantitative, continuous flow, single molecule analysis with high uniformity and high mass detection efficiency. Such a system will be referred to as a Cylindrical Illumination Confocal Spectroscopy (CICS) system. CICS is designed to be a highly sensitive and high throughput detection method that can be generically integrated into microfluidic systems without additional microfluidic components.

Rather than use a minute, diffraction limited point, CICS uses a sheet-like observation volume that can substantially entirely span the cross-section of a microchannel. It is created through the 1-D expansion of a standard diffraction-limited detection volume from approximately 0.5 fL to 3.5 fL using a cylindrical lens. Large observation volume expansions in 3-D (>100× increase in volume) have been previously performed to directly increase mass detection efficiency and to decrease detection variability by reducing the effects of molecular trajectory (Wabuyele, M. B., H. Farquar, W. Stryjewski, R. P. Hammer, S. A. Soper, Y. W. Cheng, and F. Barany. 2003. Approaching real-time molecular diagnostics: single-pair fluorescence resonance energy transfer (spFRET) detection for the analysis of low abundant point mutations in K-ras oncogenes. J. Am. Chem. Soc. 125:6937-6945; Habbersett, R. C., and J. H. Jett. 2004. An analytical system based on a compact flow cytometer for DNA fragment sizing and single-molecule detection. Cytometry A 60:125-134; Filippova, E. M., D. C. Monteleone, J. G. Trunk, B. M. Sutherland, S. R. Quake, and J. C. Sutherland. 2003. Quantifying double-strand breaks and clustered damages in DNA by single-molecule laser fluorescence sizing. Biophys. J. 84:1281-1290; Chou, H.-P., C. Spence, A. Scherer, and S. Quake. 1999. A microfabricated device for sizing and sorting DNA molecules. Proceedings of the National Academy of Sciences 96:11-13; Goodwin, P. M., M. E. Johnson, J. C. Martin, W. P. Ambrose, B. L. Marrone, J. H. Jett, and R. A. Keller. 1993. Rapid sizing of individual fluorescently stained DNA fragments by flow cytometry. Nucl. Acids Res. 21:803-806). However, these approaches often still require molecular focusing and/or unnecessarily compromise sensitivity since observation volume expansion in the direction of molecular travel is superfluous. For example, much pioneering work has been performed by Goodwin et al. in reducing detection variability through a combination of 3-D observation volume expansion (1 pL) and hydrodynamic focusing. While highly sensitive and uniform, these flow cytometry based methods use an orthogonal excitation scheme that is ill suited to incorporation with microfluidic systems. Chou et al., on the other hand, have performed a 3-D observation volume expansion to increase uniformity in an epi-fluorescent format for DNA sizing in a PDMS microfluidic device. The large size of the observation volume (375 fL) reduces signal-to-noise ratio and limits sensitivity to the detection of large DNA fragments (>1 kbp). Rather than a large 3-D expansion, a smaller 1-D expansion can be used to increase mass detection efficiency and increase detection uniformity while having a reduced effect on signal-to-noise ratio and detection sensitivity. 1-D beam shaping using cylindrical lenses has been recently applied in selective plane illumination microscopy (Huisken, J., J. Swoger, F. Del Bene, J. Wittbrodt, and E. H. K. Stelzer. 2004. Optical Sectioning Deep Inside Live Embryos by Selective Plane Illumination Microscopy. Science 305:1007-1009), confocal line scan imaging (Ralf, W., Z. Bernhard, and K. Michael. 2006. High-speed confocal fluorescence imaging with a novel line scanning microscope. J. Biomed. Opt. 11:064011), imaging-based detection of DNA (Van Orden, A., R. A. Keller, and W. P. Ambrose. 2000. High-throughput flow cytometric DNA fragment sizing. Anal. Chem. 72:37-41), and fluorescence detection of electrophoretically separated proteins (Huang, B., H. K. Wu, D. Bhaya, A. Grossman, S. Granier, B. K. Kobilka, and R. N. Zare. 2007. Counting low-copy number proteins in a single cell. Science 315:81-84) but have not been thoroughly explored in SMD. We present CICS as a confocal SMD system and method in which the trade-off between observation volume size, signal-to-noise ratio, detection uniformity, and mass detection efficiency can be easily modeled and optimized through 1-D beam shaping.

FIG. 5A is a schematic illustration of a cylindrical illumination confocal spectroscopy system 100 according to an embodiment of the current invention. The cylindrical illumination confocal spectroscopy system 100 includes a fluidic device 102 having a fluid channel 104 defined therein, an objective lens unit 106 arranged proximate the fluidic device 102, an illumination system 108 in optical communication with the objective lens unit 106 to provide light to illuminate a sample through the objective lens unit 106, and a detection system 110 in optical communication with the objective lens unit 106 to receive at least a portion of light that passes through the objective lens unit 106 from the sample. The illumination system 108 includes a beam-shaping lens unit 112 constructed and arranged to provide a substantially planar illumination beam 114 that subtends across, and is wider than, a lateral dimension of the fluid channel 104. The substantially planar illumination beam has an intensity profile that is wide in one direction orthogonal to the direction of travel of the beam (the width) while being narrow, relative to the wide direction, in another direction substantially orthogonal to both the direction of travel of the beam and the wide direction (the thickness). This substantially planar illumination beam is therefore a sheet-like illumination beam. The beam-shaping lens unit 112 can include, but is not limited to, a cylindrical lens. The detection system 110 includes an aperture stop 116 that defines a substantially rectangular aperture having a longitudinal dimension and a transverse dimension. The aperture stop 116 is arranged so that the rectangular aperture is confocal with an illuminated portion of the fluid channel such that the longitudinal dimension of the rectangular aperture substantially subtends the lateral dimension of the fluid channel without extending substantially beyond the fluid channel. In other words, the longitudinal, or long dimension, of the rectangular aperture is matched to, and aligned with, the illuminated width of the fluid channel 104. The transverse, or narrow dimension, of the rectangular aperture remains size matched to the narrow dimension, or thickness, of the illuminated sheet. Although the aperture is referred to as being substantially rectangular, it can be shapes other than precisely rectangular, such as an oval shape. In other words, the “substantially rectangular aperture” is longer in one dimension than in an orthogonal dimension. FIG. 5B shows the illumination light spread out to provide a substantially planar illumination beam 114. By arranging the substantially planar illumination beam 114 so that it extends sufficiently beyond the edges of the fluid channel 104 the bright central portion can be centered on the fluid channel. The aperture stop 116 can then be used to block light coming from regions outside of the desired illuminated slice of the fluid channel 104. The dimension of the beam expansion, the aperture size, and fluid channel size can be selected to achieve uniform detection across the channel according to an embodiment of the current invention. The beam is expanded such that the uniform center section of the Gaussian intensity profile covers the fluid channel. The remaining, non-uniform section is filtered out by the substantially rectangular aperture. For example, the substantially planar illumination beam incident upon said fluidic device is uniform in intensity across said fluid channel to within ±10% according to an embodiment of the current invention. To ensure that molecules within the microchannels are uniformly excited irrespective of position, the 1D beam expansion can be performed such that the max-min deviation across the microchannel is <20% according to some embodiments of the current invention. This leads to an optical measurement CV of ±6.5% due to illumination non-uniformity alone. For higher precision measurements, greater beam expansion can be performed at the cost of additional wasted illumination power. For example, given the same microchannel, a larger beam expansion can be performed such that the max-min variation is <5%, an optical measurement CV of <2% can be obtained.

In an embodiment of the current invention, we can use a 5 μm wide microchannel, for example. The aperture can be 600×50 μm (width×height). Given an 83-fold magnification, when the aperture is projected into sample space it ends up being about 7 μm wide, 2 μm wider than the channel. The laser beam is expanded to a 1/e² diameter of about 35 μm, 7-fold wider than the channel width, where the excitation is most uniform. Thus, we only collect from the center 7 μm of the total 35 μm. Then, molecules flow through 5 μm of the available 7 μm (i.e., the microchannel). The narrow dimension of the aperture is size matched to the narrow, diffraction limited width the illumination line in the longitudinal direction to maximize signal to noise ratio. This provides approximately 100% mass detection efficiency with highly uniform beam intensity across the microchannel. However, the broad concepts of the current invention are not limited to this particular example.

The fluidic device 102 can be, but is not limited to, a microfluidic device in some embodiments. For example, the fluid channel 104 can have a width and/or depth than is less than a millimeter in some embodiments. The fluidic device can be, but is not limited to, a microfluidic chip in some embodiments. This can be useful for SMD using very small volumes of sample material, for example. However, other devices and structures that have a fluid channel that can be arranged proximate to the objective lens unit 106 are intended to be included within the definition of the fluidic device 102. For single fluorophore analysis, a fluid channel that has a width less than about 10 μm and a depth less than about 3 μm has been found to be suitable. For brighter molecule analysis, a fluid channel that has a width less than about 25 μm and a depth less than about 5 μm has been found to be suitable. For high uniformity analysis, a fluid channel has a width less than about 5 μm and a depth less than about 1 μm has been found to be suitable.

The objective lens unit 106 can be a single lens or a compound lens unit, for example. It can include refractive, diffractive and/or graded index lenses in some embodiments, for example.

The illumination system 108 can include a source of substantially monochromatic light 118 of a wavelength selected to interact in a detectable way with a sample when it flows through said substantially planar illumination beam in the fluid channel 104. For example, the source of substantially monochromatic light 118 can be a laser of a type selected according to the particular application. The wavelength of the laser may be selected to excite particular atoms and/or molecules to cause them to fluoresce. However, the invention is not limited to this particular example. The illumination system 108 is not limited to the single source of substantially monochromatic light 118. It can include two or more sources of light. For example, the illumination system 108 of the embodiment illustrated in 59A has a second source of substantially monochromatic light 120. This can be a second laser, for example. The second source of substantially monochromatic light 120 can provide illumination light at a second wavelength that is different from the wavelength from the first laser in some embodiments. Additional beam shaping, conditioning, redirecting and/or combining optical components can be included in the illumination system 108 in some embodiments of the current invention. FIG. 5A shows, schematically, an example of some additional optical components that can be included as part of the illumination system 108. However, the general concepts of the current invention are not limited to this example. For example, rather than free space combination f the illumination beam, the two or more beams of illumination light can be coupled into an optical fiber, such as a multimode optical fiber, according to an embodiment of the current invention.

The detection system 110 has a detector 122 adapted to detect light from said sample responsive to the substantially monochromatic light from the illumination system. For example, the detector 122 can include, but is not limited to, an avalanche photodiode. The detection system can also include optical filters, such as a band pass filter 124 that allows a selected band of light to pass through to the detector 122. The pass band of the band pass filter 124 can be centered on a wavelength corresponding to a fluorescent wavelength, for example, for the sample under observation. The detection system 110 is not limited to only one detector. It can include two or more detectors to simultaneously detect two or more different fluorescent wavelengths, for example. For example, detection system 110 has a second detector 126 with a corresponding second band pass filter 128. A dichroic mirror 130 splits off a portion of the light that includes the wavelength range to be detected by detector 126 while allowing light in the wavelength range to be detected by detector 122 to pass through. The detection system 110 can include various optical components to shape, condition and/or otherwise modify the light returned from the sample. FIG. 5A schematically illustrates some examples. However, the general concepts of the current invention are not limited to the particular example illustrated.

The cylindrical illumination confocal spectroscopy system 100 also has a dichroic mirror 132 that allows at least a portion of illumination light to pass through it while reflecting at least a portion of light to be detected.

The cylindrical illumination confocal spectroscopy system 100 can also include a monitoring system 134 according to some embodiments of the current invention. However, the monitoring system 134 is optional.

In addition, the detection system can also include a signal processing system 136 in communication with the detectors 122 and/or 126 or integrated as part of the detectors.

The cylindrical illumination confocal spectroscopy system 100 can be used to analyze single molecules, beads, particles, cells, droplets, etc. according to some embodiments of the current invention. The single molecules, beads, cells, particles, droplets, etc. can incorporate an entity such as a fluorophore, microparticle, nanoparticle, bead, etc. that elicits an optical signal that can be detected by the cylindrical illumination confocal spectroscopy system 100 according to some embodiments of the current invention. However, the general concepts of the current invention are not limited to these particular examples.

### Examples

As depicted in FIG. 5A, high signal-to-noise detection can be enabled by the combination of a cylindrical lens (CL) 112 with a novel, microfabricated confocal aperture (CA) 116 according to an embodiment of the current invention. The cylindrical lens 112 is used to expand the illumination volume laterally in 1-D (along the x-direction or width) while remaining diffraction limited in the y-direction to maximize signal-to-noise ratio (FIG. 5B). Then, a confocal aperture is used to limit light collection to only the center section of the illumination volume (FIG. 5C). The microfabricated confocal aperture is neither round nor slit-like as in typical SMD but is rectangular and mimics the shape of the CICS observation volume. Whereas typical pinholes are nominally sized to the 1/e² radius of the diffraction limited illumination volume (Centonze, V., and J. B. Pawley. 2006. Tutorial on Practical Confocal Microscopy and Use of the Confocal Test Specimen. In Handbook of Biological Confocal Microscopy. J. B. Pawley, editor. Springer, N.Y. 627-649), the CICS aperture is designed to occlude a much larger proportion of the illumination volume. Less than 30% of illumination volume in the x-direction is allowed to pass, such that a uniform, sheet-like observation volume is created. The final CICS observation volume is designed to be slightly larger than the accompanying microchannel in order to span the entire cross-section for uniform detection with near 100% mass detection efficiency, rectifying the limitations of traditional SMD without the drawbacks of molecular focusing or nanochannel confinement. This enables the resultant fluorescence bursts to not only be discrete but also to be so uniform they become digital in nature, ensuring accurate and robust quantification analysis.

CICS according to some embodiments of the current invention is shown to be superior to traditional SMD in accurate quantification and precise burst parameter determination. First, the limitations of traditional SMD and the potential benefits of CICS are theoretically explored using a combination of semi-geometric optics modeling and Monte Carlo simulations in the following examples. CICS is optimized for a 5×2 μm microchannel (w×h) and theoretically shown to have near 100% mass detection efficiency and <10% relative standard deviation (RSD) in the uniformity of detected fluorescence. Then, these models are validated using experimentally acquired observation volume profiles. Finally, CICS is implemented and demonstrated in two microfluidic systems through the detection of fluorescently stained DNA in a silicon device and a polydimethylsiloxane (PDMS) device and the detection of single Cy5 dye molecules in a PDMS device.

### Materials and Methods

### Numerical Simulation—Observation Volume

The observation volume (OV) profiles of confocal spectroscopy systems and their effects have been well explored in fluorescence correlation spectroscopy and SMD (Hess, S. T., and W. W. Webb. 2002. Focal volume optics and experimental artifacts in confocal fluorescence correlation spectroscopy. Biophys. J. 83:2300-2317; Enderlein, J., D. L. Robbins, W. P. Ambrose, and R. A. Keller. 1998. Molecular shot noise, burst size distribution, and single-molecule detection in fluid flow: Effects of multiple occupancy. J. Phys. Chem. A 102:6089-6094; Enderlein, J., D. L. Robbins, W. P. Ambrose, P. M. Goodwin, and R. A. Keller. 1997. Statistics of single-molecule detection. J. Phys. Chem. B 101:3626-3632; Goodwin, P. M., W. P. Ambrose, J. C. Martin, and R. A. Keller. 1995. Spatial dependence of the optical collection efficiency in flow-cytometry. Cytometry 21:133-144; Rigler, R., U. Mets, J. Widengren, and P. Kask. 1993. Fluorescence correlation spectroscopy with high count rate and low-background—analysis of translational diffusion. Eur. Biophys. J. Biophy. 22:169-175; Qian, H., and E. L. Elson. 1991. Analysis of confocal laser-microscope optics for 3-D fluorescence correlation spectroscopy. Appl. Optics 30:1185-1195; Chen, Y., J. D. Muller, P. T. So, and E. Gratton. 1999. The photon counting histogram in fluorescence fluctuation spectroscopy. Biophys. J. 77:553-567). We adopt a simple semi-geometric optics approach previously used by Qian and Rigler to theoretically model and guide the design of the CICS system (see Observation Volume Modeling below).

The code for simulation of the OV profiles was written in Matlab (The Mathworks, Cambridge, Mass.). In both simulations, the total observation volume, 10×10.2×12 μm (x×y×z), was discretized into 0.05×0.15×0.05 μm (x×y×z) elements. The OV function was evaluated at each element and stored in a 3D array for analysis. The image space, 8×8 μm, was discretized into 0.02×0.02 μm elements. The constants used for standard SMD simulation were: wₒ=0.5 μm, pₒ=75 μm, M=83.3, n=1.47, λ=525 nm, NA=1.35, and rₒ=0.5 μm. The constants used for CICS simulation were: xₒ=25 μm, yₒ=0.5 μm, zₒ=5 μm, pₒ=300 μm, M=83.3, n=1.47, λ=525 nm, NA=1.35, and rₒ=0.5 μm.

### Observation Volume Modeling

The observation volume profile OV(r,z) reflects the detected intensity of fluorescence from a molecule located at a specific point (r,z). It can be calculated from the collection efficiency CEF(r,z) and illumination intensity I(r,z) using:

OV(r,z)=CEF(r,z)×I(r,z) (1)

where r=(x,y). The z axis is taken as the optical axis while the x axis and y axis run perpendicular and parallel to the direction of flow, respectively.

The illumination profile I(r,z) for traditional SMD can be approximated by that of a focused laser beam using a Gaussian-Lorentzian function:

$$I ( r , z ) = \frac{2 P}{π {w}^{2} ( z )} exp ( - 2 \frac{{r}^{2}}{{w}^{2} ( z )} ) \qquad ( 2 )$$

where P accounts for the illumination power of the laser. The beam waist radius w(z) can be found using:

$$\begin{matrix}{w}^{2} ( z ) = {w}_{o }^{2} + {z}^{2} {tan}^{2} δ , & ( 3 ) \\ {w}_{o} = \frac{λ}{n π tan δ} , & ( 4 )\end{matrix}$$

where λ is the laser wavelength, n is the index of refraction, and δ is the focusing angle of the laser beam at the 1/e² radius.

For CICS, since the illumination profile is expanded in 1-D and no longer radially symmetric, a 3-D Gaussian function is used:

$$I ( r , z ) = P exp [ - 2 ( \frac{{x}^{2}}{{x}_{0}^{2}} + \frac{{y}^{2}}{{y}_{0}^{2}} + \frac{{z}^{2}}{{z}_{0}^{2}} ) ] \qquad ( 5 )$$

where xₒ, yₒ, and zₒ are the beam waist radii in the x, y, and z directions, respectively.

The collection efficiency CEF(r,z) represents the proportion of light collected by a point emitter located at (r,z). In confocal optics, the collection efficiency can be expressed as the convolution of the microscope point spread function PSF(r′,r,z) and the confocal aperture transmission function T(r′):

$$CEF ( r , z ) = \frac{1}{Δ} \int T ( {r}^{′} ) PSF ( {r}^{′} , r , z ) d {r}^{′} \qquad ( 6 )$$

where r′ is the image space coordinate and Δ is the normalization factor:

$$Δ = \int circ ( \frac{{r}^{′}}{{s}_{0}} ) PSF ( {r}^{′} , 0 , 0 ) d {r}^{′} . \qquad ( 7 )$$

The microscope PSF reflects the image of a point source located at (r,z). As long as a highly corrected microscope objective is used, the microscope PSF can be assumed to be isoplanatic and isochromatic. It is approximated using:

$$\begin{matrix}PSF ( {r}^{′} , r , z ) = \frac{circ ( \frac{{r}^{′} - r}{R ( z )} )}{π {R}^{2} ( z )} & ( 8 ) \\ {R}^{2} ( z ) = {R}_{o}^{2} + {z}^{2} {tan}^{2} α & ( 9 )\end{matrix}$$

where Rₒ is the resolution limit of the objective and the numerical aperture is defined by NA=n sin α.

The aperture transmission function used is:

$$\begin{matrix}T ( r ) = circ ( \frac{r}{{s}_{0}} ) & ( 10 ) \\ circ ( \frac{r}{{s}_{0}} ) = \{ \begin{matrix}1 if \vert r \vert \leq {s}_{o} \\ 0 if \vert r \vert > {s}_{0}\end{matrix} & ( 11 )\end{matrix}$$

where sₒ is the pinhole radius in image space defined by sₒ=rₒ/M, rₒ is actual the pinhole radius, and M is the magnification at the pinhole. The same disk function is used for both traditional SMD and CICS simulations. The rectangular shape of the actual CICS aperture is not accounted for in the optical model. This leads to a slight overestimation of the background noise and underestimation of the signal variability.

Although using a semi-geometric optics model neglects higher order effects such as those resulting from diffraction and high-NA optics, the calculated OV profiles still provide a reasonable comparison between standard SMD and CICS as will be experimentally shown.

### Numerical Simulation—Monte Carlo

Once the OV profiles are calculated, Monte Carlo simulations can be used to model the stochastic procession of molecules through the observation volume and the Poisson photoemission and detection process. This method is used to produce simulated single molecule trace data that can be analyzed in a manner identical to experimental data. During each time step, molecules are generated at random initial locations according to the concentration and propagated a distance in the y-direction according to the flow velocity.

The detected fluorescence intensity from a molecule at (r,z) can be calculated by:

I_{f}(r,z)=β_{f}OV(r,z)Δt (12)

where Δt is the integration time step and β_{f} is a constant that accounts for factors such as the quantum yield and absorption coefficient of the fluorophore, the transmission of the optics, and the quantum efficiency of the detector.

The total collected fluorescence for all points within the observation volume can be found through integration over the entire volume:

I_{f}=∫∫β_{f}OV(r,z)drdzΔt. (13)

The same process can be repeated to calculate the background noise intensity Iₙ by substituting the constant βₙ for β_{f}. The total collected intensity Iₜ is given by:

Iₜ=I_{f}+Iₙ (14)

The final signal, SMD, takes into account the Poisson photoemission and photodetection process:

SMD=Poi(Poi(Iₜ)) (15)

Additional variability may be added to account for other sources of variability such as staining variability and variability in DNA length.

The Monte Carlo simulation was implemented in Matlab (The Mathworks, Cambridge, Mass.). Each fluorescent molecule has no volume and is assumed to be a point emitter. The models simulate 4 and 8 kb dsDNA stained at a 5:1 bp:dye ratio. The nominal DNA concentration was 1 pM unless otherwise indicated. A constant flow profile of v=1.5 mm/s was used in all simulations. Diffusion is ignored, and molecules travel in the y-direction only. A 0.1 ms time step was used, and all simulations were run for 100 s. Two data traces, one with and one without Poisson fluctuations in the photoemission and photodetection process, are stored, allowing accurate determination of mass detection efficiency. The signal-to-background ratio (SBR=average burst height/average background) was adjusted to match experimental data. In standard SMD, the simulation approximates the flow of molecules in a channel significantly larger than the observation volume. For CICS, a channel of 10.2×5×2 μm (l×w×h) was simulated.

### CICS Instrumentation

All data were acquired with a custom-built, dual laser, dual detection channel, single molecule spectroscopy system capable of both traditional SMD and CICS with 488 nm and/or 633 nm laser illumination and detection at 520 nm and 670 nm. The beam from a 488 nm Ar-ion laser (Melles Griot, Carlsbad, Calif.) was expanded, collimated, and filtered using two doublet lenses (f=50 mm and f=200 mm, Thorlabs, Newton, N.J.) and a 150 μm pinhole (Melles Griot, Carlsbad, Calif.) arranged as a Keplerian beam expander. The beam from a 633 nm He—Ne laser (Melles Griot, Carlsbad, Calif.) is also expanded and filtered using similar optics. The two beams are spatially aligned using beam steering mirrors mounted on gimbals (U100-G2K, Newport, Irvine, Calif.) and combined using a dichroic mirror (z633RDC, Chroma Technology, Rockingham, Vt.). The laser powers are individually adjusted using neutral density filters (Thorlabs, Newton, N.J.). In CICS mode, a cylindrical lens (f=300 mm, Thorlabs, Newton, N.J.) is used to shape the beam into a sheet and focused into the back focal plane of the microscope objective. The laser is then tightly focused by a 100× oil-immersion (1.4 NA) objective (100× UPlanFl, Olympus, Center Valley, Pa.). The fluorescence is collected by the same objective and spectrally separated from the excitation light using a second dichroic mirror (z488/633RPC, Chroma Technology, Rockingham, Vt.). It is passed through a confocal aperture, further separated into two detection bands by a third dichroic mirror (XF2016, Omega Optical, Brattleboro, Vt.) and filtered by bandpass filters (520DF40 and 670DF40, Omega Optical, Brattleboro, Vt.) before being imaged onto silicon avalanche photodiodes (APD) (SPCM-CD2801 and SPCM-AQR13, PerkinElmer Optoelectronics, Fremont, Calif.) with f=30 mm doublet lenses (Thorlabs, Newton, N.J.). Holographic notch filters (HNPF-488.0-1 and HNPF-633.0-1, Kaiser Optical Systems, Ann Arbor, Mich.) are also used to reduce the background from scattered light. Using an f=150 mm doublet tube lens (Thorlabs, Newton, N.J.), the total magnification at the pinhole is ˜83×. For standard SMD, a circular pinhole (Melles Griot, Carlsbad, Calif.) is used but for CICS, a rectangular, microfabricated confocal aperture is used. Data is collected from the APDs by a PC using a PCI6602 counter/DAQ card (National Instruments, Austin, Tex.) that is controlled using software written in Labview (National Instruments, Austin, Tex.). Samples are positioned using a combination of a computer controlled, high resolution piezoelectric flexure stage (P-517.3CL, PI, Auburn, Mass.) and a manual XYZ linear stage (M-462, Newport, Irvine, Calif.). The entire system was built on a pneumatically isolated optical table (RS2000, Newport, Irvine, Calif.).

### Microfabricated Confocal Aperture

The confocal aperture is fabricated from a 4″ silicon wafer (300 μm thick, (1,0,0), SSP, p-type). 60 μm thick SPR220-7 (Shipley) is patterned using a triple spin coat and used as a masking material for a through wafer inductively coupled plasma/reactive ion etch (Trion Phantom RIE/ICP). The etch simultaneously forms the rectangular aperture and releases the die as a 9.5 mm diameter disk that can be mounted into a XYZθ-stage (RSP-1T and M-UMR5.25, Newport, Irvine, Calif.) for alignment. Apertures of 620×115 μm and 630×170 μm were used. Since the alignment of the aperture is critical to the observation volume uniformity, a RetigaExi CCD (QImaging Corporation, Surrey, BC, Canada) is used to guide the alignment. Image analysis is performed using IPLab (BD Biosciences Bioimaging, Rockville, Md.)

### Single Molecule Trace Data Analysis

Data analysis is performed using software written in Labview. A thresholding algorithm is first used to discern fluorescence bursts from background fluctuations. The threshold can be set either at a constant value or in proportion to the background fluctuation levels. The identified bursts can then be individually analyzed for burst width, burst height, and burst size after a background correction is performed. No smoothing algorithms are applied.

### OV Profile Acquisition

OV profile analysis was performed on the 488-SMD and 488-CICS systems. The experimental OV profiles were acquired by scanning a 0.24 μm yellow-green CML fluorescent bead (Invitrogen, Carlsbad, Calif.) through the OV using a high resolution piezoelectric stage (PI, Auburn, Mass.) and recording the resultant fluorescence intensity as a function of position. A low excitation laser power of 0.008 mW/cm² was used to minimize photobleaching. The fluorescent beads were diluted to a concentration of 2×10⁶ beads/ml using DI water. A 5 μl drop of the diluted bead solution was placed onto a No. 1 thickness glass coverslip (Fisher Scientific) and allowed to dry. Then, the beads were covered with a thin layer of poly-dimethylsiloxane (PDMS, Dow Corning, Midland, Mich.) for protection (Cannell, M. B., A. McMorland, and C. Soeller. 2006. Practical Tips for Two-Photon Microscopy. In Handbook of Biological Confocal Microscopy. J. B. Pawley, editor. Springer, N.Y. 900-905). Beads were imaged from the backside through the glass. A rough 100×100 μM (x×y) scan was used to locate individual beads. Once an isolated bead was found, it was scanned in 0.15×0.15×0.15 μm (x×y×z) steps over a 4×4×8 μm volume for standard SMD and in 0.25×0.15×0.15 μm steps over a 12×6×10 μm volume for CICS. The fluorescence intensity was binned in 1 ms intervals and averaged over 25 ms at each point.

pBR322DNA Preparation

For 488-SMD and 488-CICS analysis, pBR322DNA (New England Biolabs, Ipswich, Mass., 4.3 kbp) was stained with PicoGreen (Invitrogen, Carlsbad, Calif.) using the protocol developed by Yan (Yan, X. M., W. K. Grace, T. M. Yoshida, R. C. Habbersett, N. Velappan, J. H. Jett, R. A. Keller, and B. L. Marrone. 1999. Characteristics of different nucleic acid staining dyes for DNA fragment sizing by flow cytometry. Anal. Chem. 71:5470-5480). The DNA was diluted to 100 ng/mL in TE buffer and stained with 1 μM PicoGreen for 1 hour in the dark. It was then further diluted down to 1 pM in TE buffer for measurement. For 633-SMD and 633-CICS analysis, pBR322DNA was stained with TOTO-3 (Invitrogen, Carlsbad, Calif.). The DNA was diluted to 100 ng/mL in TE buffer and stained with TOTO-3 at a 5:1 base pair:dye ratio for 1 hour in the dark. It was then further diluted down to 1 pM in TE buffer for measurement.

### Cy5 Oligonucleotide Preparation

Single Cy5 5′ end-labeled 24 by ssDNA (Integrated DNA Technologies, Coralville, Iowa, Cy5-5′-AAGGGATTCCTGGGAAAACTGGAC-3′) was resuspended in DI water and diluted to 1 pM concentration in filtered TE buffer for measurement.

### 633-SMD/Cy5 Analysis in a Microcapillary

A flow cell was fabricated using 100 μm ID fused silica microcapillary tubing (Polymicro Technology, Phoenix, Ariz.). A syringe pump (PHD2000, Harvard Apparatus, Holliston, Mass.) was used to drive the Cy5 labeled oligonucleotide through the flow cell at a volumetric flow rate of 1 μl/min. The input laser power was 0.185 mW/cm², and a 1 ms photon binning time was used. A typical trace consists of 300 s of data.

488-CICS pBR322/PicoGreen-DNA Analysis in Silicon Microfluidics

For 488-CICS analysis of pBR322DNA, the cylindrical lens is inserted into the beam path, and the circular pinhole is swapped for a 620×115 μm rectangular confocal aperture. A microfluidic device was fabricated from silicon. First, 500×5×2 μm (l×w×h) channels were etched into a 4″, 500 μm thick, SSP, p-type, (1,0,0) silicon wafer using reactive ion etching and photoresist as a masking material. After etching, 0.8 mm through wafer fluidic vias were drilled into the silicon substrate using an abrasive diamond mandrel. Then, the channels were sealed by anodic bonding of 130 μm thick borosilicate glass (Precision Glass and Optics, Santa Ana, Calif.). Finally, Nanoport (Upchurch, Oak Harbor, Wash.) fluidic couplings were epoxied to the backside. A syringe pump was used to drive sample through the device at a typical volumetric flow rate of 0.001 μl/min such that the flow velocity was comparable to that of standard SMD. A 0.1 ms bin time was used. A typical trace consists of 300 s of data. The input laser power was 0.08 mW/cm².

### 633-CICS and 633-SMD/TOTO-3-DNA and Cy5 Oligonucleotide Analysis in PDMS Microfluidics

For 633-CICS analysis of both TOTO-3 stained pBR322DNA and Cy5, a 630×170 μm confocal aperture was used. Standard soft-lithography techniques (Younan Xia, G. M. W. 1998. Soft Lithography. Angewandte Chemie International Edition 37:550-575) were used to create 500×5×2 μm (l×w×h) PDMS channels bonded to #1 glass cover slips (Fisher Scientific, Pittsburgh, Pa.). A syringe pump was used to drive sample through the device at a volumetric flow rate of 0.001 μl/min such that the flow velocity was comparable to that of standard SMD. A 0.1 ms bin time was used in the pBR322DNA analysis while a 1 ms bin time was used in the Cy5 oligonucleotide analysis. A typical trace consists of 300 s of data. 1.85 mW/cm² and 0.057 mW/cm² illumination powers were used for CICS and SMD analysis of pBR322DNA, respectively. 3.7 mW/cm² and 0.185 mW/cm² illumination powers were used for CICS and SMD analysis of Cy5 oligonucleotide, respectively.

### Results

### Observation Volume Modeling

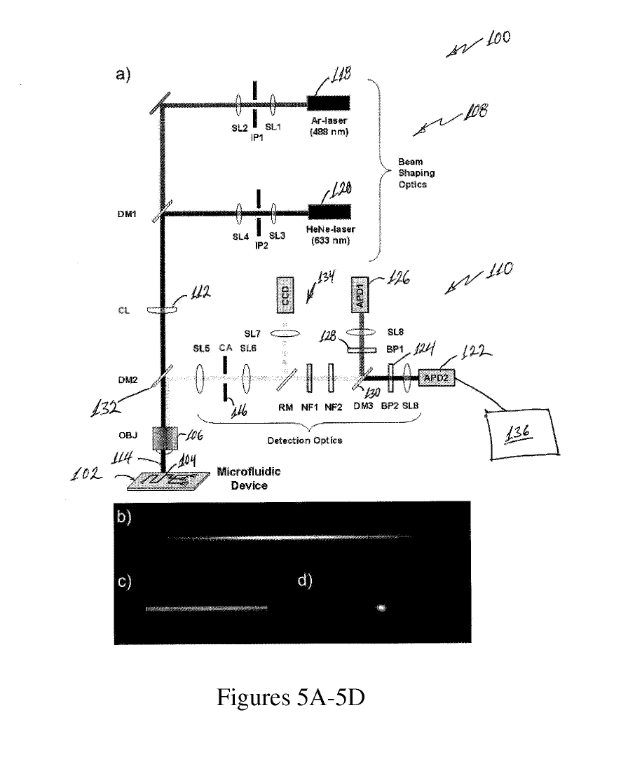

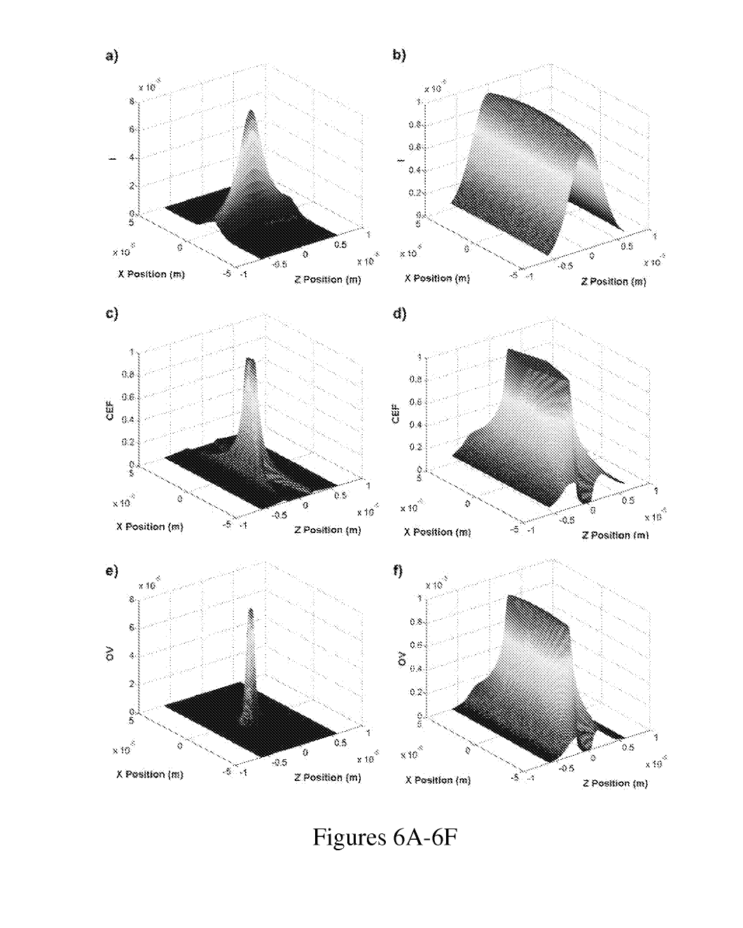

Individual molecules that traverse the observation volume of CICS are detected uniformly irrespective of location or trajectory whereas fluorescent signals that are detected using traditional SMD are a strong function of molecular trajectory. It is this enhancement in observation volume uniformity that can enable CICS to be significantly more accurate, precise, and quantitative than traditional SMD. A semi-geometric optics model is used to theoretically compare the OV profiles of CICS with traditional SMD. FIGS. 6A-6F show the calculated illumination, collection efficiency, and OV profiles for standard SMD and CICS.

The increased uniformity of CICS is created by two key modifications to the standard confocal spectroscopy system. Standard SMD has a diffraction limited illumination profile that is radially symmetric and has a 1/e² radius of approximately 0.5 μm (FIG. 6A). By using an appropriate cylindrical lens, this radius can be elongated in 1-D to approximately 25 μm to form a sheet of excitation light rather than a point (FIG. 6B). Since the illumination profile is expanded in 1-D perpendicular to flow only, noise from background is minimized while uniformity and mass detection efficiency are increased. Standard SMD also uses a small pinhole (˜100 μm) such that the collection efficiency decays sharply at regions away from the confocal point (FIG. 6C). In CICS, a large pinhole or aperture (˜600 μm) is used such that fluorescence can be uniformly collected from the entire 7×2 μm (w×h) center plateau region (FIG. 6D). However, with a standard pinhole the stray light is no longer optimally apertured due to the geometric discrepancy between the circular pinhole and the sheet-like illumination. For optimal results, a microfabricated rectangular aperture is used as subsequently described.

As shown in FIG. 6E, the result of the diffraction limited illumination profile and the sharply decaying collection efficiency is that traditional SMD has an OV profile that is nearly Gaussian in shape and varies sharply with position. Molecules that traverse the center of the observation volume result in much larger fluorescence bursts than molecules that travel through the edges, creating a train of highly variable single molecule bursts due to the typically random distribution of molecules in solution. This intrinsic variability makes accurate determination of burst parameters or burst frequency difficult. Conversely, due to the broad illumination profile and the uniform collection efficiency, FIG. 6F shows that the OV profile of CICS has a large plateau region of approximately 7×2 μm (w×h) where both excitation and detection occur in an extremely uniform manner. Over this plateau region, the detected fluorescence intensity is expected to have less than 10% RSD due to optical variation. Unlike standard SMD which requires nanochannel confinement (e.g. 0.35×0.25 μm, w×h) to achieve comparable performance (Foquet, M., J. Korlach, W. R. Zipfel, W. W. Webb, and H. G. Craighead. 2004. Focal volume confinement by submicrometer-sized fluidic channels. Anal. Chem. 76:1618-1626), CICS can be performed within a much larger microchannel (5×2 μm, w×h, >100× increase in cross-sectional area). Since the optimal microchannel is slightly smaller than the CICS observation volume, digital fluorescence bursts will be detected with near 100% mass detection efficiency.

### Monte Carlo Simulations

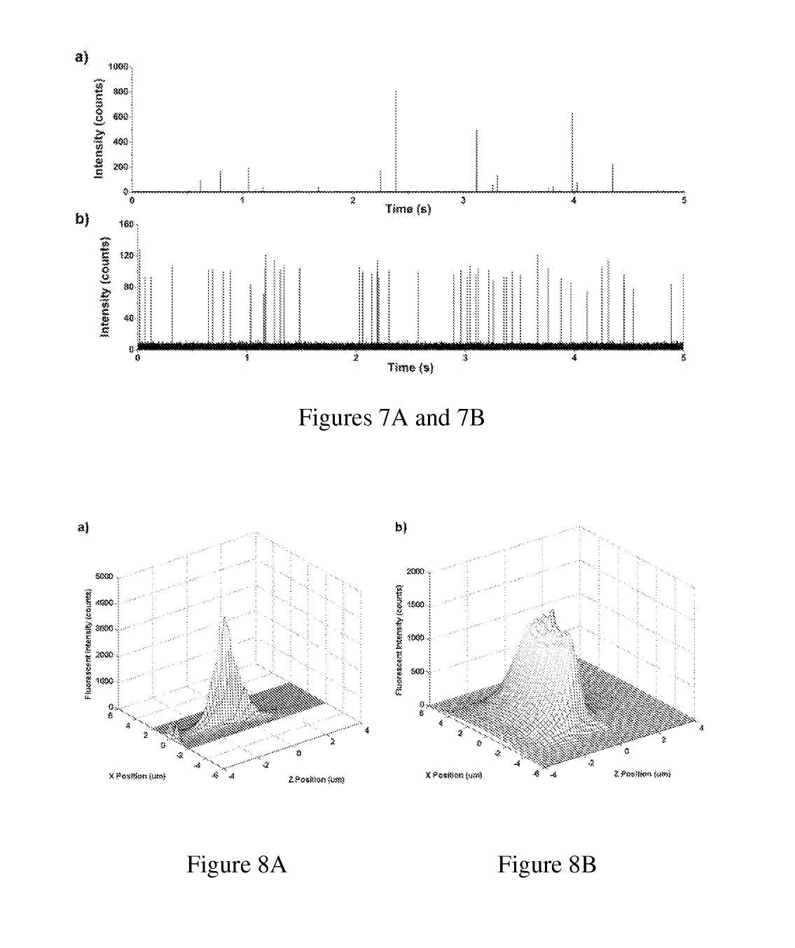

To further explore the effects of the observation volume non-uniformity and molecular trajectory, the Monte Carlo method is used to generate simulated single molecule traces based on the theoretical OV profiles in FIGS. 6A-6F. Fluorescent molecules are generated at random initial locations and propagated through the observation volume according to the flow profile. During each time step, the fluorescence signal arising from all molecules within the observation volume as well as the background signal is integrated. FIGS. 7A and 7B, respectively, depict two simulated traces for a proto-typical embodiment of traditional SMD performed within a channel that is larger than the observation volume and CICS performed within a 5×2 μm (w×h) microchannel. As expected, traditional SMD shows a smaller number of highly variable bursts due to the non-uniform OV profile while CICS shows a larger number of highly uniform bursts that appear digital due to the smooth plateau region.

The burst rate of CICS increases in direct proportion to the 1-D expansion. The large enhancement in mass detection efficiency is achieved through the combination of this increase in burst rate due to the observation volume expansion and the use of a microchannel that is size matched to the observation volume. The mass detection efficiency can be accurately analyzed in the simulation through a comparison of all randomly generated molecules against those detected after thresholding. When a discrimination threshold of 30 counts is applied, the mass detection efficiency of CICS within the 5×2 μm channel (w×h) is 100% with no false positives or false negatives due to the digital nature of the fluorescence bursts. If the channel size is further increased to 7×3 μm (w×h), the mass detection efficiency remains at 100% but the burst height variability increases from 13% RSD to 26% RSD, illustrating the tradeoff between observation volume size, throughput, and detection uniformity (data not shown).

In fact, the variability in burst height is no longer dominated by non-uniformity in the OV profile but rather the Poisson photoemission and detection process. Although the uniformity can be improved by changing the collimation optics and aperture should a larger observation volume be necessary, there will be a concurrent decrease in signal-to-noise ratio that is unavoidable. Further improvements must be found by increasing the fluorescence intensity through higher illumination powers or from longer photon binning times instead of optical modifications.

In contrast, since traditional SMD is usually performed within a channel that is much larger than the observation volume, it has an extremely low mass detection efficiency. For example, given a 100 μm ID microcapillary, the mass detection efficiency is less than 0.05% under the same threshold. This low mass detection efficiency is due to a combination of the minute observation volume, observation volume non-uniformity, thresholding artifacts, and Poisson fluctuations. The large majority of molecules (>99.6%) escape detection because of the size mismatch between the observation volume and the microcapillary. The remainder of the molecules (˜0.3%) is missed since their corresponding fluorescence bursts reside below the threshold and are indistinguishable from background fluctuations. To obtain 100% mass detection efficiency using standard SMD, nanochannel confinement or molecular focusing of molecules to a stream width of <<1 μm would be necessary.

Detailed analysis of the Monte Carlo data reveals that when thresholding algorithms are used to discriminate fluorescence bursts from background fluctuations, as is common practice, the quantification accuracy of traditional SMD is compromised due to thresholding artifacts. The burst rate is defined as the rate at which fluorescence bursts are detected and is proportional to the concentration of molecules in the sample as well as the sample flow rate and mass detection efficiency. The burst height is then defined as the maximum number of photon counts per bin time emitted by a molecule during a transit event. It is related to the brightness of the molecule, the observation volume uniformity, the flow rate, and photon binning time. The wide distribution of burst heights in standard SMD causes the burst rate and determined burst parameters to vary widely with the specific threshold applied as shown in Table 1. As the threshold is increased, the smaller bursts are progressively excluded, gradually decreasing the burst rate and shifting the average burst height upwards. Accurate determination of the absolute burst rate and burst height is extremely difficult since it is nearly impossible to distinguish between small fluorescence bursts arising from molecules that traverse the periphery of the observation volume and random background fluctuations. In contrast, since CICS bursts are uniform in size, they are much more robust when used with thresholding algorithms. The applied threshold can vary over a wide range without affecting either the burst rate or determined burst parameters. This is due to the digital nature of the fluorescence bursts. The average burst height determined using CICS remains extremely constant as the threshold is varied from 20 to 70 counts, increasing only 4% whereas the average burst height determined using traditional SMD increases 100%.

TABLE 1
Thresholding artifacts in traditional SMD versus CICS

| | Traditional SMD | | CICS | |
|---|---|---|---|---|
| Threshold | Burst | Burst Height | Burst | Burst Height |
| (counts) | Rate/100 s | (counts) | Rate/100 s | (counts) |
| 20 | 421 | 149 ± 199 | 958 | 101 ± 24 |
| 30 | 305 | 197 ± 216 | 906 | 105 ± 14 |
| 40 | 257 | 227 ± 223 | 906 | 105 ± 14 |
| 50 | 224 | 254 ± 226 | 906 | 105 ± 14 |
| 60 | 206 | 272 ± 229 | 906 | 105 ± 14 |
| 70 | 183 | 298 ± 229 | 903 | 105 ± 14 |

Analysis of 100 s Monte Carlo simulation data. The digital nature of fluorescence bursts acquired using CICS allows the system to be robust against thresholding artifacts. However, quantitative burst parameters determined using traditional SMD are highly sensitive to the specific threshold applied. The bin time was 0.1 ms.

Matters are further complicated when molecules of varying brightness need to be quantified using the burst rate. Two populations of molecules of equal concentration but different brightness levels can give significantly different burst rates even if the same threshold is applied, necessitating precise calibration for each molecular species. These effects are illustrated in Table 2. The simulated DNA is stoichiometrically stained such that the number of incorporated dye molecules and, hence, brightness increases linearly with DNA length. Although the total quantity of DNA is conserved in all cases, the burst rate of standard SMD can vary by almost 40% when presented with only a 2× increase in DNA length. With standard SMD, it is impossible to determine concentration based on burst rate alone. Prior knowledge of the sample composition is necessary to provide an accurate reference standard. When an unknown mixture of molecules of varying brightness is present, such calibrations are often infeasible as it becomes impossible to independently separate the effects of brightness and concentration. CICS, however, is highly robust even when quantifying mixtures of molecules as shown in Table 2. A constant quantity of DNA is reflected even in the presence of varying mixtures. The burst rates differ by less than 5% in the same situation, implicating that concentration can be blindly determined based on burst rate alone.

TABLE 2
Single molecule burst rates in varying DNA mixtures

| | 1 pM | 1 pM | 0.5 pM 4 kbp + | 0.25 pM 4 kbp + |
|---|---|---|---|---|
| | 4 kbp | 8 kbp | 0.5 pM 8 kbp | 0.75 pM 8 kbp |
| Traditional SMD | 305 | 420 | 381 | 410 |
| CICS | 915 | 928 | 948 | 922 |

Simulated burst rate of DNA mixtures taken using traditional SMD and CICS. The burst rate of traditional SMD varies as relative proportions of the two DNA components are varied although the total concentration is conserved in all cases. The CICS burst rate remains consistent across the mixtures. The applied threshold was 30 counts, and the bin time was 0.1 ms.

These Monte Carlo simulations have theoretically shown that the 1-D expansion of the observation volume and increase in observation volume uniformity provide the basis for CICS to achieve 100% mass detection efficiency within a microchannel and to perform highly accurate and robust burst parameter analysis. CICS rectifies the limitations of traditional SMD while still preserving single molecule sensitivity.

### Experimental Observation Volume Mapping

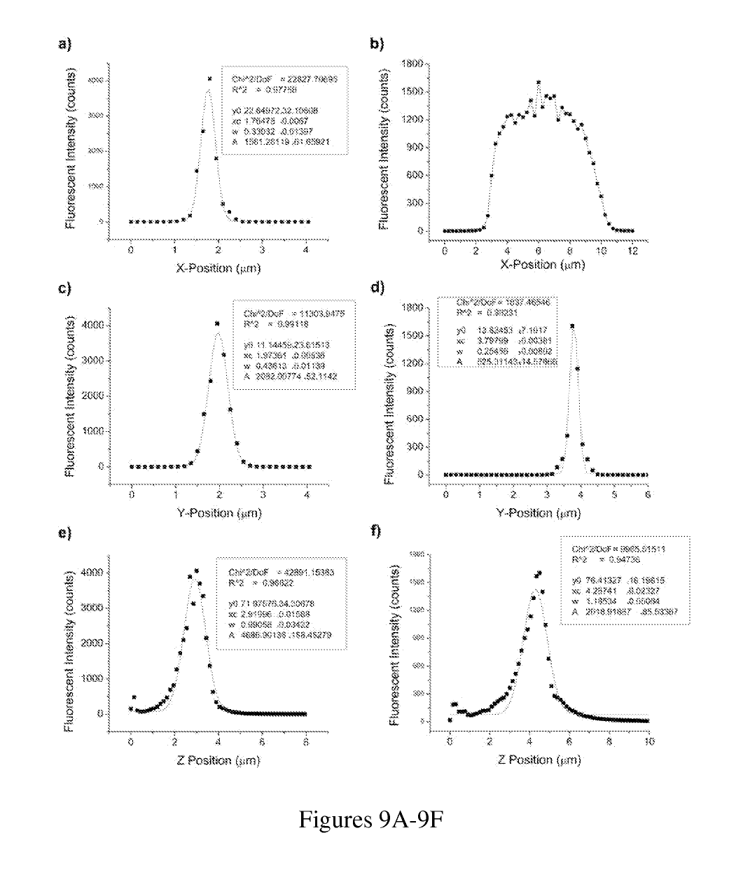

The OV profiles of the 488-SMD and the 488-CICS systems were acquired by rastering a sub-micron fluorescent bead through the observation volume and recording the collected fluorescence intensity as a function of position. FIGS. 8A and 8B, show xz-plots that track the theoretical predictions of FIGS. 6A-6F. Standard SMD has a small, sharply decaying OV profile that can be accurately modeled using a 3-D Gaussian approximation. Excellent fits to Gaussian functions were obtained resulting in measured 1/e² radii of 0.33, 0.44, and 0.99 μm in the x, y, and z directions, respectively; this leads to an observation volume size of 0.6 fL (see FIGS. 9A, 9C and 9E). However, the observation volume is not perfectly symmetrical and contains some aberrations. These are likely due to artifacts caused by optical aberrations, misalignment of optical components, mechanical drift and instability of the scanning stage, and photobleaching of the fluorescent bead.

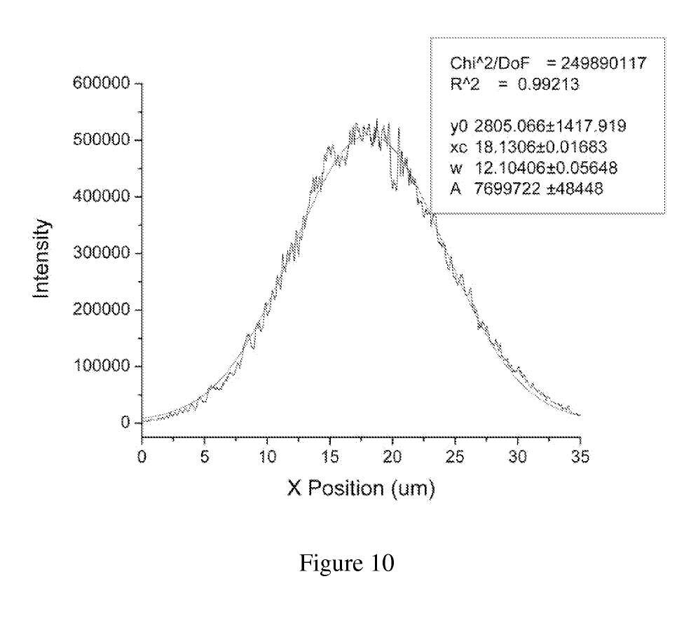

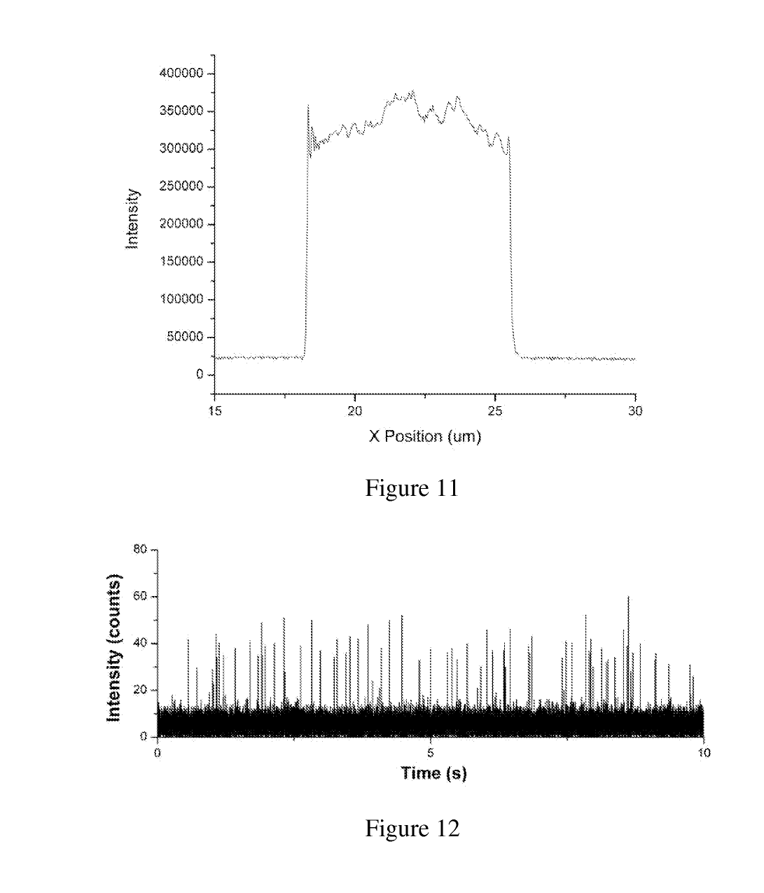

The CICS system, on the other hand, shows a much larger, elongated observation volume that is fairly uniform in the center section. The OV profile of CICS mirrors that of traditional SMD in the y- (y₀=0.25 μm) and z-directions (z₀=1.18 μm) but is elongated in the x direction (x_{uniform}˜7 μm) as designed (see FIG. 9). This is further illustrated in FIGS. 9B-9D where a CCD is used to take images of the standard SMD and CICS illumination volumes using a reflective interface held perpendicular to the optical axis. In FIG. 9B, the 1/e² radius of the illumination volume in the x-direction (width) is stretched to 12.1 μm using an f=300 mm cylindrical lens (see FIG. 10). n FIG. 9C, a 620×115 μm confocal aperture limits light collection to only the center 7 μm where the illumination is most uniform (see FIG. 10). Over this region there is roughly a 6% RSD and 15% maximum variation in illumination intensity. Since the characteristic dimensions of the observation volume are larger than the 5×2 μm (w×h) microchannel used to transport molecules, near 100% mass detection efficiency is expected as theoretically predicted (Stavis, S. M., J. B. Edel, K. T. Samiee, and H. G. Craighead. 2005. Single molecule studies of quantum dot conjugates in a submicrometer fluidic channel. Lab on a chip 5:337-343). For analysis using 633-CICS, the confocal aperture was increased to 630×170 μm (w×h) to increase signal intensity and reduce the axial dependence of collection uniformity.

Despite the general agreement, the experimental CICS OV profile lacks the distinct plateau present in the theoretical simulations. This is expected as the sharp plateau is a limitation of the semi-geometric optics approximation used. In practice, the sharp cutoff in collection efficiency defined by the aperture is replaced by a smooth decay. In addition, the dependence of the OV profile in the z-dimension is much sharper than that predicted by the model. This can possibly be rectified through the use of a lower N.A. microscope objective or larger confocal aperture. Finally, there is additional non-uniformity introduced by diffraction, optical aberrations, mis-alignment, and experimental error that are not accounted for in the theoretical simulations. Similar point spread functions have recently been reported in confocal line scanning applications (Ralf, W., Z. Bernhard, and K. Michael. 2006. High-speed confocal fluorescence imaging with a novel line scanning microscope. J. Biomed. Opt. 11:064011; Dusch, E., T. Dorval, N. Vincent, M. Wachsmuth, and A. Genovesio. 2007. Three-dimensional point spread function model for line-scanning confocal microscope with high-aperture objective. J. Microsc. 228:132-138). Together, these effects increase the non-uniformity over theoretical predictions. Further improvements in uniformity can still be had through the incorporation of an objective with a higher degree of aberration correction, improved optical alignment, increased mechanical stability, and minor refinements in optical design.

### DNA Analysis

For the preliminary demonstration of CICS, analysis was performed on bright, multiply stained pBR322DNA molecules. Initially, a silicon based microfluidic chip containing 5×2 μm microchannels was used to precisely transport molecules through the uniform 7×2 μm CICS observation volume. 488-CICS was first used to analyze PicoGreen stained pBR322DNA. The experimental trace (see FIG. 12) is characterized by a large number of uniform fluorescence bursts and shows strong similarities to the simulated trace of FIG. 7B. It has a high burst rate of 1955 bursts/300 s when a detection threshold of 22 counts is applied and average burst height of 33.0±10.4 counts (RSD=31%). However, accompanying the large increase in burst rate and uniformity is a substantial increase in background. The large increase in background is greater than that expected from the observation volume expansion alone. The close proximity of the glass-water interface at the top of the channel and the opaque silicon at the bottom of the 2 μm high microchannel creates large amounts of scattered light, significantly increasing background levels and leading to a low SBR of 6 (SBR=average burst height/average background). This scatter background is more effectively rejected by the smaller pinhole in standard SMD than the larger, rectangular aperture in CICS. In order to prevent the background from swamping out the fluorescent bursts, the illumination power was limited to only 0.08 mW/cm². Therefore, in the subsequent experiments a transition to a glass-PDMS device was made.

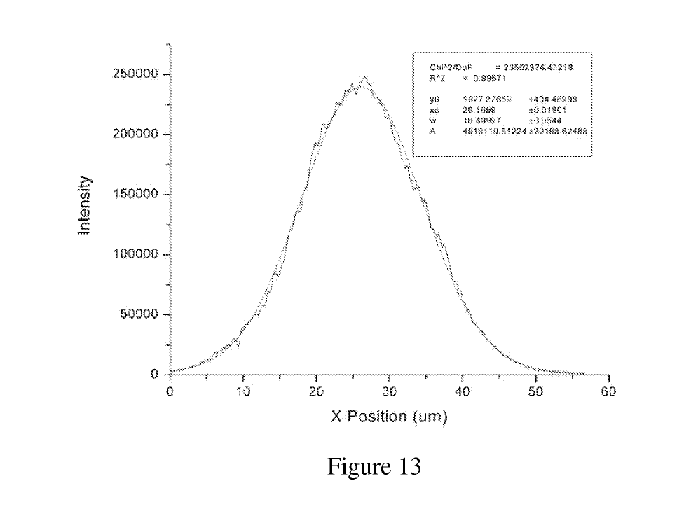

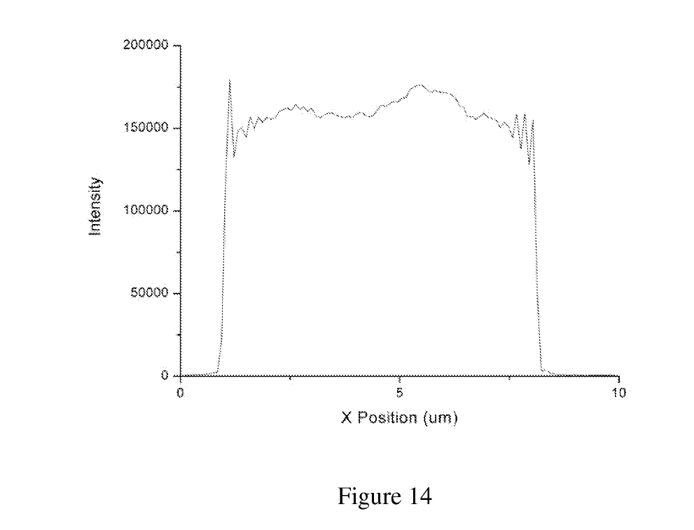

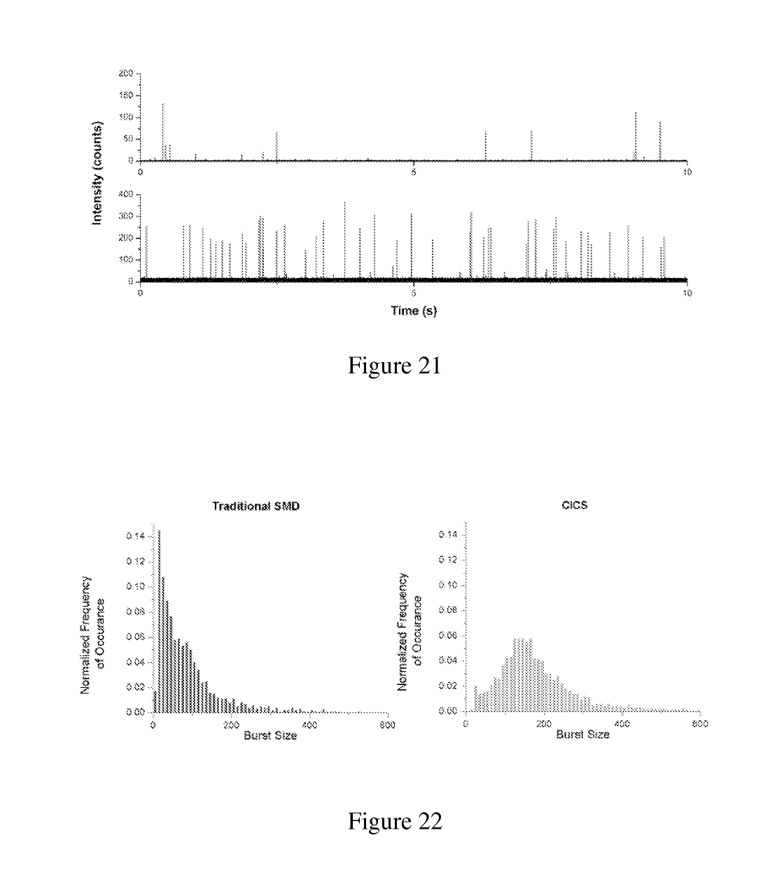

In order to compare CICS with SMD, a second microfluidic device of identical geometry to the first was fabricated out of PDMS and glass using soft-lithography. The transparent PDMS-glass materials have lower scatter background than the opaque silicon previously used. Red excitation (633 nm) with far red detection (670 nm) was found to have a lower average background and fewer spurious fluorescent bursts when used with PDMS devices than blue excitation (488 nm) with green detection (520 nm). It is believed that this can be attributed to the PDMS autofluorescence (Cesaro-Tadic, S., G. Dernick, D. Juncker, G. Buurman, H. Kropshofer, B. Michel, C. Fattinger, and E. Delamarche. 2004. High-sensitivity miniaturized immunoassays for tumor necrosis factor alpha using microfluidic systems. Lab on a chip 4:563-569; Piruska, A., I. Nikcevic, S. H. Lee, C. Ahn, W. R. Heineman, P. A. Limbach, and C. J. Seliskar. 2005. The autofluorescence of plastic materials and chips measured under laser irradiation. Lab on a chip 5:1348-1354; Yokokawa, R., S. Tamaoki, T. Sakamoto, A. Murakami, and S. Sugiyama. 2007. Transcriptome analysis device based on liquid phase detection by fluorescently labeled nucleic acid probes. Biomedical microdevices 9:869-875) as well as the large number of organic contaminants and impurities that fluoresce in green. As a result, TOTO-3 stained pBR322 DNA was analyzed rather than the previous PicoGreen stained DNA. The low scatter background enabled 633-CICS to be run at 1.85 mW/cm² rather than the low 0.08 mW/cm² previously used in 488-CICS. To achieve comparable illumination power densities at the observation region, 633-SMD was operated at 0.059 mW/cm² to account for the greater than 30× decrease in illumination volume size (see FIGS. 13 and 14). FIG. 21 shows two single molecule traces taken using 633-SMD (top) and 633-CICS (bottom). These traces closely resemble the Monte Carlo data in FIG. 7. The CICS traces show a higher burst rate, more uniform fluorescent bursts, and a slightly higher background than the SMD traces. Standard SMD, at a discrimination threshold of 10 counts, shows 336 bursts in a 300 s period with an average burst height of 51.5±44.6 counts (RSD=87%). It is difficult, though, to set a threshold where both false negative and false positive bursts are minimized. Setting the threshold at the standard μ+3σ level, which gives a 99.7% confidence interval, would lead to an average of 9000 false positive peaks when acquiring data over a 300 s period with a 0.1 ms bin time. Thus, it is necessary to use a significantly higher threshold at the cost of an increased number of false negatives. Since there is no optimal threshold setting, it is difficult to determine the accuracy of the absolute burst rate and burst parameters.

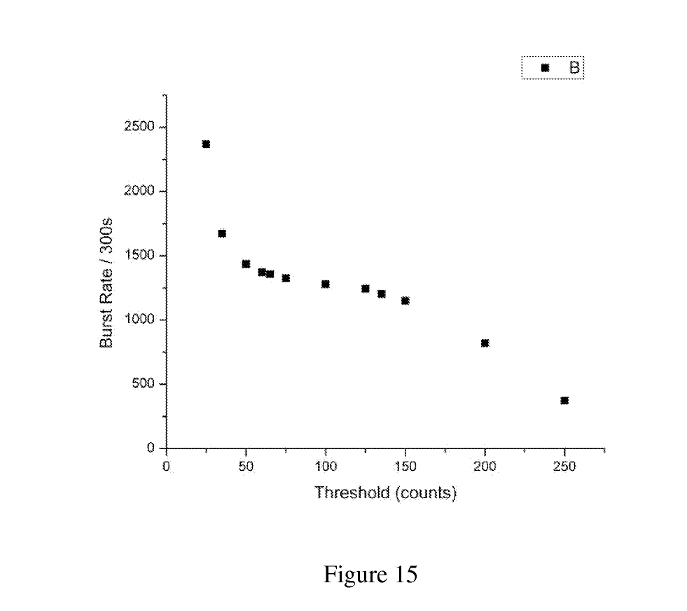

CICS burst data, on the other hand, is much less sensitive to thresholding artifacts as predicted by the model. Using a threshold of 100 counts, 1278 fluorescent bursts were detected over a 300 s period where the average burst height was 211.6±56.6 counts (RSD=27%). When the threshold is varied over a wide range of 65-135 counts, the number of detected bursts decreases only 11% whereas in standard SMD the burst rate decreases by 44% over a much smaller range of 6-14 counts (see FIG. 15). The price to pay for the increased uniformity and burst rate is a correlated reduction in SBR. While the 633-CICS SBR of 22 is much improved over the previous 488-CICS results performed within the silicon devices due to the decreased scattering background in the PDMS devices, it is still less than SBR of 271 obtained using 633-SMD. This reduction in SBR using CICS is fairly consistent but slightly more than that expected from the ˜7× linear expansion in observation volume size.

Since the channel dimensions of the silicon and PDMS devices are identical, the burst height uniformities are expected to be similar as is seen. However, they are approximately 10% greater than that which was theoretically predicted. Further uniformity improvements can be expected if the axial dependence (z-direction) is reduced through lower N.A. collection optics such as a 1.2 N.A. water immersion objective. The remainder of variability can be attributed to factors such as variability staining efficiency, fluctuations in the illumination intensity, instabilities in the flow velocity, and the Poiseuille flow profile.

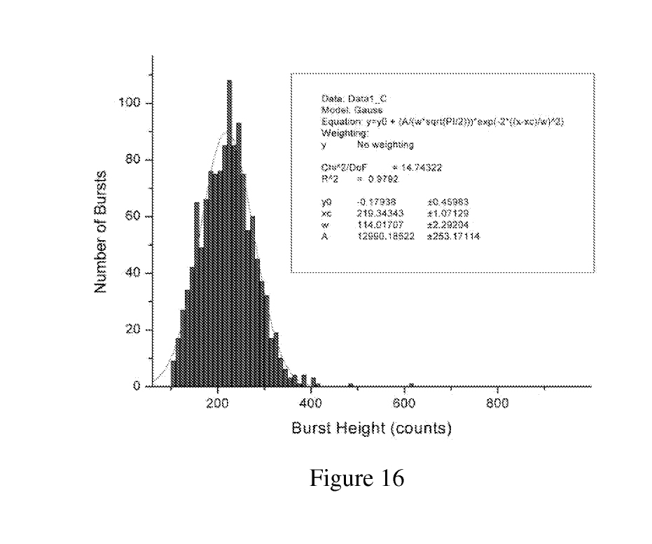

Two significant drawbacks of the PDMS devices that were not encountered using the silicon devices were frequent flow instabilities and long transient times when changing flow velocities. This can likely be attributed to the elastic nature of the PDMS and the less robust nature of the fluidic couplings. These effects become apparent as short time scale fluctuations in the burst rate (˜seconds), longer time scale drift (˜tens of minutes), and sudden spikes in burst rate. They are exacerbated by the intrinsic difficulty in controlling such low flow rates (0.001 μl/min) as well as the high flow resistance of the small microchannels. From the optical characterizations and simulations, it is evident that the 7×2 μm observation volume is sufficient to span the entire 5×2 μm microchannel. While based on the uniformity of the burst height histogram (see FIG. 16), it is evident that nearly all the molecules are flowing through the uniform center section of the observation volume. This implies that the large majority of molecules within the channel are in fact being detected. Thus, we believe the decreased burst rate can be largely attributed to flow variability.

Although the observation volume here was expanded ˜7×, which corresponded to a roughly 10× decrease in SBR from standard SMD, it can be tailored to almost any size using the correct combination of cylindrical lens and aperture. The required signal-to-noise ratio and observation volume uniformity will dictate the maximum focal volume expansion that can be performed while maintaining adequate sensitivity.

### Single Fluorophore Sensitivity

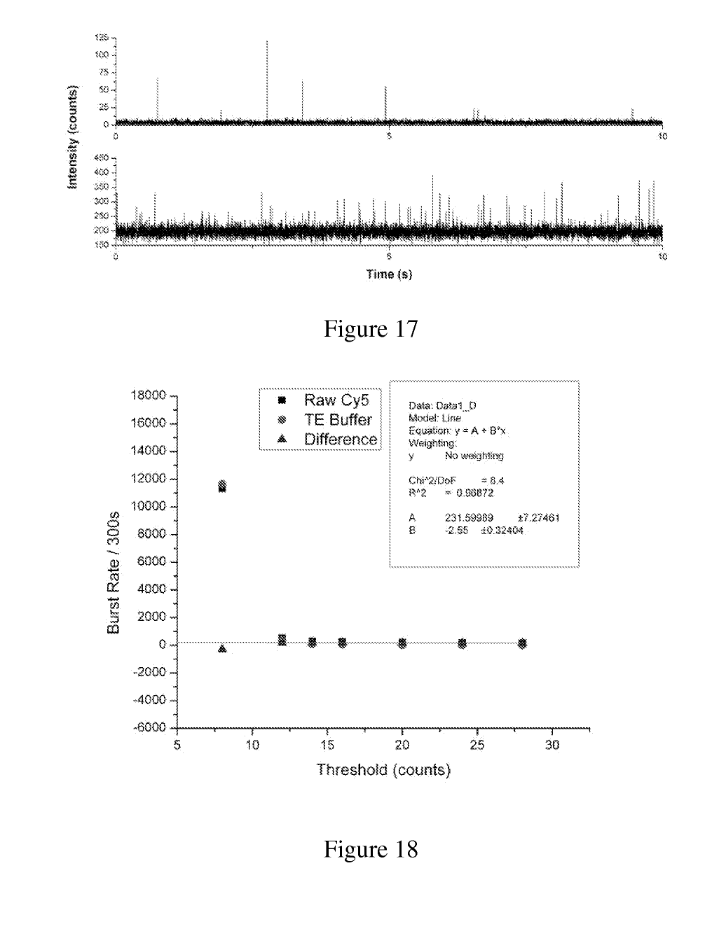

CICS was tested to see if single fluorophore sensitivity was preserved despite the observation volume expansion. Cy5 labeled 24 by ssDNA was diluted to 1 pM, flowed through the PDMS microfluidic device, and analyzed using both traditional SMD and CICS. CICS was run at 3.7 mW/cm² while SMD was performed at 0.185 mW/cm². A longer photon binning time (1 ms vs. 0.1 ms) was used in the single fluorophore Cy5 experiments to increase signal levels. When standard SMD is performed within a large capillary, Cy5 fluorophores can be detected with a SBR of 13 and 89% RSD in burst height (threshold=8 counts, average burst height=18.0±16.1 counts). Whereas when standard SMD is performed within the microchannel, the scatter background is increased due to the close proximity of the glass-water and water-PDMS interfaces resulting in a slightly reduced SBR of 10 (see FIG. 17) while burst height RSD remains at a comparable 90% (average burst height=36.7±32.9 counts) when a threshold of 14 is applied. In comparison, CICS is significantly more uniform (see FIG. 17). The average Cy5 burst height was 120.8±58.9 counts, which corresponds to a RSD of 49% (threshold=254 counts). This burst uniformity is expected to be decreased when compared to the pBR burst uniformity because of the decreased brightness of the single Cy5 fluorophore. CICS showed an SBR of 1.6 which was 6× lower than the standard SMD SBR, consistent with the 7× increase in observation volume size. This illustrates the trade-off in uniformity, burst rate, and SBR that can be easily predicted and engineered using CICS. For single fluorophore analysis, the current 7×2 μm OV/5×2 μm microchannel combination is likely the largest expansion that can be performed while retaining single fluorophore sensitivity. But for brighter molecules such as fluorescent beads, quantum dots, or multiply labeled DNA or proteins, it is expected that even larger microchannels may be used for increased throughput.

### Single Fluorophore Mass Detection Efficiency

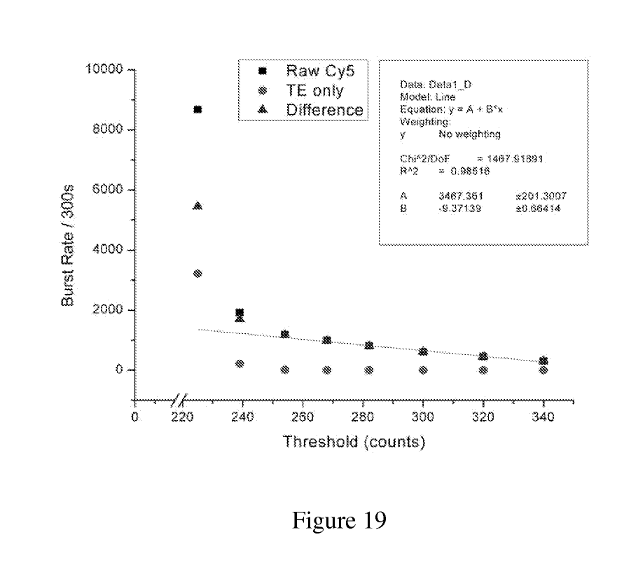

As previously discussed, single Cy5 fluorophores are readily detected by both standard SMD and CICS. The estimation of mass detection efficiency requires an accurate determination of the absolute burst rate, which is in turn highly influenced by the specific threshold applied. The optimal threshold balances the proportion of false positive bursts against the proportion of false negative bursts in the attempt to minimize the influence of both. However, when analyzing dim molecules such as single fluorophores where the fluorescent fluctuations are not fully resolved from the background fluctuations (i.e. the distribution of fluorescent fluctuations overlaps the distribution of background fluctuations), this becomes extremely difficult since every threshold chosen will introduce an inordinate number of either false positives or false negatives. We adapt the method of Huang et al. to extrapolate the true burst rate from that determined after thresholding (Huang, B., H. K. Wu, D. Bhaya, A. Grossman, S. Granier, B. K. Kobilka, and R. N. Zare. 2007. Counting low-copy number proteins in a single cell. Science 315:81-84). Given the applied flow rate (0.001 μl/min) and nominal concentration (1 pM), an average of ˜3011 molecules are expected to flow through the channel during each 300 s period. Using standard SMD, 232 molecules can be detected leading to a mass detection efficiency of 7.5% (see FIG. 18). This burst rate appears somewhat lower than expected. Under CICS analysis, on the other hand, 3467 molecules can be detected (see FIG. 19). Although this number is slightly greater than the expected number of molecules, this difference may be attributed to errors in flow rate due to pump calibration, instabilities in flow as previously discussed, pipetting errors in sample preparation, and inaccuracies in the data analysis method.

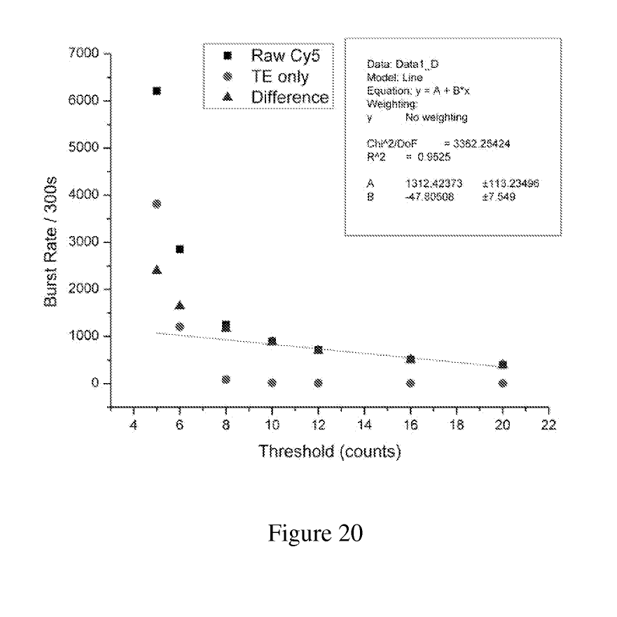

The large mass detection efficiency increase in CICS is achieved through the combination of two effects, a decrease in the size of the transport channel and a matched 1-D increase in observation volume size. Standard SMD mass detection efficiencies (<1%) are low since the transport channel (diameter ˜100 μm) is typically much larger than the SMD observation volume (diameter ˜1 μm). Since the mass detection efficiency describes the relative proportion of detected molecules, a reduction in transport channel size increases mass detection efficiency without a concurrent increase in burst rate while an increase in observation volume size increases both mass detection efficiency and burst rate. As the channel size is reduced to below the observation volume size, the mass detection efficiency is maximized while the absolute burst rate is progressively reduced. Using the previous method, standard SMD performed in a 100 μm diameter capillary achieves a mass detection efficiency of only 0.04% (see FIG. 20). By substituting a 5×2 μm microchannel, the mass detection efficiency is increased to 7.5% while the absolute burst rate is actually reduced by 5× since the low microchannel height limits the effective size of the observation volume. This 7.5% roughly correlates to the overlap in cross-sectional area between the SMD observation volume size and the microchannel, but is slightly lower than the 10-15% expected, likely due to flow instabilities, a slight misalignment of the channel to the observation volume, and inaccuracy in the estimation method. To increase mass detection efficiency to near 100% using standard SMD, a nanochannel must be used (Stavis, S. M., J. B. Edel, K. T. Samiee, and H. G. Craighead. 2005. Single molecule studies of quantum dot conjugates in a submicrometer fluidic channel. Lab on a chip 5:337-343). However, CICS further increases mass detection efficiency by matching the 5×2 μm microchannel with an optimized 1-D observation volume expansion. This leads to a 15× increase in absolute burst rate over standard SMD in a microchannel and near 100% mass detection efficiency. The observation volume in CICS can be easily tailored to span a given channel geometry with the correct choice of optics and aperture using the methods previously described.

### Burst Size Distribution Analysis (BSDA)

Not only is CICS more accurate in quantification and burst parameter determination, the greatly enhanced uniformity enables single molecule assays that cannot be performed using traditional SMD. For example, burst size distribution analysis uses the distribution of individual fluorescence burst intensities to determine the size of a molecule. As shown in FIG. 22, the Gaussian OV profile of standard SMD does not allow a clear distinction of the pBR DNA population from the background fluctuations. However, the same DNA shows a clear population centered around 151 counts when analyzed using CICS. Thus, the average burst size can be more accurately determined without being skewed by background fluctuations. In fact, the digital fluorescence bursts even obviate the need for smoothing algorithms such as Lee filtering when processing such data (Enderlein, J., D. L. Robbins, W. P. Ambrose, P. M. Goodwin, and R. A. Keller. 1997. The statistics of single molecule detection: An overview. Bioimaging 5:88-98). Using CICS, it is possible to perform a burst size distribution assay on a mixture of DNA molecules and individually identify the constituents of that mixture as well as their individual concentrations. Such an assay would be impossible using standard SMD.

Through careful modeling and implementation, CICS has been engineered to alleviate the subtle shortcomings of traditional SMD that make it difficult to apply in a widespread manner. CICS significantly enhances uniformity and mass detection efficiency while still preserving single fluorophore sensitivity, allowing more accurate and precise determination of single molecule parameters than traditional SMD. It can be operated with higher throughput and with less complication than competing technologies using molecular focusing and molecular confinement. In addition, its quantification accuracy is further reinforced by its robustness against thresholding artifacts. Finally, because CICS uses an epi-fluorescent arrangement, it is easily used with essentially all types of microfluidic devices including those with opaque substrates such as silicon. This makes it an ideal detection platform that can be generically combined with all microfluidic systems. Since the mass detection efficiency, detection uniformity, and signal-to-noise ratio can be accurately predicted, it can be easily optimized for any microfluidic channel size and application. CICS has great potential in applications such as clinical diagnostics, biochemical analysis, and biosensing where accurate quantification of the molecular properties of rare biomolecules is necessary.

### Example III

### Microfluidic System for High-throughput, Droplet-Based Single Molecule Analysis with Low Reagent Consumption

### SUMMARY

A microfluidic device for a confocal fluorescence detection system according to an embodiment of the current invention has an input channel defined by a body of the microfluidic device, a sample concentration section defined by the body of the microfluidic device and in fluid connection with the input channel, a mixing section defined by the body of the microfluidic device and in fluid connection with the concentration section, and a detection region that is at least partially transparent to illumination light of the confocal fluorescence detection system and at least partially transparent to fluorescent light when emitted from a sample under observation as the sample flows through the detection region.

A microfluidic detection system according to an embodiment of the current invention has a microfluidic device having a detection region defined by a body of the microfluidic device, an objective lens unit arranged proximate the microfluidic device, an illumination system in optical communication with the objective lens unit to provide light to illuminate a sample through the objective lens unit, and a detection system in optical communication with the objective lens unit to receive at least a portion of light that passes through the objective lens unit from the sample. The microfluidic device has an input channel defined by the body of the microfluidic device, a sample concentration section defined by the body of the microfluidic device and in fluid connection with the input channel, and a mixing section defined by the body of the microfluidic device and in fluid connection with the concentration section. The detection region is at least partially transparent to illumination light from the illumination system and at least partially transparent to fluorescent light when emitted from a sample under observation as the sample flows through the detection region.

A method of detecting particles according to an embodiment of the current invention includes providing a sample comprising particles to be detected and a fluid in which the particles are at least one of suspended or dissolved, concentrating the sample by removing at least a portion of the fluid using a microfluidic device to provide a concentrated sample, mixing the concentrated sample with a reagent to label the particles to be detected using the microfluidic device, and detecting the particles after the mixing based on a response of the labels. The sample is greater than about 1 μl and less than about 1 ml, and the concentrated sample is reduced in volume by a factor of at least 100.

The terms light, optical, optics, etc are not intended to be limited to only visible light in the broader concepts of the current invention. For example, they could include infrared and/or ultraviolet regions of the electromagnetic spectrum according to some embodiments of the current invention.

An embodiment of the current invention is directed to a microfluidic device that includes inline micro-evaporators to concentrate biological target molecules within nano-to-picoliter-sized water-in-oil droplets. These droplets can serve as both low-volume reactors for parallel sample processing of the concentrated samples, and digital compartments that enable ordered transfer for downstream SMD analysis. Utilization of the evaporators as microliter-to-picoliter interconnects between the macroscopic world and single molecule microanalytical systems can solve problems of conventional devices such as those discussed above that hinder the widespread acceptance and utilization of SMD. First, solvent removal within the evaporators transports and confines the molecular contents of large sample volumes to the downstream droplets, which can be swept through laser-illuminated, confocal fluorescence detection volumes. The intradroplet, molecular detection efficiency at this point can be as high as about 100% using cylindrical illumination confocal spectroscopy (CICS) (K. H. Liu and T. H. Wang. Biophys. Journal, 95(6), 2964-2975, 2008) and pushing the entire droplet through a laser-illuminated sheet; however, the optical probe can be made to match a variety of operational parameters and the platform is not limited to only CICS detection. Unlike traditional continuous flow SMD platforms, sample throughput and the kinetics of probe-target interactions of single molecule assays conducted in accordance with some embodiments of the current invention are limited by the speed of solvent removal, which is a controllable device parameter. Therefore, run times for single molecule assays can be greatly reduced due to target enrichment within the droplets, which facilitates probe-target interactions at relatively high concentrations. At these concentrations, droplet-based microfluidics becomes an advantageous complementary technology to single molecule optical platforms, allowing rapid analysis of molecules trapped within parallel reaction compartments in an automated and controllable fashion. And, in addition to simply making SMD amenable to high-throughput studies of genetic alterations, microfluidic systems and methods according to some embodiments of the current invention can open new biological applications that were previously unachievable. For instance, microfluidic loading and quick analytical schemes according to some aspects of the current invention can make high-speed, fluorescence-activated molecular sorting (“FACS for molecules”) a possibility, within controllable reaction compartments that can be manipulated and observed nearly at the will of the genomic researcher.

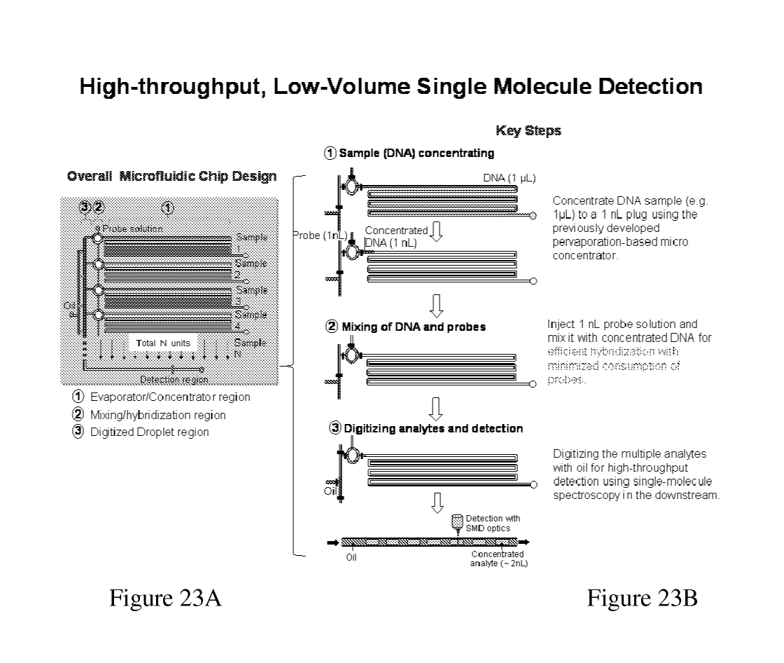

FIG. 23A is a schematic illustration of a microfluidic device 100 for a confocal fluorescence detection system according to an embodiment of the current invention. The microfluidic device 100 comprises a body 102 that defines an input section 104, a sample concentration section 106 in fluid connection with the input section 104, a mixing section 108 in fluid connection with the concentration section 106, and an output channel 110 in fluid connection with the mixing section 108. The output channel 110 has a detection region 112 that is at least partially transparent to illumination light of the confocal fluorescence detection system and at least partially transparent to fluorescent light when emitted from a sample under observation as the sample flows through the detection region 112.

The body 102 of the microfluidic device 100 can be a composite structure having a plurality of layers and/or components combined according to the particular application. For example, the body 102 defines a fluid channel layer therein which can include a patterned layer attached to a substrate. The body 102 can further include an actuation layer in some embodiments of the current invention. The actuation layer can include structures to provide valves at selected regions of the microfluidic device 100.

The concentration section 106 has a total of N concentration components in parallel in this example. The invention is not limited to a particular number N of concentration components and also includes the case in which N=1 such that there is no parallelism in that particular example. However, parallel structures in which N=2, 3, 4 or a much larger number may be useful for many applications. Each concentration component of the concentration section 106 is in fluid connection with an input channel of the input section 104. This allows selected fluids to be directed into each concentration component of the concentration section 106.

The microfluidic device 100 further comprises a droplet generator 114 defined by the body 102 of the microfluidic device 100. The droplet generator 114 is arranged in fluid connection between the mixing section 108 and the output channel 110. Although not shown in detail in FIG. 23A, the droplet generator 114 can be a hydrodynamic-focusing droplet generator or a pneumatic valve actuator-based droplet generator, for example.

FIG. 23B is a schematic illustration to facilitate the explanation of the operation of the microfluidic device 100. Fluid containing molecules and/or particles of interest is introduced into at least one concentration component 115 of the concentration section 106 through the input section 104. A portion of the solvent and/or other fluid in which the molecules and/or particles of interest are suspended is removed in the concentration component 115 while valve 116 is closed. For example, the fluid may contain DNA and/or other molecules of interest. The concentration component 115 can include a semi-permeable membrane in some embodiments of the current invention, which will be described in more detail below. In some embodiments of the current invention, input volumes of the order of micro liters can be reduced to volumes on the order of nano liters, thus resulting in a concentration of molecules and/or particles of interest by about three order of magnitude (about a factor of 1,000). However, the broad concepts of the current invention are not limited to specific levels of concentration.

Once the sample has been concentrated to provide plug 118, valve 116 is opened to allow the plug 118 to be forced into the mixing component 120 of mixing section 108. In this example, the mixing component 120 comprises a rotary chamber operable through peristaltic pumping by means of a plurality of valves around the rotary chamber. However, the mixing component is not limited to only rotary mixers. In other embodiments, serpentine mixers or other types of mixers could be used instead of or in addition to rotary mixers. Also, chaotic mixing structures within the channels could be included in some embodiments, such as structure to disrupt laminar flow to cause chaotic flow. The mixing component 120 can include one or more additional ports such that reagents and or other fluids can be directed into the rotary chamber to mix and/or react with molecules of interest in the plug 118. For example, fluorophores can be attached to molecules of interest, such as DNA molecules, at this stage. However, the broad concepts of the invention are not limited to this particular example. Other examples could include introducing various nanoparticles, quantum dots, etc. into the mixing component 120 according to the particular application.

After the mixing is complete, valve 122 is opened to direct plug 118 after mixing into the section 124 of the droplet generator 114. The droplet generator provides a fluid that is immiscible with the plug 118 in order to isolate the plug 118 from subsequent and/or preceding mixed plugs. For example, the molecules and/or particles of interest may be mixed and/or suspended in an aqueous solution to form a droplet in oil provided in the droplet generator. Alternatively, oil in water type droplets could be formed in some applications. A sequence of droplets are formed by sequential and/or parallel operation to the output channel 110 such that they pass through the detection region 112 of the output channel 110. The microfluidic device 100 can be used in conjunction with a detection system 126 to detect the molecules and/or particles of interest as they pass through the detection region 112. The detection system 112 can be an optical detection system in some embodiments of the current invention. In some embodiments, the detection system 126 can be a confocal spectroscopic system. In some embodiments, the detection system 126 can be a cylindrical illumination confocal spectroscopic system.

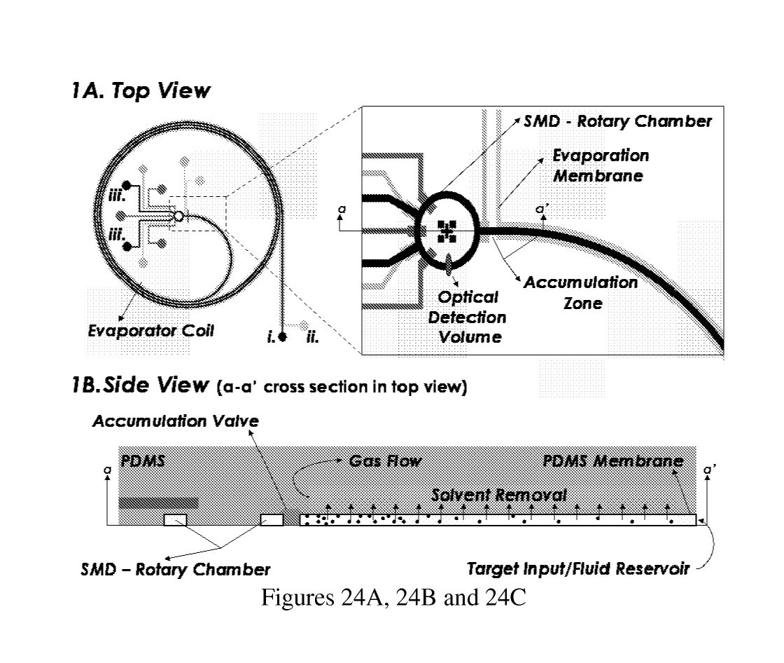

FIG. 24A is a schematic illustration of a microfluidic device according to another embodiment of the current invention. FIG. 24B shows an enlarged view of a section of FIG. 24A and FIG. 24C is a section taken as indicated in the section line of FIG. 24B. In this example, the concentration component of the concentration section is an evaporator coil. The section of FIG. 24C illustrates in more detail an embodiment of the concentration component. In this example, there is a semi-permeable membrane between the fluid channel and a gas flow channel that carries away solvent that passes through the semi-permeable membrane to the gas flow channel.

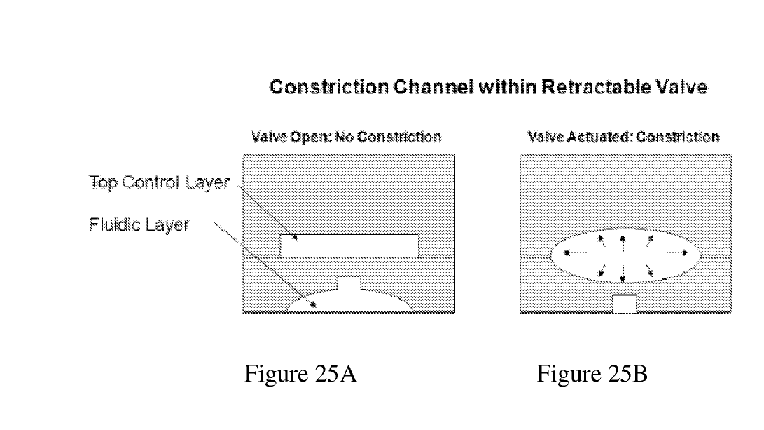

In some embodiments of the current invention, the detection region 112 has channel cross sectional area that can be changed from an initial area to a smaller area such that it acts to stretch out the droplet that is passing through it. FIGS. 25A and 25B provide an example of one embodiment of a detection channel that has a selectable, or changeable, cross sectional area. FIG. 25A is a cross section view of the detection region 112 in an open configuration. The open configuration can be substantially equal in cross sectional area as that of the output channel 110 immediately prior and subsequent to the detection region 112, for example. FIG. 25B shows a constricted configuration of the detection region 112. In this example, the detection region includes a detection channel and a deformable membrane such that the deformable membrane is operable to change the cross-sectional area of said detection channel.

An embodiment of the current invention provides a confocal spectroscopy system that can enable highly quantitative, continuous flow, single molecule analysis with high uniformity and high mass detection efficiency with a microfluidic device according to the current invention (See also U.S. application Ser. No. 12/612,300 assigned to the same assignee as the current application, the entire contents of which is hereby incorporated herein by reference in its entirety). Such a system will be referred to as a Cylindrical Illumination Confocal Spectroscopy (CICS) system. CICS is designed to be a highly sensitive and high throughput detection method that can be generically integrated into microfluidic systems without additional microfluidic components.

Rather than use a minute, diffraction limited point, CICS uses a sheet-like observation volume that can substantially entirely span the cross-section of a microchannel. It is created through the 1-D expansion of a standard diffraction-limited detection volume from approximately 0.5 fL to 3.5 fL using a cylindrical lens. Large observation volume expansions in 3-D (>100× increase in volume) have been previously performed to directly increase mass detection efficiency and to decrease detection variability by reducing the effects of molecular trajectory (Wabuyele, M. B., H. Farquar, W. Stryjewski, R. P. Hammer, S. A. Soper, Y. W. Cheng, and F. Barany. 2003. Approaching real-time molecular diagnostics: single-pair fluorescence resonance energy transfer (spFRET) detection for the analysis of low abundant point mutations in K-ras oncogenes. J. Am. Chem. Soc. 125:6937-6945; Habbersett, R. C., and J. H. Jett. 2004. An analytical system based on a compact flow cytometer for DNA fragment sizing and single-molecule detection. Cytometry A 60:125-134; Filippova, E. M., D. C. Monteleone, J. G. Trunk, B. M. Sutherland, S. R. Quake, and J. C. Sutherland. 2003. Quantifying double-strand breaks and clustered damages in DNA by single-molecule laser fluorescence sizing. Biophys. J. 84:1281-1290; Chou, H.-P., C. Spence, A. Scherer, and S. Quake. 1999. A microfabricated device for sizing and sorting DNA molecules. Proceedings of the National Academy of Sciences 96:11-13; Goodwin, P. M., M. E. Johnson, J. C. Martin, W. P. Ambrose, B. L. Marrone, J. H. Jett, and R. A. Keller. 1993. Rapid sizing of individual fluorescently stained DNA fragments by flow cytometry. Nucl. Acids Res. 21:803-806). However, these approaches often still require molecular focusing and/or unnecessarily compromise sensitivity since observation volume expansion in the direction of molecular travel is superfluous. For example, much pioneering work has been performed by Goodwin et al. in reducing detection variability through a combination of 3-D observation volume expansion (1 pL) and hydrodynamic focusing. While highly sensitive and uniform, these flow cytometry based methods use an orthogonal excitation scheme that is ill suited to incorporation with microfluidic systems. Chou et al., on the other hand, have performed a 3-D observation volume expansion to increase uniformity in an epi-fluorescent format for DNA sizing in a PDMS microfluidic device. The large size of the observation volume (375 fL) reduces signal-to-noise ratio and limits sensitivity to the detection of large DNA fragments (>1 kbp). Rather than a large 3-D expansion, a smaller 1-D expansion can be used to increase mass detection efficiency and increase detection uniformity while having a reduced effect on signal-to-noise ratio and detection sensitivity. 1-D beam shaping using cylindrical lenses has been recently applied in selective plane illumination microscopy (Huisken, J., J. Swoger, F. Del Bene, J. Wittbrodt, and E. H. K. Stelzer. 2004. Optical Sectioning Deep Inside Live Embryos by Selective Plane Illumination Microscopy. Science 305:1007-1009), confocal line scan imaging (Ralf, W., Z. Bernhard, and K. Michael. 2006. High-speed confocal fluorescence imaging with a novel line scanning microscope. J. Biomed. Opt. 11:064011), imaging-based detection of DNA (Van Orden, A., R. A. Keller, and W. P. Ambrose. 2000. High-throughput flow cytometric DNA fragment sizing. Anal. Chem. 72:37-41), and fluorescence detection of electrophoretically separated proteins (Huang, B., H. K. Wu, D. Bhaya, A. Grossman, S. Granier, B. K. Kobilka, and R. N. Zare. 2007. Counting low-copy number proteins in a single cell. Science 315:81-84) but have not been thoroughly explored in SMD. We present CICS as a confocal SMD system and method in which the trade-off between observation volume size, signal-to-noise ratio, detection uniformity, and mass detection efficiency can be easily modeled and optimized through 1-D beam shaping.

FIG. 5A is a schematic illustration of a cylindrical illumination confocal spectroscopy system 400 according to an embodiment of the current invention. The cylindrical illumination confocal spectroscopy system 400 includes a fluidic device 402 having a fluid channel 404 defined therein, an objective lens unit 406 arranged proximate the fluidic device 402, an illumination system 408 in optical communication with the objective lens unit 406 to provide light to illuminate a sample through the objective lens unit 406, and a detection system 410 in optical communication with the objective lens unit 406 to receive at least a portion of light that passes through the objective lens unit 406 from the sample. The fluidic device 402 can be a microfluidic device such as described above with respect to FIGS. 23A-25B, for example. The illumination system 408 includes a beam-shaping lens unit 412 constructed and arranged to provide a substantially planar illumination beam 414 that subtends across, and is wider than, a lateral dimension of the fluid channel 404. The substantially planar illumination beam has an intensity profile that is wide in one direction orthogonal to the direction of travel of the beam (the width) while being narrow, relative to the wide direction, in another direction substantially orthogonal to both the direction of travel of the beam and the wide direction (the thickness). This substantially planar illumination beam is therefore a sheet-like illumination beam. The beam-shaping lens unit 412 can include, but is not limited to, a cylindrical lens. The detection system 410 includes an aperture stop 416 that defines a substantially rectangular aperture having a longitudinal dimension and a transverse dimension. The aperture stop 416 is arranged so that the rectangular aperture is confocal with an illuminated portion of the fluid channel such that the longitudinal dimension of the rectangular aperture substantially subtends the lateral dimension of the fluid channel without extending substantially beyond the fluid channel. In other words, the longitudinal, or long dimension, of the rectangular aperture is matched to, and aligned with, the illuminated width of the fluid channel 404. The transverse, or narrow dimension, of the rectangular aperture remains size matched to the narrow dimension, or thickness, of the illuminated sheet. Although the aperture is referred to as being substantially rectangular, it can be shapes other than precisely rectangular, such as an oval shape. In other words, the “substantially rectangular aperture” is longer in one dimension than in an orthogonal dimension. FIG. 5B shows the illumination light spread out to provide a substantially planar illumination beam 414. By arranging the substantially planar illumination beam 414 so that it extends sufficiently beyond the edges of the fluid channel 404 the bright central portion can be centered on the fluid channel. The aperture stop 416 can then be used to block light coming from regions outside of the desired illuminated slice of the fluid channel 404. The dimension of the beam expansion, the aperture size, and fluid channel size can be selected to achieve uniform detection across the channel according to an embodiment of the current invention. The beam is expanded such that the uniform center section of the Gaussian intensity profile covers the fluid channel. The remaining, non-uniform section is filtered out by the substantially rectangular aperture. For example, the substantially planar illumination beam incident upon said fluidic device is uniform in intensity across said fluid channel to within ±10% according to an embodiment of the current invention. To ensure that molecules within the microchannels are uniformly excited irrespective of position, the 1D beam expansion can be performed such that the max-min deviation across the microchannel is <20% according to some embodiments of the current invention. This leads to an optical measurement CV of ±6.5% due to illumination non-uniformity alone. For higher precision measurements, greater beam expansion can be performed at the cost of additional wasted illumination power. For example, given the same microchannel, a larger beam expansion can be performed such that the max-min variation is <5%, an optical measurement CV of <2% can be obtained.

In an embodiment of the current invention, we can use a 5 μm wide microchannel, for example. The aperture can be 600×50 μm (width×height). Given an 83-fold magnification, when the aperture is projected into sample space it ends up being about 7 μm wide, 2 μm wider than the channel. The laser beam is expanded to a 1/e² diameter of about 35 μm, 7-fold wider than the channel width, where the excitation is most uniform. Thus, we only collect from the center 7 μm of the total 35 μm. Then, molecules flow through 5 μm of the available 7 μm (i.e., the microchannel). The narrow dimension of the aperture is size matched to the narrow, diffraction limited width the illumination line in the longitudinal direction to maximize signal to noise ratio. This provides approximately 100% mass detection efficiency with highly uniform beam intensity across the microchannel. However, the broad concepts of the current invention are not limited to this particular example.

The fluidic device 402 can be, but is not limited to, a microfluidic device in some embodiments. For example, the fluid channel 404 can have a width and/or depth than is less than a millimeter in some embodiments. The fluidic device can be, but is not limited to, a microfluidic chip in some embodiments. This can be useful for SMD using very small volumes of sample material, for example. However, other devices and structures that have a fluid channel that can be arranged proximate to the objective lens unit 106 are intended to be included within the definition of the fluidic device 402. For single fluorophore analysis, a fluid channel that has a width less than about 10 μm and a depth less than about 3 μm has been found to be suitable. For brighter molecule analysis, a fluid channel that has a width less than about 25 μm and a depth less than about 5 μm has been found to be suitable. For high uniformity analysis, a fluid channel has a width less than about 5 μm and a depth less than about 1 μm has been found to be suitable.

The objective lens unit 406 can be a single lens or a compound lens unit, for example. It can include refractive, diffractive and/or graded index lenses in some embodiments, for example.

The illumination system 408 can include a source of substantially monochromatic light 418 of a wavelength selected to interact in a detectable way with a sample when it flows through said substantially planar illumination beam in the fluid channel 404. For example, the source of substantially monochromatic light 418 can be a laser of a type selected according to the particular application. The wavelength of the laser may be selected to excite particular atoms and/or molecules to cause them to fluoresce. However, the invention is not limited to this particular example. The illumination system 408 is not limited to the single source of substantially monochromatic light 418. It can include two or more sources of light. For example, the illumination system 408 of the embodiment illustrated in FIG. 5A has a second source of substantially monochromatic light 420. This can be a second laser, for example. The second source of substantially monochromatic light 420 can provide illumination light at a second wavelength that is different from the wavelength from the first laser in some embodiments. Additional beam shaping, conditioning, redirecting and/or combining optical components can be included in the illumination system 408 in some embodiments of the current invention. FIG. 5A shows, schematically, an example of some additional optical components that can be included as part of the illumination system 408. However, the general concepts of the current invention are not limited to this example. For example, rather than free space combination of the illumination beam, the two or more beams of illumination light can be coupled into an optical fiber, such as a multimode optical fiber, according to an embodiment of the current invention.

The detection system 410 has a detector 422 adapted to detect light from said sample responsive to the substantially monochromatic light from the illumination system. For example, the detector 422 can include, but is not limited to, an avalanche photodiode. The detection system can also include optical filters, such as a band pass filter 424 that allows a selected band of light to pass through to the detector 422. The pass band of the band pass filter 424 can be centered on a wavelength corresponding to a fluorescent wavelength, for example, for the sample under observation. The detection system 410 is not limited to only one detector. It can include two or more detectors to simultaneously detect two or more different fluorescent wavelengths, for example. For example, detection system 410 has a second detector 426 with a corresponding second band pass filter 428. A dichroic mirror 430 splits off a portion of the light that includes the wavelength range to be detected by detector 426 while allowing light in the wavelength range to be detected by detector 422 to pass through. The detection system 410 can include various optical components to shape, condition and/or otherwise modify the light returned from the sample. FIG. 5A schematically illustrates some examples. However, the general concepts of the current invention are not limited to the particular example illustrated.

The cylindrical illumination confocal spectroscopy system 400 also has a dichroic mirror 432 that allows at least a portion of illumination light to pass through it while reflecting at least a portion of light to be detected.

The cylindrical illumination confocal spectroscopy system 400 can also include a monitoring system 434 according to some embodiments of the current invention. However, the monitoring system 434 is optional.

In addition, the detection system can also include a signal processing system 436 in communication with the detectors 422 and/or 426 or integrated as part of the detectors.

Some aspects of the current invention can include some or all of the following:

1) Microevaporators as Analytical Inputs from Large and Dilute Sample Volumes
a. Solvent removal can be used to transport and confine low-abundant, target DNA molecules from large microliter volumes to nano-to-picoliter samples plugs. Microfluidic control of these low volume plugs can then used for highly efficient, post-evaporation, single molecule analysis.
b. A range of solvents can be used in the pervaporator (i.e. ethanol or water), each can be chosen to match specific evaporation speeds or buffering capacity.

2) Inline, evaporators as inputs to Water-in-Oil Droplets
a. Post-evaporation microfluidic control of the concentrated nano-to-picoliter sample plugs allows both introduction of fluorescent probes to the enriched target molecules and packaging of aqueous plugs into addressable water-in-oil droplets.

3) Tunable Molecular Detection Efficiencies from within Microfluidic Droplets using Fluorescence Confocal Spectroscopy
a. Stretching the droplet reaction volumes through microfluidic confinements enables tunable molecular detection efficiencies, as each droplet passes through a laser illuminated optical probe volume with adjustable coverage of the droplet cross-sections. Traditional SMD or smaller detection volumes can be used for applications with less stringent requirements, while CICS can be used for 100% detection efficiencies.

4) Low Reagent Genomic Analysis
a. The single molecule detection platform according to some embodiments of the current invention can provide parallel processing of nanoliter volumes containing picomolar concentrations of precious fluorescent probes, without the need for expensive amplification enzymes or molecule-surface conjugations. This is in contrast to conventional molecular amplification-based or microarray schemes for genomic analysis that require micromolar concentrations of probes for adequate reaction kinetics, or conventional single molecule detection platforms that must scan large sample volumes for individual molecules. Thus, use of this platform in a commercial setting for high-throughput genomic analysis can have a large potential for cost-savings through order-of-magnitude reagent reduction.

5) Low Run Time Single Molecule Assays
a. The embodiments described herein can be designed according to the solvent removal capabilities of the microevaporators, as analysis of the contents of nano-to-picoliter droplets requires relatively little time. This efficiency does not exist in current single molecule detection platforms that require large preparation and run times to both bind specific biomolecules to molecular probe and scan those molecules from large sample volumes. Thus, use of this platform in a commercial setting can offer order-of-magnitude increases in throughput compared to conventional SMD schemes.

6) High-throughput, yet Low Volume Single Molecule Detection Assays

The combination of the above features can offer the first platform for single molecule analysis that:
a) directly interfaces a SMD platform with “macro-world” or pipette-able sample volumes,
b) increases the number of these samples that can be analyzed within a given time without compromising single molecule sensitivity,
c) takes advantage of amplification-free detection to truly decrease reagent consumption and assay times,
d) and packages SMD into an automated, microfluidic platform, amenable to genomic applications.

7) Alternative Applications based on Traditional Amplification-based Detection

The evaporator input to microfluidic droplets is not limited to SMD applications, but can also be used to augment technologies that it is otherwise meant to replace, such as, amplification-based detection schemes. For example, using the evaporator in PCR-based assays can result in:
a) reduced number of amplification cycles or reduced assay times,
b) decreased consumption of probe reagents, and
c) increased throughput via sample enrichment.

### EXAMPLES

In this example, we used inline, micro-evaporators according to an embodiment of the current invention to concentrate and transport DNA targets to a nanoliter single molecule fluorescence detection chamber for subsequent molecular beacon probe hybridization and analysis. This use of solvent removal as a unique means of target transport in a microanalytical platform led to a greater than 5,000-fold concentration enhancement and detection limits that pushed below the femtomolar barrier commonly reported using confocal fluorescence detection. This simple microliter-to-nanoliter interconnect for single molecule counting analysis resolved several common limitations, including the need for excessive fluorescent probe concentrations at low target levels and inefficiencies in direct handling of highly dilute biological samples. In this example, the hundreds of bacteria-specific DNA molecules contained in ˜25 microliters of a 50 aM sample were shuttled to a four nanoliter detection chamber through micro-evaporation. Here, the previously undetectable targets were enhanced to the pM regime and underwent probe hybridization and highly-efficient fluorescent event analysis via microfluidic recirculation through the confocal detection volume. This use of microfluidics in a single molecule detection (SMD) platform delivered unmatched sensitivity and introduced complemental technologies that may serve to bring SMD to more widespread use in replacing conventional methodologies for detecting rare target biomolecules in both research and clinical labs.

### Introduction

The development of microanalytical systems for biosensing is driven by advances in microfluidic control technologies for handling nano- to picoliter sample volumes (J. Melin and S. R. Quake, Annu. Rev. Biophys. Biomol. Struct., 2007, 36, 213-231 (DOI:10.1146/annurev.biophys.36.040306.132646); S. Y. Teh, R. Lin, L. H. Hung and A. P. Lee, Lab. Chip, 2008, 8, 198-220 (DOI:10.1039/b715524g); S. Haeberle and R. Zengerle, Lab. Chip, 2007, 7, 1094-1110 (DOI:10.1039/b706364b)). However, the use of small sample volumes in these platforms also requires highly sensitive analyte detection schemes and it is the development and integration of these detection approaches, which remains one of the main challenges for the practical application of microfluidic devices (H. Craighead, Nature, 2006, 442, 387-393 (DOI:10.1038/nature05061); A. J. de Mello, Lab. Chip, 2003, 3, 29N-34N (DOI:10.1039/b304585b [doi])). Traditionally, laser-induced fluorescence (LIE) and methods for electrochemical detection provide the workhorse detection schemes for microanalysis, although recently there has been considerable progress in alternative detection techniques, such as, surface plasmon resonance (SPR), chemiluminescence, Raman, infrared, and absorbance-based detectors (A. J. de Mello, Lab. Chip, 2003, 3, 29N-34N (DOI:10.1039/b304585b [doi]); A. G. Crevillen, M. Hervas, M. A. Lopez, M. C. Gonzalez and A. Escarpa, Talanta, 2007, 74, 342-357 (DOI:10.1016/j.talanta.2007.10.019)). As the original detection technique LIF is most often used in conjunction with micro-capillary electrophoresis (CE) platforms, and this combination of separation and sensitive fluorescence detection remains one of the most represented classes of analytical Microsystems (A. G. Crevillen, M. Hervas, M. A. Lopez, M. C. Gonzalez and A. Escarpa, Talanta, 2007, 74, 342-357 (DOI:10.1016/j.talanta.2007.10.019)).

In parallel with these micro-CE platforms several researchers concentrate on the development of target-specific, amplification- and separation-free fluorescent biomolecular detection methods (A. Castro and J. G. Williams, Anal. Chem., 1997, 69, 3915-3920; J. P. Knemeyer, N. Marme and M. Sauer, Anal. Chem., 2000, 72, 3717-3724; H. Li, L. Ying, J. J. Green, S. Balasubramanian and D. Klenerman, Anal. Chem., 2003, 75, 1664-1670; H. Li, D. Zhou, H. Browne, S. Balasubramanian and D. Klenerman, Anal. Chem., 2004, 76, 4446-4451 (DOI:10.1021/ac049512c); C. Y. Zhang, H. C. Yeh, M. T. Kuroki and T. H. Wang, Nat. Mater., 2005, 4, 826-831; C. Y. Zhang, S. Y. Chao and T. H. Wang, Analyst, 2005, 130, 483-488 (DOI:10.1039/b415758c); L. A. Neely, S. Patel, J. Garver, M. Gallo, M. Hackett, S. McLaughlin, M. Nadel, J. Harris, S. Gullans and J. Rooke, Nat. Methods, 2006, 3, 41-46 (DOI:10.1038/nmeth825); H. C. Yeh, Y. P. Ho, I. Shih and T. H. Wang, Nucleic Acids Res., 2006, 34, e35 (DOI:34/5/e35 [pii]; 10.1093/nar/gkl021 [doi]); C. M. D'Antoni, M. Fuchs, J. L. Harris, H. P. Ko, R. E. Meyer, M. E. Nadel, J. D. Randall, J. E. Rooke and E. A. Nalefski, Anal. Biochem., 2006, 352, 97-109 (DOI:10.1016/j.ab.2006.01.031); N. Marme and J. P. Knemeyer, Anal. Bioanal Chem., 2007, 388, 1075-1085 (DOI:10.1007/s00216-007-1365-1); H. C. Yeh, C. M. Puleo, Y. P. Ho, V. J. Bailey, T. C. Lim, K. Liu and T. H. Wang, Biophys. J., 2008, 95, 729-737 (DOI:10.1529/biophysj.107.127530)). In these methods, the confocal detection design of LIF enables ultrasensitive, single-molecule detection (SMD), while several unique probe strategies, such as molecular beacons (T. H. Wang, Y. Peng, C. Zhang, P. K. Wong and C. M. Ho, J. Am. Chem. Soc., 2005, 127, 5354-5359 (DOI:10.1021/ja042642i [doi]); H. C. Yeh, S. Y. Chao, Y. P. Ho and T. H. Wang, Curr. Pharm. Biotechnol., 2005, 6, 453-461), two-color coincidence detection (H. C. Yeh, Y. P. Ho and T. H. Wang, Nanomedicine, 2005, 1, 115-121 (DOI:10.1016/j.nano.2005.03.004)), or additional FRET or PET-based probes facilitate specific molecular detection in a homogenous format. Although the sensitivity of LIF in detecting single fluorescent molecules yields infinitely low theoretical detection limits for biomolecular targets, the practical limitations of LIF-based SMD platforms are reported in the pM to fM range.

These common detection limits stem from two main challenges. The first is that analysis of probe-target interactions is complicated by free probe molecules. Although it is desirable to use high concentrations of probe molecules in order to increase probe-target interaction rates and ensure target saturation in a reasonable time, high excess probe causes increased background that prevents enumeration of single molecule fluorescence. For instance, although self-quenching probes, such as molecular beacons or smart probes, exhibit low background signals, the concentration of such probes still has to be restricted to the sub-nanomolar level in order to facilitate detection of single molecules. Previous attempts to deal with these complications include the use of fluorescent quenchers to suppress signal from unbound probe (R. L. Nolan, H. Cai, J. P. Nolan and P. M. Goodwin, Anal. Chem., 2003, 75, 6236-6243) or the use of nanocrystals in unique FRET pairings, allowing for the use of increased probe concentrations to improve probe-target interactions. However, strategies such as these add cost and complexity to the assays and do not result in detection limits that breach the fM regime.

Secondly, nearly all of the successful applications of these SMD platforms utilize traditional means of analyte delivery, that is, fluorescently-labeled biomolecules are delivered to the focused laser observation volume through continuous flow within a microcapillary or microfabricated channel. In this case, the potential for assay miniaturization is confounded by inefficient fluidic couplings, reliance on external pumping systems, and size mismatch between the observation volume and flow cell. Indeed, these drawbacks restrict the use of homogenous, single molecule probe strategies, relegating them to isolated, large sample volume platforms with low mass detection efficiency. However, use of a closed-loop, rotary pump (H. P. Chou, M. A. Unger and S. Quake, Biomed. Microdevices, 2001, 3, 323-323-330) eliminates the extra fluid couplings associated with traditional SMD platforms and provides repeated, random sampling of probe-target interactions from nanoliter chambers (C. M. Puleo, H. C. Yeh, K. J. Liu and T. H. Wang, Lab Chip, 2008, 8, 822-822-825 (DOI:10.1039/b717941c)); thus, enabling new analyte delivery schemes tailored for discrete, low-volume SMD assays and specific biosensing strategies.

Herein, we describe a microfluidic coupling to deliver and concentrate targets to nanoliter-sized SMD chambers (C. M. Puleo, H. C. Yeh, K. J. Liu and T. H. Wang, Lab Chip, 2008, 8, 822-822-825 (DOI:10.1039/b717941c)) from otherwise undetectably low concentrations of sample DNA. In the design, a membrane-based, microfluidic evaporator serves as the input to a SMD rotary chamber and following solvent removal via pevaporation, a concentrated sample plug is transferred for probe-target hybridization and interrogation via single molecule fluorescence burst counting. Though simple in design and function this unique means of analyte delivery represents a powerful method to overcome the traditional limitations associated with single molecule detection within microfluidic systems. First, the required fluorescent probe concentrations for efficient probe-target interactions within the highly dilute samples are minimized through target pre-concentration, thus diminishing the effect of background fluorescent events. In addition, direct measurements are made from clinically relevant microliter sample volumes through the use of micro-evaporators as unique interconnects between the dilute DNA samples and the nanoliter-sized SMD rotary chamber. Furthermore, application of this microfluidic detector-concentrator combination is shown to be ideal due to both the relatively gentle conditions necessary for solvent removal and the highly controlled rate of evaporation.

Indeed, desktop analyte concentration by solvent removal remains a mainstay in clinical and biological labs, as centrifugal and rotary evaporators are commonly used for nucleic acid preparation steps, during which DNA from large tissue samples are isolated into manageable sample sizes. This simple step has served as an enabling technique for the most highly sensitive, desktop biomolecular assays, such as polymerase chain reaction (PCR) and microarrays for decades. Still, evaporation in microdevices is most often looked upon as a nuisance (Y. S. Heo, L. M. Cabrera, J. W. Song, N. Futai, Y. C. Tung, G. D. Smith and S. Takayama, Anal. Chem., 2007, 79, 1126-1134 (DOI:10.1021/ac061990v); G. C. Randall and P. S. Doyle, Proc. Natl. Acad. Sci. U.S.A., 2005, 102, 10813-10818 (DOI:10.1073/pnas.0503287102)) and utilization of solvent removal for practical applications remains rare (J. Leng, M. Joanicot and A. Adjari, Langmuir, 2007, 23, 2315-2315-2317; G. M. Walker and D. J. Beebe, Lab. Chip, 2002, 2, 57-61 (DOI:10.1039/b202473j [doi]); M. Zimmermann, S. Bentley, H. Schmid, P. Hunziker and E. Delamarche, Lab. Chip, 2005, 5, 1355-1359 (DOI:10.1039/b510044e)). Here, the practicality of coupling micro-evaporation with highly sensitive microanalytical platforms is demonstrated by decreasing the relative limit of detection of a common molecular beacon probe by over four orders of magnitude, thus surpassing previous limits set by more complex SMD probe schemes through a purely microfluidic means.

### Materials and Methods

### Microdevice Design

The devices, shown in FIG. 24A, were prepared as two layer PDMS (Sylgard 183) on glass using multilayer soft lithographic techniques (MSL) (M. A. Unger, H. P. Chou, T. Thorsen, A. Scherer and S. R. Quake, Science, 2000, 288, 113-116 (DOI:8400 [pii])), as described previously. FIG. 24B depicts the operation principles for pervaporation-based concentration (G. C. Randall and P. S. Doyle, Proc. Natl. Acad. Sci. U.S.A., 2005, 102, 10813-10818 (DOI:10.1073/pnas.0503287102); J. Leng, B. Lonetti, P. Tabeling, M. Joanicot and A. Ajdari, Phys. Rev. Lett., 2006, 96, 084503), as described in the results section. The cross-sectional dimensions of the fluidic channel measured 100 μm wide by 12 μm high, while the top, evaporation layer overlapped at slightly larger dimensions of 200 μm wide by 50 μm high. The PDMS membrane separating the two layers ranged from 20-30 μm with slight device-to-device variation. The sample inlet (labeled i.) of the fluidic channel was connected to a sample reservoir using 0.02″ tygon tubing (Cole-Parmer) fitted with blunt-end, steel needle tips (McMaster-Carr, gauge 23). Access holes were punched in both layers using needle tips enabling device loading either directly from the tubing reservoir or gel-loading pipette tips for samples volumes as low as 0.1 μL.

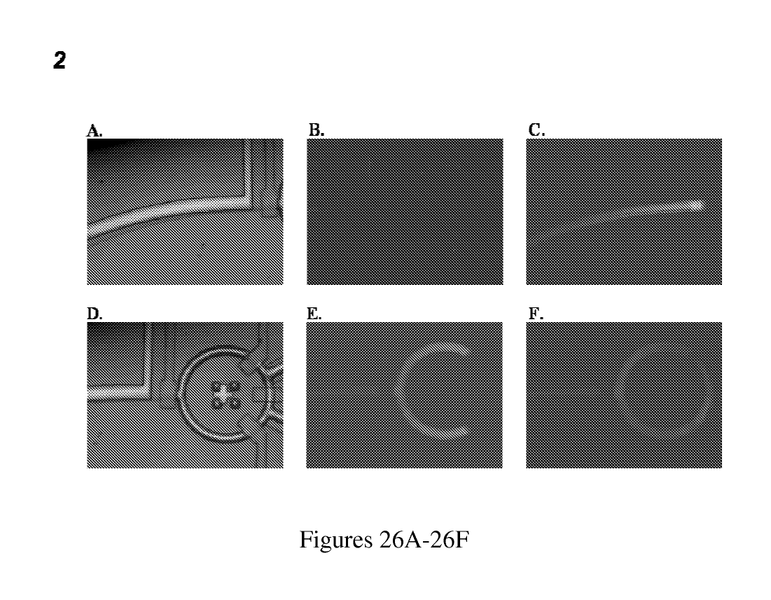

The SMD rotary chamber had dimensions of 1 mm loop diameter, 12 μm depth, and 100 μm width, while the intersecting valve control dimensions were 200 μm width by 50 μm depth. FIG. 26 depicts target accumulation at the inlet of this chamber during device operation and the loading steps for interrogation, with further description in the results section. The three valves trisecting the rotary chamber had two functions. First, they served to segment the chamber into multiple compartments to enable loading of multiple fluidic samples (FIGS. 26D and 26E). Second, actuation of the three valves in alternating patterns enabled peristaltic actuation of the four nanoliter sample within the chamber, creating a microfluidic rotary pump (FIG. 26F). All valve components of the device were primed with filtered water, controlled using the same needle tip connections used above, and pressurized with separate compressed air sources. Actuation sequences were programmed using an array of solenoid valves (Asco) and a Visual Basic (Microsoft) interface for an electrical switchboard (Agilent). Rotary actuation provided efficient mixing of the concentrated nanoliter plug with molecular probes and reaction buffers and enabled downstream recirculation for SMD analysis of specific biomolecules that accumulated during pervaporation (C. M. Puleo, H. C. Yeh, K. J. Liu and T. H. Wang, Lab Chip, 2008, 8, 822-822-825 (DOI:10.1039/b717941c)).

The microdevices were coupled to a custom confocal fluorescence spectroscopic system by positioning the chip into a piezo-actuation stage capable of sub-micron resolution (Physik Instrumente) in order to focus the optical probe volume at the channel midpoint (C. M. Puleo, H. C. Yeh, K. J. Liu and T. H. Wang, Lab chip, 2008, 8, 822-822-825 (DOI:10.1039/b717941c)). A HeNe laser (633 nm, 25-LHP-151-249, Melles Griot) was expanded to match the back aperture of the focusing objective (100X, 1.4 N.A., UPlanFl, oil immersion, Olympus) after reflection by a dichroic mirror (51008 BS, Chroma Technology). During experiments the laser power was attenuated to ˜100 μW by a neutral density filter before entering the objective and the beam was focused 6 μm into the channels, using the water-glass interface as a reference point. Emitted fluorescence was collected by the same objective, passed through a 50 μm pinhole (PNH-50, Melles Griot), and focused onto an avalanche photodiode (APD, SPCM-AQR-13, PerkinElmer) after band pass filtering (670DF40, Omega Optical). Acquisition software, written in Labview (National Instrument), and a digital counter (National Instrument) were used to collect data from the APDs. Threshold fluorescence values were determined by evaluating no target control samples, while single molecule events were defined by bursts within non-filtered data streams, where photon counts exceeded this preset threshold. Integration time for photon binning was set at 1 ms for all peak counting experiments, unless otherwise stated.

### Pervaporation-Induced Flow Measurement

Previous groups described pervaporation induced flow, determining velocity distributions within the microchannel by assuming a constant volumetric flow rate of water through the PDMS membrane. In our study, bulk evaporation measurements were taken by evaluating the average displacement of the sample meniscus inside the reservoir tubing. In addition, time dependent fluctuations of the maximum pervaporation-induced flow rate was determined at the start of the membrane using an adaptation of a method previously described by our lab (S. Y. Chao, H. Yi-Ping, V. J. Bailey and T. H. Wang, J Fluoresc., 2007, 17, 767-767-774), in which the average duration of single molecule fluorescence bursts represent the flow-rate dependent transit time of molecules/particles passing through the optical detection volume. In these measurements, fluorescent bursts were measured using samples of 6×10⁸ particles/mL, 0.1 μm tetraspec fluorescent beads (Molecular Probes) and the signal integration time for photon binning was set to 0.1 ms. Prior to burst analysis all flow measurement data was smoothed using the Lee Filter algorithm in order to provide more meaningful burst durations in low flow rate conditions (J. Enderlein, D. Robbins, W. Ambrose and R. Keller, J. Phys. Chem. A, 1998, 102, 6089-6089-6094; R. C. Habbersett and J. H. Jett, Cyto. A, 2004, 60A, 125-125-134). Stability of the evaporation induced flow was measured over time by monitoring fluorescent bursts in 100 s intervals, immediately following sample loading and commencement of gas flow within the top, evaporation channel. The effect of several operational parameters on flow rate control and stability were investigated, including evaporation chamber length, nitrogen flow rate, fluidic channel back-pressure, and device temperature.

### Molecular Beacon (MB) Probe and Single Molecule Detection

A DNA-MB (5′-Cy5-CATCCGCTGCCTCCCGTAGGAG TG-BHQ2-3′) was synthesized by Integrated DNA Technologies (IDT) with the probe sequence (indicated in bold) complementary to a conserved region of the 16S rRNA in a wide-range of bacteria (C. Xi, L. Raskin and S. A. Boppart, Biomed. Microdev., 2005, 7, 7-7-12). Complementary DNA oligonucleotides (IDT) were diluted in water and then loaded to fill a coiled, 1000 mm long channel. Pressurizing the reservoir tubing allowed complete dead-end filling, and maintained channel shape and sample continuity even at high nitrogen flow rates within the evaporation channel. For all experiments, both the back-pressure of the fluidic channel and the nitrogen pressure were kept equal (25 PSI for MB experiments), while control valves were actuated at 35 PSI to maintain closure. Control hybridization experiments were carried out without evaporation by loading the rotary pump with known concentrations of target DNA in water, then hybridizing the targets with MB probes (10 pM final concentration) loaded with hybridization buffer, in the second input. Prior to all hybridization experiments the microdevice was rinsed with a detergent (0.1% SDS) for ten minutes and filtered water for one hour, prior to drying in an oven overnight. The hybridization buffer was loaded with the probes to yield concentrations of 10 mM phosphate buffer (pH 7.8) and 900 mM NaCl after mixing and dilution with the target sample. The rotary pump was run at 100 Hz for 15 seconds upon loading of the rotary chamber with targets and probes, prior to heating the chip to 80° C. using a flat-bed thermocycler (custom Labnet MultiGene II) for 5 seconds and incubation at room temperature for one hour. After hybridization, the rotary pump was run at 100 Hz to recirculate sample through the optical probe volume and perform fluorescence burst counting for DNA detection within the four nanoliter chamber. Upon determining the detection limit under these condition, five incubation times were examined (5, 10, 15, 20, 30 minutes) to ensure optimal hybridization in subsequent concentrator experiments. The hybridization study was then repeated after accumulating DNA targets from samples at different concentrations using the evaporation channel, allowing determination of the efficacy of the combined evaporator-SMD microdevice. It is important to note that DNA targets were prepared from a 1 μM stock solution in 1×TE buffer by diluting to the experimental concentrations of 5-500 aM in purified water. Thus, these extreme dilutions rendered the effects of the original buffer concentration negligible, even after relatively large amounts of solvent removal.

### RESULTS AND DISCUSSION

### Principle and Operation of the Microfluidic Device

As shown in FIGS. 24A-24C, solvent in the bottom, fluidic layer pervaporated through the thin PDMS membrane separating this sample layer and the evaporation channel. Evaporated solvent was replaced through convection from a sample reservoir (labeled i.), while dry nitrogen was flown through the evaporation channel (labeled ii.) to maintain a more constant driving force for pervaporation throughout the device. In this example, accumulation of analyte was accomplished through the incorporation of a MSL valve (accumulation valve) to interrupt the convective flux from the reservoir. The fluidic and evaporation channels were coiled from this dead-end valve, allowing fabrication of devices with pervaporation membranes from 5 mm to 2000 mm in length. The reversible, MSL valve allowed manipulation of the concentrated sample plugs, which form after solvent removal and solute accumulation. FIG. 26 shows the accumulation of model, FAM-labeled, single stranded DNA (500 nM, 23 nt sequence, IDT) at this dead-end valve (FIG. 26C), followed by subsequent release of the valve and transfer of the concentrated nanoliter-sized sample plug to a downstream SMD rotary chamber (FIG. 26E). Images of the model fluorescent targets were taken using a 5× objective (Olympus BX51) and a cooled CCD camera (RetigaExi, QImaging Corporation) at 2 second exposure time. In MB experiments, probes and hybridization buffer were then loaded into the remaining portion of the rotary chamber for subsequent mixing with the concentrated sample plug (FIG. 26F) and re-circulating SMD.

### Device Characterization

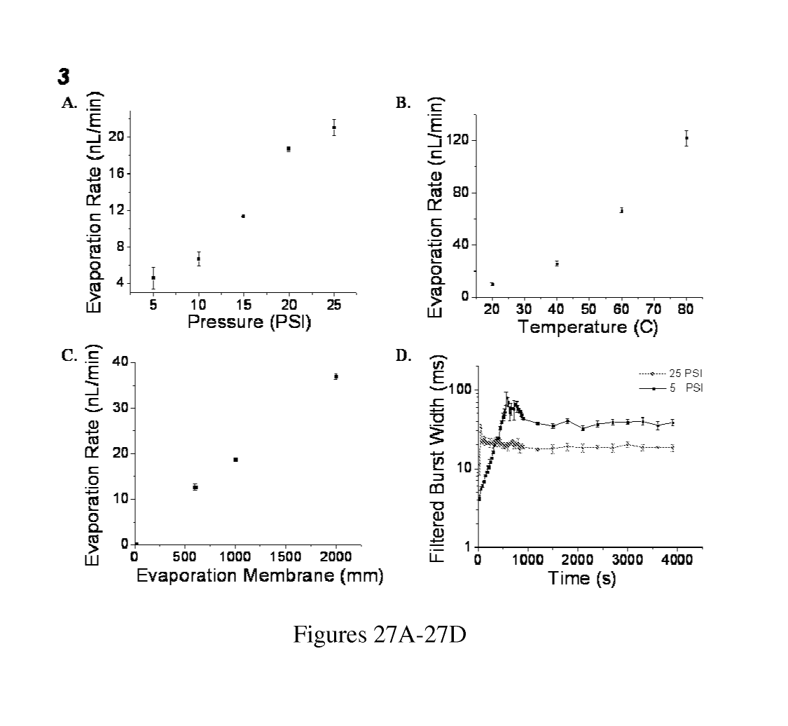

As discussed previously, the compensating flow from the fluid reservoir must equal the volumetric flow rate achieved by the pervaporation membrane. Therefore, the effectiveness of coupling the concentrator to the SMD rotary chamber is dependent on the magnitude and stability of the volumetric flow rate due to evaporation, which were measured both by quantifying average burst durations of polymer beads just upstream of the channel entrance and by observing the motion of the meniscus within the tubing reservoir. FIG. 27 shows average evaporation rates within the microdevice after altering various operational parameters, including applied pressure, temperature, and evaporation membrane length. The increasing evaporation rates with nitrogen pressure (FIG. 27A) were likely attributable to the faster nitrogen flows within the device, which act to purge water vapor and minimize diffusive boundary layers across the pervaporation membrane. In all experiments, back-pressure applied to both the sample channel and nitrogen flow channels were increased simultaneously and increasing sample pressure alone had little effect on the non-negligible evaporation rates with zero applied nitrogen flow (data not shown). However, this effect of nitrogen flow on evaporation rate is limited, as higher flow rates eventually result in constant driving forces for evaporation within the device, and interfaces between device layers often fail at back-pressures approaching 40-50 PSI. Still, several additional methods exist for increasing evaporation rates and thus the efficacy of the combined concentrator-detector. FIG. 27B shows the evaporation rates from a 1000 mm pervaporator when held at various temperatures using a flatbed thermocycler, with a maximum rate of ˜120 mL/min at 80° C., while FIG. 27C shows rates from microdevices held at room temperature (˜25° C.) with varying evaporation membrane lengths. Importantly, while not fully optimized in this example, the dependence of evaporation rates on multiple device parameters enables concentration approaching the hundreds of microliters per hour rates associated with desktop evaporators (Genevac, Ltd., EZ-Bio, “Second Generation Evaporation/Concentration System for Life Science Laboratories,” www.genevac.com, 2008). In addition, elimination of any air-liquid interface in the membrane-based microfluidic evaporator eradicates spurious convective flows or bumping, which may cause sample-loss or cross contamination in alternative macro- or micro-evaporator designs (C. M. Puleo, H. C. Yeh, K. J. Liu, T. Rane and T. H. Wang, Micro Electro Mechanical Systems, 2008. MEMS 2008. IEEE 21st International Conference on, 2008, 200-203). Furthermore, the low thermal mass within the micro-evaporator permits isothermal conditions gentle enough to preserve the activity of biological species, while integration of the evaporator with MSL control technologies allows direct coupling of the analytical component of the microdevice, thereby maximizing sensitivity.

FIG. 27D shows a time trace of the average fluorescent burst duration of fluorescent beads within a 1000 mm, coiled pervaporation chamber immediately following the start of nitrogen circulation within the top channel. Unlike the bulk evaporation data presented thus far, the single particle measurements show large transient sample flows and non-negligible latency times (up to 15 minutes) due to vibrations of the coiled membrane at low applied nitrogen pressures. The large sample flow rates (short burst durations) observed immediately after commencement of nitrogen flow is followed by sample flow cessation (long burst durations), which is caused by reflection of the vibration induced sample convection at the dead-end or accumulation valve. After damping of this transient flow, burst durations reach a stable value, which persist throughout device operation. Increasing the back-pressure applied to the fluid and gas channels (25 PSI) lead to faster damping of this transient flow and steady evaporation within seconds, thus allowing device operation with minimal latency times.

Attomolar Detection of DNA Targets with Molecular Beacons

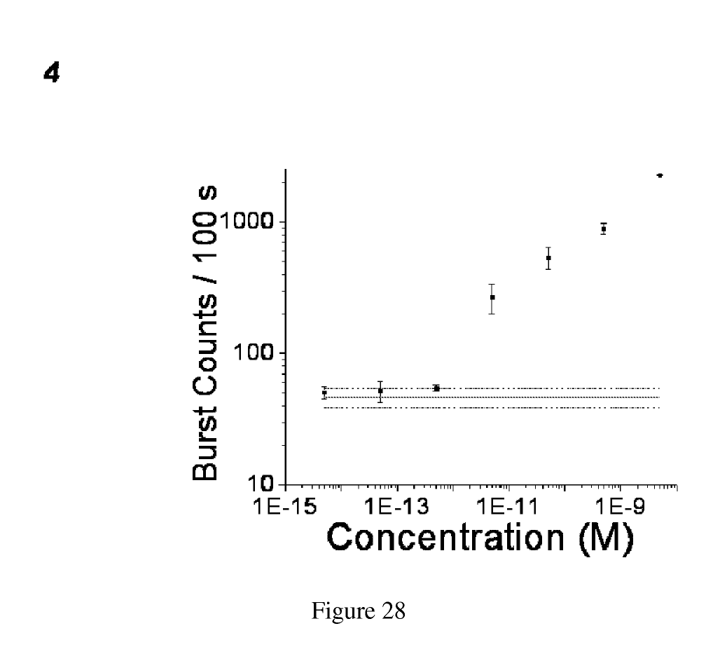

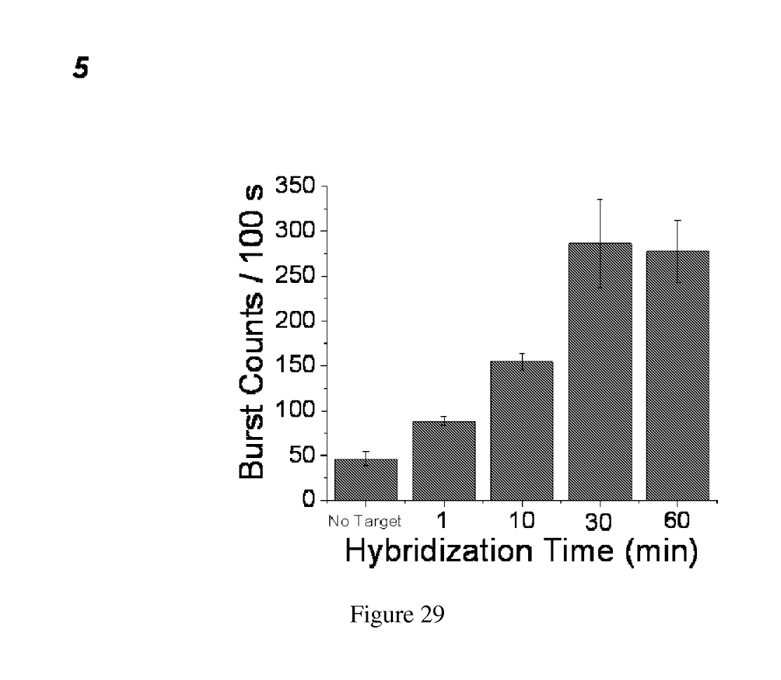

FIG. 28 shows the fluorescence burst data for control MB hybridization experiments within the microdevice, without the use of the evaporator. In bulk studies, dual-labeled, hairpin probes commonly increase in fluorescence intensity from 10-100 fold upon hybridization to complementary targets (A. Tsourkas, M. A. Behlke, S. D. Rose and G. Bao, Nucleic Acids Res, 31, 1319-1319-1330). This signal-to-background ratio is limited by the need to design hairpins with stem structures long enough to minimize signal from non-bound probes, yet short enough to provide instability to allow probe-target hybridization within reasonable timescales. These design criteria have restricted the use of molecular beacons in homogenous, single molecule assays, where signal from thermally fluctuating MBs become indistinguishable from bound probes at low target concentrations, as shown in FIGS. 28 and 29. Limitations such as these have led researchers to develop alternative FRET-based and coincident probe schemes specifically designed to increase signal-to-background ratios in single molecule studies.

Still, probe-target reactions in these traditional SMD studies are typically conducted for hours prior to running confocal fluorescence detection experiments and the overall sensitivity is still limited to fM. These limits are due in part to the restricted molecular probe concentrations (nM-pM) required to maintain low levels of background fluorescence for SMD measurements, discussed previously. In addition, the long probe-target incubation times for SMD, extended read times reported to gain reliable results, and difficulties in handling rare target molecules remain persistent barriers against more widespread use for quantification of biomolecules. FIG. 29 shows the hybridization time required to obtain a maximum fluorescence burst count after loading 5 pM DNA targets into the microdevice. After mixing and hybridization, the MB signal saturates within a <30 min incubation time, significantly reducing the reaction time required for experiments in which target concentrations have been enhanced to this level, compared to direct quantification from dilute or sub-picomolar concentrations using traditional SMD platforms. Thus, the rate limiting step in fluorescent event counting assays within the evaporator-SMD microdevice becomes solvent removal, which is a controllable device parameter (FIG. 27).

The unique micro-evaporator coupling to single molecule assays allows direct analysis from microliter-sized, low abundant, purified DNA solutions eliminating additional sample handling, in which variability could be introduced when using traditional SMD platforms. Importantly, solvent removal remains a viable option for nucleic acid concentration since several nucleic acid isolation protocols allow for washing or desalting of DNA, including phenol extraction/ethanol precipitation or elution using glass beads (D. Moore, “Purification and concentration of DNA from aqueous solutions.” Curr Protoc Immunol. 2001, pp. 10.1). Re-suspension in purified water does not alter DNA integrity, while stringent cleaning protocols for the microdevice enables removal of large amounts of solvent for concentration factors reaching 1,000's with little effect on subsequent hybridization reactions. In addition, probe introduction to the microdevice takes place following solvent removal from separate device inlets facilitating hybridization reactions within buffered and controlled conditions that are independent of the concentration step. This becomes especially important when using hairpin probes, such as molecular beacons, since several important probe properties, including signal-to-background ratio and specificity, are altered dramatically in solutions with differing ionic strengths (Z. Tang, K. Wang, W. Tan, J. Li, L. Liu, Q. Guo, X. Meng, C. Ma and S. Huang, Nucleic Acids Res., 2003, 31, e148). Indeed, these requirements highlight the advantage of performing recirculating SMD within a microdevice amenable to arrayed formats for probing optimal buffer conditions from concentrated sample plugs.

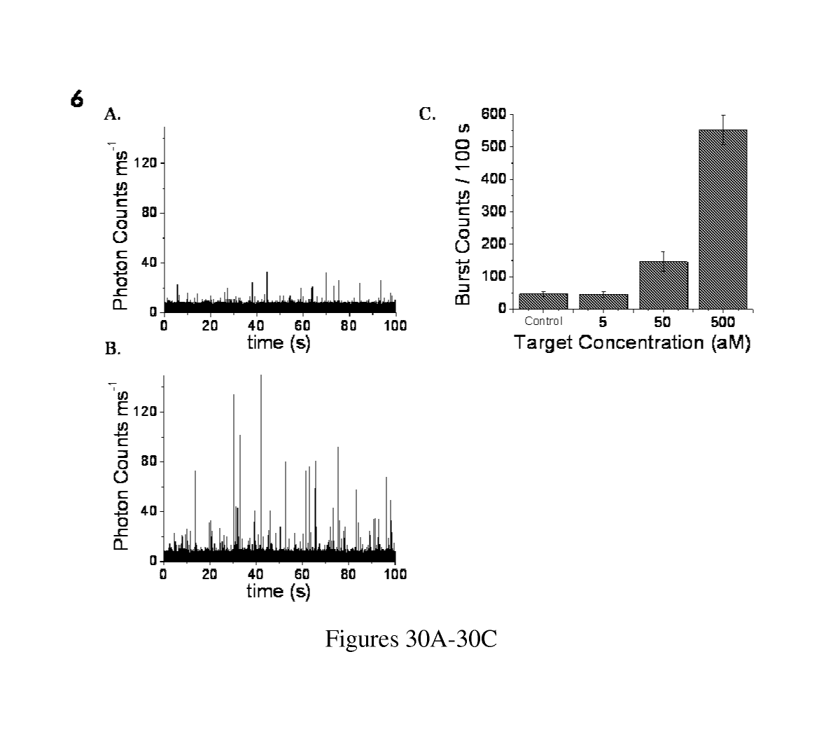

As shown in FIG. 26, target DNA is advected toward the dead-end valve during evaporation where it accumulates for subsequent transfer and detection within the SMD rotary chamber. The width of this accumulation zone is dependent on backwards thermal diffusion of the concentrated species. As shown in FIG. 26C, the width of target accumulation is comparable to the volume swept into the rotary pump for SMD; therefore, the rate of concentration within the microdevice is directly dependent on increase in target concentration within this accumulation zone. At large running times the growth of this accumulation zone can be estimated using the time scale associated with emptying one complete evaporator channel volume or tₑ=h/vₑ, where h is the height the channel and vₑ is the evaporation velocity through the pervaporation membrane. Evaporation velocity is calculated over the total pervaporation surface (S) as vₑ=Qₑ/S, where Qₑ is the measured volumetric flow rate achieved through solvent removal. Evaporation at 25 PSI nitrogen pressure results in an estimated Qₑ of 21.63 nL/min, as shown above, giving a tₑ value of ˜55 minutes and a target flux of J=Cvₑ within that time, where C represents the concentration of target within the sample reservoir. At this rate of evaporation the longest concentration time attempted in this report resulted in removal of ˜26 μL of solvent or a ˜6500-fold enhancement in target concentration within the 4 nanoliter SMD chamber. In the molecular beacon calibration curve (FIG. 28), the pM level burst count response above background reveals that the above level of target enhancement would yield theoretical detection limits approaching 200 aM after solvent removal. Indeed, FIG. 30 validates this aM level detection limit after evaporation, showing a measured limit of 50 aM after evaporation. The 4-fold discrepancy between the measured and expected detection limits may be attributable to chip-to-chip variations in evaporation rates due to membrane thickness or alignment. In addition, while the evaporation coil may serve as an interconnect to large clinical sample volumes, the dilute DNA solutions used in this report must be prepared through serial dilutions and are subject to pipetting errors. Still, as shown the enrichment of the 100 s of target molecules (FIG. 30B) from the aM sample was sufficient for detection above the background fluorescent bursts (FIG. 30A) resulting from thermal fluctuations of the 1000 s of MB probes injected into the SMD chamber. These results demonstrate efficient transport of the low abundant DNA molecules through the relatively inert PDMS evaporator. Furthermore, it is noteworthy that enumeration of these few hundred molecules ferried to the 4 nanoliter SMD chamber would still pose quite a challenge were it not for the application of recirculating confocal fluorescence detection. Resampling within the discrete nanoliter chamber enables utilization of the majority of the molecular information contained in the SMD chamber in relatively short read times, thus permitting the unique combination of an evaporation-based concentrator and SMD. In addition, FIG. 27 shows that modification of simple operating parameters explored in this example lead to Qₑ values of 100's nanoliters per minute, showing that the evaporation time necessary for achieving these detection limits can be drastically reduced. Even so, to our knowledge this represents the first practical report of attomolar sensitivity using single molecule fluorescence counting or common hairpin probes.

### CONCLUSIONS

Novel means of analyte delivery are necessary in order to breach the common femtomolar detection limits in current microfluidic platforms (P. R. Nair and M. A. Alam, Appl. Phys. Lett., 2006, 88, 233120; P. E. Sheehan and L. J. Whitman, Nano Lett., 2005, 5, 803-807 (DOI:10.1021/n1050298x [doi])). Microevaporators represent a unique method to bridge the gap between real-world, microliter biological samples and the nano- to picoliter detection volumes within microanalytical systems. Specifically, the well-controlled evaporation rates within microdevices enable highly reproducible transfer of a small number of molecular targets to specified detection components within microfluidic networks. In this example, DNA targets are detected at initial concentrations as low as 50 aM using a simple hairpin probe. Thus, the novel scheme of using solvent removal for analyte transfer to a nanoliter-sized detection volume not only obviates the need for special fluorescent probes designed specifically for confocal fluorescence detection, but surpasses the detection limits of these probes used in normal microfluidic platforms. Key to this result is performing single molecule fluorescence detection within a closed-loop rotary pump, which decreases the hybridization assay volume by orders of magnitude, thus allowing direct coupling to the microfluidic evaporator. In addition, detection is made from the typical starting volumes normally handled with pipettes and bench-top processing techniques, rendering the microdevice compatible with common nucleic acid isolation procedures, such as alcohol precipitation and affinity-based separation, which result in resuspension of small amounts of DNA in microliters of water.

Microevaporators could easily be integrated with other detection schemes, such as disk and wire-like nano-biosensors (Z. Gao, A. Agarwal, A. D. Trigg, N. Singh, C. Fang, C. H. Tung, Y. Fan, K. D. Buddharaju and J. Kong, Anal. Chem., 2007, 79, 3291-3291-3297; F. Patolsky, G. Zheng and C. M. Lieber, Nanomed., 2006, 1, 51-51-65) to increase analyte transfer and kinetics of target capture. Detection chambers for these nanoscale biosensors could reach picoliter levels, enabling concentration factors surpassing the ˜6500 shown using nanoliter chambers in this example. Indeed, optimization and standardization of microevaporators as universal analyte inputs to microanalytical systems could lift many of the current limitations of conventional microfluidic delivery systems. Additional improvements to membrane-based evaporators could include ion permeable membranes, enabling control over buffer concentrations during solvent removal, thus expanding applicability to complex protein and microorganism containing samples. Further modifications to the evaporator coil could also include the use of three-dimensional microstructures to maximize the surface area of the pervaporation membrane, which would lead to increases in assay sensitivity, while substantially decreasing total processing time. In this manner, processing times for single molecule detection platforms, such as single molecule fluorescence counting, that are traditionally limited due to probe-target hybridization kinetics would become dominated by the controllable evaporation or enrichment speeds within the evaporation-based analyte input. In addition, utilizing solvent removal as a simple method of analyte transport alleviates many of the challenges involved with low-volume sample processing and the lack of compatibility between conventional lab methodologies and SMD. Therefore, these results represent a clear example that for specific biological applications the performance of any microanalytical device must be assessed by the sensitivity of the sum of its parts, and not just the responsiveness of its probe.

From the foregoing description, one skilled in the art can easily ascertain the essential characteristics of this invention, and without departing from the spirit and scope thereof, can make changes and modifications of the invention to adapt it to various usage and conditions and to utilize the present invention to its fullest extent. The preceding preferred specific embodiments are to be construed as merely illustrative, and not limiting of the scope of the invention in any way whatsoever. The entire disclosure of all applications, patents, and publications cited above (including U.S. provisional application 61/176,745, filed May 8, 2009) and in the figures, are hereby incorporated in their entirety by reference.

1. A method for detecting a nucleic acid molecule of interest in a sample comprising cell-free nucleic acids, comprising
fluorescently labeling the nucleic acid molecule of interest, by specifically binding a fluorescently labeled nanosensor or probe to the nucleic acid of interest, or by enzymatically incorporating a fluorescent probe or dye into the nucleic acid of interest,
illuminating the fluorescently labeled nucleic acid molecule, causing it to emit fluorescent light, and
measuring the level of fluorescence by single molecule spectroscopy,
wherein the detection of a fluorescent signal is indicative of the presence of the nucleic acid of interest in the sample.

2. The method of claim 1, wherein the single molecule spectroscopy is conducted by
causing the sample comprising the fluorescently labeled nucleic acid molecule to flow through a channel of a fluidic device,
illuminating a portion of the fluid flowing through the channel with diffraction limited beam of light that activates the fluorescent label,
directing fluorescing light from the fluorescent nucleic acid molecule to be detected through an aperture comprising a confocal pinhole or slit to be detected and,
detecting the labeled nucleic acid molecule based on light directed through the aperture.

3. The method of claim 1, wherein the single molecule spectroscopy is conducted by
causing the sample comprising the fluorescently labeled nucleic acid molecule to flow through a channel of a fluidic device,
illuminating a portion of the fluid flowing through the channel substantially uniformly with a sheet-like beam of light that activates the fluorescent label,
directing fluorescing light from the fluorescent nucleic acid molecule to be detected through a substantially rectangular aperture of an aperture stop to be detected,
wherein the substantially rectangular aperture is constructed and arranged to substantially match a width of the channel in one dimension and to substantially match a diffraction limited width of the sheet-like illumination beam in another dimension, and
detecting the labeled nucleic acid molecule based on light directed through the substantially rectangular aperture.

4. The method of claim 3, wherein the single molecule spectroscopy is cylindrical illumination confocal spectroscopy (CICS).

5. The method of claim 3, further comprising passing the sample through a microfluidic detection region.

6. The method of claim 1, further comprising
concentrating the sample comprising cell-free nucleic acids by removing at least a portion of fluid in the sample, using a microfluidic device to provide a concentrated sample;
mixing the concentrated sample with a reagent to fluorescently label the nucleic acid molecule of interest, using the microfluidic device; and
detecting the nucleic acid of interest after the mixing, by illuminating the nucleic acid to be detected, causing the fluorescent molecules to emit fluorescent light to be detected,
wherein the sample is greater than about 1 μl and less than about 1 ml, and the concentrated sample is reduced in volume by a factor of at least 100.

7. The method of claim 6, wherein the concentrated sample is less than 100 nl.

8. The method of claim 7, wherein the illuminating comprises illuminating the sample with a beam of light to perform confocal fluorescence spectroscopy.

9. The method of claim 1, wherein the fluorescently labeled nanosensor is a molecular beacon.

10. The method of claim 1, wherein the fluorescently labeled nanosensor is a fluorescence coincidence nanosensor.

11. The method of claim 10, which comprises
(a) performing an assay that, in the presence of the nucleic acid of interest, generates a fluorescence coincidence nanosensor, wherein the fluorescence coincidence nanosensor comprises
i. one or more copies of the nucleic acid of interest, each bound to
ii. an oligonucleotide probe that is specific for the nucleic acid of interest, and which comprises a first member of a fluorophore pair,
and to
iii. a second oligonucleotide probe that is also specific for the nucleic acid of interest, which comprises the second member of the fluorophore pair;
(b) exciting fluorescence emission from both fluorophores; and
(c) measuring the level of fluorescence by single molecule spectroscopy (e.g. CICS)
wherein the coincident detection of a fluorescent signal from both fluorophores is indicative of the presence of the nucleic acid of interest in the sample.

12. The method of claim 11, wherein the either one or both of the fluorophores are quantum dots.

13. The method of claim 1, wherein the fluorescently labeled nanosensor is a fluorescent amplification nanosensor.

14. The method of claim 13, which comprises
(a) performing an assay that, in the presence of the nucleic acid of interest, generates a fluorescence amplification nanosensor, wherein the fluorescence amplification nanosensor comprises
i. two or more fluorophores that are enzymatically incorporated into a nucleic acid duplicate that is produced using the nucleic acid target of interest as the template
ii. two or more fluorescently labeled oligonucleotide probes that hybridize to the nucleic acid of interest,
(b) exciting fluorescence emission from the labeled fluorophores; and
(c) measuring the level of fluorescence by single molecule spectroscopy (e.g. CICS)
wherein the amplified single molecule fluorescent signal from (i) the enzyme-mediated multiply labeled duplicate or (ii) the hybrid comprising multiple probes bound to the nucleic acid target is indicative of the presence of the nucleic acid of interest in the sample.

15. The method of claim 1, wherein the fluorescently labeled nanosensor is a FRET nanosensor.

16. The method of claim 15, which comprises
(a) performing an assay that, in the presence of the nucleic acid of interest, generates a FRET-nanosensor, wherein the FRET-nanosensor comprises
i. one or more copies of the nucleic acid of interest, each bound to
ii. an oligonucleotide probe that is specific for the nucleic acid of interest, and which comprises a first member of a fluorophore pair,
and to
iii. a second oligonucleotide probe that is also specific for the nucleic acid of interest, which comprises the second member of the fluorophore pair;
(b) inducing fluorescence resonance energy transfer (FRET) between the first and second members of the fluorophore pair; and
(c) measuring the level of fluorescence by single molecule spectroscopy (e.g. CICS)
wherein the detection of a fluorescent signal is indicative of the presence of the nucleic acid of interest in the sample.

17. The method of claim 16 wherein the first member of the fluorophore pair is a quantum dot and together comprises a QD-FRET nanosensor.

18. The method of claim 16, wherein the FRET-nanosensor is bound to the quantum dot by the interaction of a biotin molecule attached to the FRET-nanosensor and an avidin molecule fixed to the quantum dot, or by the interaction of an avidin molecule attached to the FRET-nanosensor and a biotin molecule fixed to the quantum dot.

19. The method of claim 1, wherein the sample is a body fluid.

20. The method of any of claim 1, herein the nucleic acid of interest is a cell-free nucleic acid (CNA) in a body fluid.

21. The method of claim 1, wherein the cell-free nucleic acid in the sample is not separated from other components in the sample before the assay is performed.

22. The method of claim 1, wherein the cell-free nucleic acid is separated from other components in the sample before the assay is performed.

23. The method of claim 1, wherein the cell-free nucleic acid in the sample is not amplified before the assay is performed.

24. The method of claim 1, wherein the sample is a cell-free body fluid.

25. The method of claim 1, wherein the sample is from a human.

26. The method of claim 1, wherein the sample is generated from a pleural effusion, ascites sample, plasma, serum, whole blood, urine, ductal lavage, stool, or sputum.

27. The method of claim 1, wherein the nucleic acid of interest is a microRNA (miRNA), a viral DNA or RNA, a mitochondrial DNA, a tumor DNA or RNA, a fetal DNA or RNA, or an mRNA.

28. The method of claim 1, wherein the nucleic acid of interest is a microsatellite instability (MSI) marker, loss of heterozygosity (LOH) marker, or copy number variation (CNV) marker, or it comprises a mutation or a single nucleic polymorphism (SNP) of interest.

29. The method of claim 1, wherein the nucleic acid of interest comprises unmethylated cytosines that have been converted to uracils.

30. The method of claim 1, wherein the probe is linked nucleic acid (LNA), peptide nucleic acid (PNA), or DNA, complementary to the nucleic acid of interest.

31. The method of claim 1, wherein the probe is an intercalating dye.

32. The method of claim 1, wherein the dye is incorporated through polymerization of fluorophore labeled nucleotides.

33. The method of claim 1, wherein the dye is incorporated through ligation of fluorophore labeled oligonucleotides.

34. The method of claim 1, wherein the method is high throughput.

35. The method of claim 1, which is a method for the quantification of the amount of the nucleic acid of interest, wherein the frequency of detection of fluorescent bursts indicates the amount of the nucleic acid of interest in the sample.

36. The method of claim 1, which is a method for detecting methylation of a nucleic acid, for detecting a mutation in the nucleic acid, or for diagnosis of cancer, trauma, stroke, diabetes, or fetal medicine.

37. The method of claim 36, wherein the cancer is ovarian, breast, lung, prostate, colorectal, esophageal, pancreatic, prostate, head and neck, gastrointestinal, bladder, kidney, liver, lung, or brain cancer, gynecological, urological or brain cancer, or a leukemia, lymphoma, myeloma or melanoma.

38. The method of claim 1, further comprising introducing a fluorescent tracer particle during single molecule spectroscopy to control for flow velocity, focus position and/or fluorescent intensity.

39. The method of claim 17, which is a method for detecting methylation of a nucleic acid, comprising, in step (a),
treating a nucleic acid suspected of containing one or more methylated cytosine residues with an agent that converts unmethylated cytosines to uracils,
hybridizing the treated nucleic acid with a specific positive or a negative methylation-specific oligonucleotide probe, which is labeled with a first member of a fluorophore pair, and
binding the hybridized, treated nucleic acid to a quantum dot which comprises the second member of the fluorophore pair, thereby forming a QD-FRET-nanosensor,
wherein the presence of a fluorescent signal following hybridization with the positive methylation-specific probe indicates that the nucleic acid contains the one or more methylated cytosine residues, and the presence of a fluorescent signal following hybridization with the negative methylation-specific probe indicates that the nucleic acid does not contain the one or more methylated cytosine.

40. The method of claim 17, which is a method for detecting methylation of a nucleic acid, comprising, in step (a),
amplifying a nucleic acid comprising unmethylated cytosines converted to uracil with a primer pair, wherein one primer comprises a binding moiety having affinity to a binding partner, and the other primer comprises a first member of a fluorophore pair, to obtain an amplicon; and capturing the amplicon comprising the binding moiety with a binding partner fixed to a quantum dot, which comprises the second member of the fluorophore pair, thereby forming a QD-FRET-nano sensor,
wherein the presence of the fluorescent signal indicates that the nucleic acid is methylated.

41. The method of claim 17, which is a method for detecting a mutation in the nucleic acid, comprising, in step (a),
hybridizing a nucleic acid of interest that is suspected of comprising the mutation with two probes that flank the position of the mutation, wherein one of the probes comprises a sequence that is complementary to the mutation, wherein one of the probes is labeled at the end distal to the site of the mutation with a first member of a fluorophore pair, and wherein the other probe comprises, at the end distal to the site of the mutation, a binding moiety having affinity to a binding partner,
treating the hybridized nucleic acid with a ligase, such that the two probes become ligated if the mutation is present in the nucleic acid of interest, and
capturing ligated nucleic acids, which comprise both the first member of the fluorophore pair and the binding moiety, with a binding partner fixed to a quantum dot, which comprises the second member of the fluorophore pair, thereby forming a QD-FRET-nanosensor,
wherein the presence of the fluorescent signal indicates that the DNA of interest comprises the mutation.

42. The method of any of claim 1, which is a method for determining the tumor load in a subject compared to one or more reference standards,
wherein the DNA of interest is correlated with the presence of a cancer in a subject, further comprising
comparing the amount of the DNA of interest in the sample to a positive and/or a negative reference standard,
wherein the negative and positive reference standards are representative of defined amounts of tumor load.

43. The method of claim 42, which is a method to determine if a subject is likely to have a cancer,
wherein the negative reference standard is representative of the tumor load in a subject that does not have the cancer; and the positive reference standard is representative of the tumor load in a subject that has the cancer,
wherein an amount of the nucleic acid of interest in the sample that is statistically significantly greater than the negative reference standard, and/or is approximately the same the positive reference standard, indicates that the subject is likely to have the cancer.

44. The method of claim 43, which is a method for detecting a cancer at stage 1 or stage 2.

45. The method of claim 42, which is a method to stage a cancer in the subject,
wherein the negative reference standard is representative of the tumor load in a subject that does not have the cancer, or has an early stage cancer, and the positive reference standard is representative of the tumor load in a subject that has a late stage cancer,
wherein an amount of the nucleic acid of interest that is approximately the same as the negative standard indicates that the subject is likely to have an early stage cancer, and an amount of the nucleic acid of interest that is statistically significantly greater than the negative reference standard, or is approximately the same as the positive standard, indicates that the subject is likely to have a more advanced stage of the cancer.

46. The method of claim 42, which is a method to determine if a tumor is benign or malignant,
wherein the negative reference standard is representative of the tumor load in a subject that has a benign tumor, and the positive reference standard is representative of tumor load in a subject that has a malignant cancer,
wherein an amount of the nucleic acid of interest that is approximately the same as the negative standard indicates that the subject is likely to have a benign tumor, and an amount of the nucleic acid of interest that is statistically significantly greater than the negative reference standard, or is approximately the same as the positive standard, indicates that the subject is likely to have a malignant tumor.

47. The method of claim 42, which is a method for monitoring the progress or prognosis of a cancer in a subject, comprising determining the amount of the nucleic acid of interest at various times during the course of the cancer,
wherein a decrease in the amount of the nucleic acid of interest over the course of the analysis indicates that cancer is going into remission and that the prognosis is likely to be good, and an increase in the amount of the nucleic acid of interest over the course of the analysis indicates that cancer is progressing and that the prognosis is not likely to be good.

48. The method of claim 42, which is a method for evaluating the efficacy of a cancer treatment, comprising measuring the amount of the nucleic acid of interest at different times during the treatment,
wherein a change in the amount of the nucleic acid of interest over the course of the analysis indicates whether the cancer treatment is efficacious.

49. A kit for carrying out a method of claim 1, comprising a microfluidic device, which is optionally preloaded with a suitable buffer; and suitable probes or nanosensors, which bind specifically to a biomarker of interest.
